(19) United States
(12) Patent Application Publication
(10) Pub. No.: US 2005/0162338 A1
(43) Pub. Date: Jul. 28, 2005

(54) Information transmitting method, electronic apparatus, and wireless communication terminal

(76) Inventors: Masayuki Ikeda, Shiojiri-shi (JP); Izumi Iida, Shiojiri-shi (JP); Makoto Inoguchi, Tokyo-to (JP)

Correspondence Address: HARNESS, DICKEY & PIERCE, P.L.C., P.O. BOX 828, BLOOMFIELD HILLS, MI, 48303, US

(21) Appl. No.: 11/042,992

(22) Filed: Jan. 25, 2005

(30) Foreign Application Priority Data
Jan. 26, 2004 (JP) 2004-017259
Jan. 29, 2004 (JP) 2004-022265
Feb. 3, 2004 (JP) 2004-026732
Aug. 26, 2004 (JP) 2004-246359

(51) Int. Cl. G09G 5/00

(52) U.S. Cl. 345/2.1

(57) ABSTRACT

An electronic apparatus is provided including a wireless communication unit transmitting first category information and a wire communication unit transmitting second category information, and the first and second category information items are transmitted in parallel by the wireless communication unit and the wire communication unit.

### RELATED APPLICATIONS

This application claims priority to Japanese Patent Application Nos. 2004-017259 filed Jan. 26, 2004, 2004-022265 filed Jan. 29, 2004, 2004-026732 filed Feb. 3, 2004, and 2004-246359 filed Aug. 26, 2004 which are hereby expressly incorporated by reference herein in their entirety.

### BACKGROUND

1. Technical Field

The present invention relates to an information transmitting method used for elements requiring high-speed data transmission, such as a display element and an image capturing element, an electronic apparatus, and a wireless communication terminal using the same.

2. Related Art

In recent years, with the improvement of functions of electronic apparatuses, such as mobile phones, notebook computers, and digital cameras, it has been demanded that display elements or image capturing elements mounted in these electronic apparatuses have high resolution and high precision, which results in complicated apparatuses. In particular, mobile phones having a small size and light weight, a camera function, a display unit having a large size and advanced functions, and low power consumption have been demanded. In addition, folding-type or flip-type mobile phones are mainly used.

FIG. 40 is a block diagram illustrating the typical structure of an electronic apparatus using a display element as an active matrix liquid crystal display body, and (a) to (k) in FIG. 41 are corresponding timing charts.

As shown in FIG. 40, a CPU 5701 generates image data to be displayed and writes the display data on a video memory 5702. The CPU 5701 generates the image data to be display by decompressing or calculating compressed image data or moving picture data in a JPEG method or an MPEG method. A liquid crystal controller 5703 generates various timing signals required for liquid crystal display, such as an X clock 5715 for an X driver 5713, a horizontal synchronizing signal 5714, and a vertical synchronizing signal 5718, and reads the image data from the video memory 5702 according to a display sequence to output the read data to a driver of a liquid crystal display body 5708 (an X driver 5713 and a Y driver 5707). When pixels of the liquid crystal display body 5708 are arranged in a matrix of n rows and m columns, the X driver 5713 comprises an m-stage shift register 5704, an m-word latch 5705, and m DA converters 5706.

When reading a pixel at the head of a display frame, the liquid crystal controller 5703 generates the vertical synchronizing signal 5718 to output the signal to the Y driver 5707. At the same time, the liquid crystal controller 5703 reads data displayed on a pixel located at a first row and a first column of the display body 5708 from the video memory 5702 and outputs the read data to a data terminal of the latch 5705 as a display data signal 5716.

As shown in FIG. 41, the shift register 5704 reads the horizontal synchronizing signal 5714 generated by the liquid crystal controller 5703 in synchronism with the X clock signal 5715 to generate a signal, X1 latch ((c) in FIG. 41), for latching first column image data. This signal causes data displayed on the pixel arranged at the first row and the first column to be latched at the first column of the latch 5705. Then, the liquid crystal controller 5703 reads data to be displayed on the next pixel from the video memory 5702 and outputs the read data. The shift register 5704 of the X driver 5713 shifts the horizontal synchronizing signal 5714 by one digit to generate a signal, X2 latch ((d) in FIG. 41), for latching second column image data, and then latches image data in the first row and second column.

Hereinafter, the shift register. 5704 sequentially shifts the horizontal synchronizing signal 5714 and sequentially latches first row display data. When the latch 5705 holds data corresponding to one row, the next horizontal synchronizing signal 5714 is output (It should be particularly noted that (a) to (f) in FIG. 41 and (g) to (k) in FIG. 41 are difference from each other in the time scale along the horizontal axis. Therefore, the same horizontal synchronizing signal is shown in (a) and (h) of FIG. 41 in different time scales.) The DA converter 5706 converts the data held in the latch 5705 into an analog signal and outputs the signal to a Xi-th column of electrodes 5710 (1≦i≦m). At the same time, the Y driver 5707 outputs a selection signal to a first row of electrodes Y1.

Similarly, the Y driver 5707 sequentially shifts a selection signal to be output to an Yj-th row of electrodes 5709 (1≦j≦n) whenever the horizontal synchronizing signal 5714 is output.

In FIG. 40, a region inside the dot-and-dash line 5718 is an enlarged view of one of the pixels arranged in a matrix in the liquid crystal display body 5708. When the Yj-th row of electrodes 5709 is selected, an active matrix element 5711 transmits the output of the DA converter 5706 output to the Xi-th column of electrodes 5710 to a pixel electrode 5712. In addition, one DA converter 5706 may be provided on the liquid crystal controller side to transmit data 5716 as an analog signal. In this case, the latch 5705 is an analog sample and hold circuit. This conventional method has been mainly used because it is possible to reduce the number of DA converters. In addition, although a DA converter is used, it is preferable that a voltage value finally applied to the pixel electrode 5712 be a predetermined value. Further, a digital circuit capable of performing pulse width modulation can be used, and the analog sample and hold circuit is not needed. Therefore, with an increase in the density of LSI, the above-mentioned method has been generally used.

However, in the conventional method, since data is transmitted as a digital signal, a large number of signal lines, for example, twenty-four signal lines obtained by multiplying 8 bits by the three primary colors are needed.

Further, the time from a point of time when a display signal at a right end of a row on a screen is output from the liquid crystal controller 5703 to a point of time when a display signal at a left end of the next row is output is called a blanking period or a retrace period, and the period cannot be zero in a CRT. However, the period may be zero in the liquid crystal display body 5708. FIG. 41 shows an example in which a horizontal retrace period corresponding to one pixel and a vertical retrace period corresponding to one row are set.

In an electronic apparatus, such as a digital camera using an image capturing element, a signal transmitting direction is reverse to that in an electronic apparatus using the liquid crystal display body 5708, so that the same circuit is constructed.

As the electronic apparatus equipped with the display body element or the image capturing element, a small and lightweight apparatus having a large display unit and high resolution has been demand. Therefore, a plurality of mounting substrates are generally used for mounting the electronic apparatus shown in FIG. 40. In this case, the mounting substrate is generally divided along the dot-and-dash line 5717-5717′ of FIG. 40.

Inevitably, long wiring lines are used for connecting the CPU 5701 to the liquid crystal display body 5708. In addition, even when the image capturing element is mounted in the structure shown in FIG. 40, a signal transmitting direction is reverse to that in an apparatus using the liquid crystal display body 5708, so that the same circuit is constructed. Therefore, long wiring lines are needed to connect the CPU 5701 to the image capturing element.

Furthermore, with an increase in the resolution of the liquid crystal display body 5708 and the image capturing element, a signal frequency of the wiring lines of these devices becomes high, so that it is difficult to connect these devices to the CPU 5701. In particular, in a folding-type mobile phone, these devices and the CPU are connected to each other through a thin hinge. Therefore, with an increase in the resolution of the display element or the image capturing element, the amount of data exchanged between both substrates obtained by dividing the mounting substrate along the one dot-chain line 5717-5717′ of FIG. 40 becomes larger. Therefore, in order to achieve this apparatus, a technique of transmitting data at high speed is needed. As a high-speed data transmitting method for solving this problem, it has been suggested a method in which LVDS (Low Voltage Differential Signaling) is used to connect the display body to the image capturing element (U.S. Pat. No. 3,086,456 (column 44) and U.S. Pat. No. 3,330,359 (column 46)).

Moreover, with the advance of a semiconductor manufacturing technique, the degree of integration becomes higher by a system on chip technique. Therefore, there is a tendency to mount many semiconductor circuits into one chip. In this case, in order to connect the semiconductor chip to an external circuit, for example, several hundred pins may be used. In addition, since an operating frequency of the semiconductor circuit increase, a conventional method of connecting the semiconductor to an external circuit via wire bonding causes a problem in frequency characteristics. As a result, it is difficult to exactly exchange signals with the external circuit. In order to solve the above problem, ‘Nikkei Micro Device’, December 2003, discloses a technique in which data is transmitted between chips wirelessly.

However, although a technique of increasing the size of a display body is developed, the technique is insufficient to obtain a satisfactory function. For a sufficient noise characteristic (interfere resisting characteristic and interference characteristic), precise design and adjustment are needed. In addition, in LVDS, since the level of a signal is low, there is a problem in that power consumption increases by processing an analog signal using a digital IC.

Further, in order to exactly transmit signals, a matched impedance terminal is needed. However, the number of lines required for the impedance terminal increases, and transmitting impedance is no more than 100 Ω. Therefore, power consumed at these terminating resistors becomes larger than a permitted value.

Further, when dividing the mounting substrate along the dot-and-dash line 5717-5717′ of FIG. 40, it is necessary to transmit data in large quantities and at high speed through long wiring lines. Therefore, a radiated electromagnetic field from the wiring lines increases, which results in the cause of electromagnetic wave interference on other electronic apparatuses. In the conventional method of transmitting signals by a signal line, an amplitude level of a signal at a receiving end is prescribed. Therefore, even when a sufficient quality is obtained at the receiving end, it is difficult to reduce the amplitude level of a signal. That is, it is difficult to take measures for an EMI problem, which causes a restriction in the design of an apparatus and an increase in costs. In addition, since a transmitter drives the floating capacitance of a transmission line as well as the load of the receiving end, surplus energy for signal transmission is required, which results in an increase in power consumption.

Moreover, an increase in the number of wiring lines accompanying high-speed data transmission requires a space for wiring, and thus the design of an apparatus is greatly restricted.

In particular, in the folding-type mobile phone, when wiring lines pass through a movable portion, such as a hinge, the characteristic impedance is changed according to the folded state of the movable portion. Therefore, impedance mismatching can be generated according to circumstances, and signal distortion caused by reflection from the folded portion can be generated. As a result, there are problems in that the speed of data to be transmitted is restricted and a mounting method or the arrangement of components is restricted.

Further, in order to cope with the display body element or the image capturing element for realizing high resolution and high-speed data transmission, dozens of signal lines are used to transmit data through a hinge portion, and wiring lines on a substrate are not used. Therefore, a flexible substrate is connected through a connector. The connection by the flexible substrate or the connector causes problems, such as an increase in costs and the deterioration of connection reliability.

In order to solve these problems, a method can be used in which, in the same electronic apparatus, the data transmission between portions where it is difficult to provide wiring lines is performed wirelessly, that is, an electromagnetic wave signal, using the conventional wireless communication technique.

However, when applying the conventional wireless communication method to data transmission inside an electronic apparatus, the structure of the electronic apparatus is very complicated, compared to a case in which data is transmitted via a wire, and it is difficult to mount devices in the electronic apparatus.

Further, when data transmission is performed in the same electronic apparatus using the conventional wireless communication technique, an electromagnetic wave signal used for communication may leak, which results in the leakage of information. That is, the security of communication is deteriorated, for example, via wiretapping.

Accordingly, the present invention is designed to solve the above problems, and it is a first object of the present invention to achieve an electronic apparatus and a wireless communication terminal having a low manufacturing cost and high reliability. The first object is realized by improving the conventional wireless communication technique to be applied to data transmission in the same electronic apparatus and by performing high-speed data transmission wirelessly to solve the above-mentioned various problems and restrictions.

Further, it is a second object of the present invention to achieve an electronic apparatus and a wireless communication terminal having a low manufacturing cost and high reliability, capable of solving a problem of security generated when wireless communication is performed in the same electronic apparatus in order to settle various problems and restrictions caused by a conventional information transmitting method.

### SUMMARY

In order to achieve the above-mentioned objects, the present invention provides an information transmitting method used in an electronic apparatus comprising a wireless communication unit for wirelessly transmitting first category information and a wire communication unit for transmitting second category information via a wire. In the information transmitting method, the wireless transmission of the first category information and the wire transmission of the second category information are performed in a communication link.

According to the above-mentioned structure, since a group of signals difficult to transmit at high speed are transmitted wirelessly, various problems caused by high-speed data transmission are avoided. In addition, since a signal, such as synchronization information required for wireless transmission, is transmitted via a wire, it is possible to simplify a system although a wireless transmission method is used.

In this way, it is possible to propagate a transmitting signal, which is high-speed data, through a space with a simple system, and wiring lines for wire transmission are not needed, so that wiring for a flexible substrate or a connector is simplified. Thus, it is possible to settle various problems caused by complicated wiring, such as an increase in costs and the deterioration of reliability. In addition, an increase in power consumption accompanying high-speed data transmission or impedance matching can be prevented. Further, restrictions in wiring and the arrangement of components can be relieved, and it is possible to improve the design or utilization of an electronic apparatus. Furthermore, since an electromagnetic wave used for signal transmission is transmitted at a short distance in the same system, communication can be reliably performed at this distance. In addition, since the strength of a, radiated electromagnetic wave can be reduced to a limit level, it is possible to easily take measures for an EMI problem. Further, the term ‘one communication link’ means a period in which communication is performed without disconnection, and in the one communication link, transmission and reception are performed at least one time.

An electronic apparatus according to the present invention comprises: a wireless communication unit for wirelessly transmitting first category information; and a wire communication unit for transmitting second category information via a wire. In the electronic apparatus, the wireless transmission of the first category information and the wire transmission of the second category information are performed in a communication link.

According to the above-mentioned structure, it is possible to settle various problems accompanying information transmission in the electronic apparatus using the above-mentioned information transmission, thereby easily realizing an electronic apparatus.

An electronic apparatus according to the present invention comprises: a wireless communication unit for wirelessly transmitting first category information; and a wire communication unit for transmitting second category information used for controlling or processing the first category information via a wire.

According to the above-mentioned structure, since it is possible to receive a portion of the information used for the wireless communication via a wire, the load of the wireless communication can be reduced, and it is possible to transmit the first category information wirelessly. Thus, problems accompanying wireless communication, such as the deterioration of security and an increase in the size of a circuit, can be settled, and problems accompanying wire communication, such as an increase in the number of wiring lines and a restriction of the arrangement of components, can be solved. Therefore, it is possible to achieve an electronic apparatus having a large screen and advanced functions, and it is possible to achieve a small-sized and lightweight electronic apparatus.

Further, an electronic apparatus according to the present invention comprises: an information transmitting unit for transmitting first category information; an encoding unit for encoding the first category information from the information transmitting unit; a wireless transmitting unit for transmitting the first category information encoded by the encoding unit as an electromagnetic wave signal; a wireless receiving unit for receiving the electromagnetic wave signal transmitted by the wireless transmitting unit; a decoding unit for decoding the signal received by the wireless receiving unit; a key generating unit for generating an encrypted key as second category information; and a wire communication unit for distributing the encrypted key generated by the key generating unit to the encoding unit and the decoding unit via a wire.,

According to the above-mentioned structure, encoded information is transmitted in the electronic apparatus wirelessly. Therefore, even when the information is leaked to a third party, the third party cannot read the information if he does not have an encrypted key. Thus, it is possible to improve the security of the electronic apparatus. In addition, since the encrypted key is frequently updated and is transmitted to the other side, the third party cannot obtain the encrypted key. That is, a key distribution problem (KDP) accompanying encryption does not arise.

An electronic apparatus according to the present invention comprises: an information transmitting unit for transmitting first category information; a random number generating unit for generating a random number as second category information; a wire communication unit for distributing the random number generated by the random number generating unit via a wire; an adding unit for adding the random number to the first category information transmitted from the information transmitting unit; a wireless transmitting unit for transmitting the information added by the adding unit as an electronic wave signal; a wireless receiving unit for receiving the electromagnetic wave signal transmitted from the wireless transmitting unit; and a subtracting unit for subtracting the random number from the information received by the wireless receiving unit and for decoding the resultant signal.

According to the above-mentioned structure, a random number is added to the information transmitted in the electronic apparatus wirelessly. Therefore, even when the information leaks, a third party cannot know the contents of the information, thereby ensuring the security of the electronic apparatus.

An electronic apparatus according to the present invention comprises: an information transmitting unit for transmitting first category information; a spread code generating unit for generating a spread code as second category information; a wire communication unit for transmitting the spread code generated from the spread code generating unit via a wire; a modulating unit for spread-modulating the first category information transmitted from the information transmitting unit by the spread code; a wireless transmitting unit for transmitting the information modulated by the modulator as an electromagnetic wave signal; a wireless receiving unit for receiving the electromagnetic wave signal; and a demodulating unit for reversely spreading the information received by the wireless receiving unit by the spread code.

According to the above-mentioned structure, the information transmitted in the electronic apparatus wirelessly is spread-modulated by the spread code. Therefore, even when a signal leaks, the third party cannot know the contents of the information if he does not know the spread code. Thus, it is possible to ensure the security of the electronic apparatus. Since the spread code is frequently updated and is transmitted to a transmitter side via a wire communication, the third party cannot obtain the spread code. In addition, since a spread gain is obtained, the wireless communication path does not influence the electronic apparatus, and the wireless communication path is not affected by an electromagnetic wave signal or noise generated from the electronic apparatus.

Further, in the electronic apparatus according to the present invention, the wire communication unit superimposes a signal on a power line to transmit the signal.

According to the above-mentioned structure, since the wire communication unit performs communication using the signal superimposed on the power line, a dedicated signal line for wire communication unit is not needed. Therefore, it is possible to simply transmit a large amount of data through a small number of wiring lines.

The electronic apparatus according to the present invention further comprises: an electromagnetic wave converting unit for converting the first category information into the electromagnetic wave signal; and an electromagnetic wave restoring unit for receiving the electromagnetic wave signal to restore the signal to the first category information.

According to the above-mentioned structure, it is possible to wirelessly transmit signals as an electronic wave (radio wave) with a simple structure. In particular, since the transmitter side and the receiver side transmitting and receiving signals wirelessly use a common control signal transmitted via a wire, it is possible to absorb the variation of characteristics or the variation of timing at transmitting and receiving ends. Thus, it is possible to obtain high communication quality without using high-precision components.

Further, in the electronic apparatus according to the present invention, the electromagnetic wave converting unit and the electromagnetic wave restoring unit are driven with a carrier wave generated by the same carrier oscillator.

According to the above-mentioned structure, since both the transmitter side and the receiver side wirelessly transmitting and receiving signals are driven by a carrier wave generated by the common signal transmitted via a wire, it is not necessary for the receiver side to synchronize synchronization detection. Therefore, it is possible to obtain high communication quality with a simple circuit structure, without using high-precision components at the transmitting and receiving ends.

Furthermore, in the electronic apparatus according to the present invention, the electromagnetic wave converting unit performs spectral spread modulation, and the electromagnetic wave restoring unit performs spectral reverse spread modulation. In addition, synchronization information of the electromagnetic wave converting unit and the electromagnetic wave restoring unit is transmitted via a wire.

According to the above-mentioned structure, it is possible to multiplex a plurality of signals by spectral spread modulation without converting serial signals and then to transmit them. Therefore, the real time characteristic is excellent. In addition, since a spread gain can be obtained, it is possible to construct a robust system that is little interfered with the electromagnetic wave to be transmitted or that hardly interferes with the electromagnetic wave. In addition, since the synchronization information is transmitted between the transmitting end and the receiving end via a wire, it is not necessary for the receiving end to have a synchronizing circuit for synchronization compensation from the received electromagnetic wave signal, and a simple reverse spreading circuit can be used. Thus, it is possible to simplify the structure of a circuit.

Moreover, in the electronic apparatus according to the present invention, the electromagnetic wave converting unit performs modulation to a UWB signal, and the electromagnetic wave restoring unit performs demodulation from the UWB signal. In addition, synchronization information of the electromagnetic wave converting unit and the electromagnetic wave restoring unit is transmitted via a wire.

According to the above-mentioned structure, under a strong electromagnetic field condition of an electronic apparatus whose basic function is to generate an electromagnetic wave, such as a mobile phone performing communication by a radio wave, it is possible to transmit data having high reliability at high speed using a wide-band characteristic unique to UWB and a specular density characteristic. According to UWB communication, the provisions of the maximum radiation electromagnetic field prescribed by law are relaxed, and thus it is easier to design a receiver. Further, a modulator and a demodulator for UWB use the same synchronization information transmitted via a wire, it is not necessary to provide a circuit for synchronization detection in the receiver side. Therefore, it is possible to simplify a circuit structure.

An electronic apparatus according to the present invention comprises: a wireless transmitting unit for modulating first category information and transmitting the modulated information as an electromagnetic wave signal; a wireless receiving unit for receiving the electromagnetic wave signal to demodulate the signal; a wire transmitting unit for superimposing second category information on a power line to transmit the information; and a wire receiving unit for separating the signal superimposed on the power line. In the electronic apparatus, the first category information and the second category information are transmitted in a communication link by the wireless transmitting unit and the wire transmitting unit, and the wireless transmitting unit and the wire transmitting unit are supplied with power through the common power line.

According to the above-mentioned structure, a group of signals difficult to transmit at high speed can be transmitted wirelessly, which does not cause various problems accompanying the high-speed transmission of data. In addition, since the synchronization information required for wireless transmission is superimposed on the power line and is then transmitted therethrough, it is possible to prevent a communication system from being complicated due to the wireless communication system. Further, since a wire transmission line and the power line are used in common, it is possible to ravel out the difficulty of wiring.

In this way, it is possible to propagate a transmitting signal, which is high-speed data, through a space with a simple system, and wiring lines for wire transmission are not needed, so that wiring for a flexible substrate or a connector is simplified. Thus, it is possible to settle various problems caused by complicated wiring, such as an increase in costs and the deterioration of reliability. In addition, an increase in power consumption accompanying high-speed data transmission or impedance matching can be prevented. Further, restrictions in wiring and the arrangement of components can be relieved, and thus it is possible to improve the design or utilization of an electronic apparatus. Furthermore, since an electromagnetic wave used for signal transmission is transmitted at a short distance in the same system, communication can be reliably performed at this distance. In addition, since the strength of a radiated electromagnetic wave can be reduced to a limit level, it is possible to easily take measures for an EMI problem. Further, since a wire transmission line and the power line are used in common, it is possible to ravel out the difficulty of wiring.

In the electronic apparatus according to the present invention, the wireless transmitting unit comprises a control unit for generating a reference signal and a modulating unit for converting the first category information into the electromagnetic wave signal in synchronism with the reference signal, in which the second category information transmitted to or received from the wire transmitting unit and the wire receiving unit is the reference signal, and the wireless receiving unit includes a demodulating unit for demodulating the first category information in synchronism with the reference signal received by the wire receiving unit.

According to the above-mentioned structure, the wireless transmitting unit and the wireless receiving unit can be operated in synchronism with the same reference signal. Therefore, it is not necessary for the receiver side to have a circuit for synchronization, and thus it is possible to remarkably simplify the structure of hardware for receiving the first category information.

In the electronic apparatus according to the present invention, the wireless transmitting unit comprises a control unit for generating a reference signal, a first carrier oscillating unit for oscillating a carrier wave synchronized with the reference signal, and a modulating unit for modulating the carrier wave oscillated from the first carrier oscillating unit into the first category information and for converting the first category information into the electromagnetic wave signal. The second category information transmitted to or received from the wire transmitting unit and the wire receiving unit is the reference signal. In addition, the wireless receiving unit includes a second carrier oscillating unit for oscillating a carrier wave synchronized with the reference signal received by the wire receiving unit and a demodulating unit for demodulating the first category information using the carrier wave oscillated by the second carrier oscillating unit.

According to the above-mentioned structure, the wireless transmitting unit and the wireless receiving unit can be operated by the carrier wave generated in synchronism with the same reference signal. Therefore, it is not necessary for the receiver side to have a circuit for tracking or synchronization compensation for reproducing the carrier wave, and thus it is possible to remarkably simplify the structure of hardware for receiving the first category information.

In the electronic apparatus according to present invention, the wireless transmitting unit comprises a control unit for generating a reference signal, a first carrier oscillating unit for oscillating a carrier wave synchronized with the reference signal, and a modulating unit for modulating the carrier wave oscillated from the first carrier oscillating unit into the first category information in synchronism with the reference signal and for converting the first category information into the electromagnetic wave signal. Here, the second category information transmitted to or received from the wire transmitting unit and the wire receiving unit is the reference signal. In addition, the wireless receiving unit includes a second carrier oscillating unit for oscillating a carrier wave synchronized with the reference signal received by the wire receiving unit and a demodulating unit for demodulating the first category information in synchronism with the reference signal received by the wire receiving unit, using the carrier wave oscillated by the second carrier oscillating unit.

According to the above-mentioned structure, it is possible to synchronize the wireless transmitting unit with the wireless receiving unit using the reference signal superimposed on the power line, and it is also possible to operate these units using the carrier wave subjected to tracking that is generated in synchronism with the reference signal superimposed on the power line. Therefore, it is not necessary for the receiver side to have a circuit for synchronization or a circuit for reproducing the carrier wave, and thus it is possible to remarkably simplify the structure of hardware for receiving the first category information.

In the electronic apparatus according to the present invention, the wireless transmitting unit modulates the first category information by phase modulation to generate carrier wave information for modulation and demodulation based on the reference signal transmitted as the second category information via a wire, and a transmitting packet transmitted from the wireless transmitting unit is synchronized with the reference signal transmitted as the second category information via a wire.

According to the above-mentioned structure, it is possible to realize the wireless transmitting unit and the wireless receiving unit for transmitting and receiving the first category information with a simple circuit structure, and it is possible to transmit signals as electromagnetic waves (radio waves) wirelessly. Particularly, since the transmitter side and the receiver side transmitting and receiving signals wirelessly use a common control signal transmitted through the power line, it is possible for the receiver side to absorb the variation of characteristics or the variation of timing, and thus it is possible to obtain high communication quality without using high-precision components.

In the electronic apparatus according to the present invention, the wireless transmitting unit modulates the first category information by spectral spread modulation, and the wireless receiving unit demodulates the first category information by spectral reverse spread and generates carrier wave information or synchronization information of a spread code for modulation and demodulation based on the reference signal transmitted as the second category information via a wire, so that the information is synchronized with the reference signal.

According to the above-mentioned structure, it is possible to multiplex a plurality of signals by spectral spread modulation without converting serial signals and then to transmit them. Therefore, the real time characteristic is excellent. In addition, since a spread gain can be obtained, it is possible to construct a robust system that is little interfered with by the electromagnetic wave to be transmitted or that hardly interferes with the electromagnetic wave. In addition, since the synchronization information or carrier wave information is superimposed on the power line and is then transmitted between the transmitting end and the receiving end, the receiving end can use the signal to reproduce synchronization timing or the carrier wave. Therefore, it is not necessary for the receiver side to have a synchronizing circuit for synchronization compensation, and a simple reverse spreading circuit can be used. Thus, it is possible to simplify the structure of a circuit. In addition, since the carrier wave is reproduced with a simple circuit, it is possible to simplify a circuit structure. Further, since the second category information is superimposed on the power line, it is possible to decrease the number of wiring lines.

In the electronic apparatus according to the present invention, the wireless transmitting unit modulates the first category information by UWB modulation and generates synchronization information of a pulse template for modulation and demodulation based on the reference signal transmitted as the second category information via a wire, so that the information is synchronized with the reference signal.

According to the above-mentioned structure, under a strong electromagnetic field condition of an electronic apparatus whose basic function is to generate an electromagnetic wave, such as a mobile phone performing communication by a radio wave, it is possible to transmit data at high speed with high reliability. According to UWB communication, the provisions of the maximum radiation electromagnetic field prescribed by law are relaxed, and thus it is easier to design a receiver. Further, a modulator and a demodulator for UWB use the same synchronization information transmitted via a wire, it is not necessary to provide a circuit for synchronization detection in the receiver side. Therefore, it is possible to simplify a circuit structure. Further, since the second category information is superimposed on the power line, it is possible to decrease the number of wiring lines.

In the electronic apparatus according to the present invention, the second category information includes the carrier wave information or the synchronization information concerning the wireless communication of the first category information.

According to the above-mentioned structure, at the time of wireless transmission, since a procedure or a circuit for synchronization compensation is omitted in the receiver side, it is possible to simplify the structure of a circuit for wireless transmission. In addition, at the time of wireless transmission, since it is possible to always track the carrier waves of the transmitter side and the receiver side, it is possible to remarkably reduce the precision of the carrier oscillator. In addition, it is possible to remarkably reduce the precision of hardware for transmitting and receiving the first category information, resulting in a reduction in costs.

In the electronic apparatus according to the present invention, the second category information includes information indicating a receiving state of the first category information and is transmitted from a receiving side of the first category information to a transmitting side thereof.

According to the above-mentioned structure, the receiver side simply feeds back a receiving state of information transmitted wirelessly to the transmitter side according to the receiving state of information, and thus it is possible to ensure received signal quality. In addition, since it is possible to control transmitting power to a minimum level for receiving the first category information, it is possible to easily take measures for an EMI problem. Further, it is possible to prevent the leakage of information, thereby improving security.

In the electronic apparatus according to the present invention, the first category information includes at least one of image data, text data, and voice data.

According to the above-mentioned structure, it is possible to easily realize various electronic apparatuses dealing with multimedia information, such as image data, voice data, and text data.

Further, the electronic apparatus according to the present invention further comprises a storage unit for storing the first category information; a display body for displaying the first category information; a display control unit for reading the first category information from the storage unit according to an operating sequence of the display body and for outputting the read information; and a display body driving unit for driving the display body, based on the first category information read by the display control unit.

According to the above-mentioned structure, it is possible to propagate display information to be displayed on a liquid crystal display device through a space with a simple system, and wiring lines for the transmission of the display information are not needed, so that wiring for a flexible substrate or a connector is simplified. Thus, it is possible to settle various problems caused by complicated wiring, such as an increase in costs and the deterioration of reliability. In addition, an increase in power consumption accompanying high-speed data transmission or impedance matching can be prevented. Further, restrictions in wiring and the arrangement of components can be relieved, and thus it is possible to improve the design or utilization of an electronic apparatus. Furthermore, since an electromagnetic wave used for signal transmission is transmitted at a short distance in the same system, communication can be reliably performed at this distance. In addition, since the strength of a radiated electromagnetic wave can be reduced to a limit level, it is possible to easily take measures for an EMI problem.

Further, the electronic apparatus according to the present invention further comprises an image capturing element; and an image capturing control unit for reading an image signal picked-up by the image capturing element as the first category information and for outputting the signal.

According to the above-mentioned structure, the signal transmission between the image capturing element and a host device using image data obtained by the image capturing device is performed wirelessly. Therefore, wiring lines for connecting them are not needed, and it is possible to solve various problems accompanying an increase in the size of the image capturing element. That is, it is possible to easily mount a folding-type body. Further, since wiring lines for a flexible substrate and a connector are not needed, various problems caused by the wiring lines, such as an increase in costs and the deterioration of reliability, do not arise. In addition, it is possible to cope with high-speed data transmission. In particular, in a camera, since an optical system and electronic components should be mounted in one body, the mounting of the electronic components is largely restricted. However, according to the structure of the present invention, this restriction can be relaxed.

In the electronic apparatus according to the present invention, information transmitted between an electronic circuit on an integrated circuit and the outside of the integrated circuit is transmitted as the first category information wirelessly.

According to the above-mentioned structure, it is possible to make some input/output pins of a package of a semiconductor chip have a wireless transmission function. Therefore, it is possible to decrease the number of wiring lines, and it is also possible to reduce the size and manufacturing costs of the package.

Further, the electronic apparatus according to the present invention further comprises a display unit; a speaker unit; and a data source unit for generating image data displayed on the display unit and sound data for driving the speaker unit, in which the image data and the sound data transmitted between the display unit or the speaker unit and the data source unit are transmitted as the first category information wirelessly.

According to the above-mentioned structure, in a multimedia apparatus for processing image data and sound data, it is possible to easily connect a speaker or a display device to a tuner recorder unit via a wireless connection, thereby easily achieving interconnection.

Furthermore, a wireless communication terminal according to the present invention comprises: a first body; a second body connected to the first body; a connecting portion for connecting the first body to the second body so as to change the positional relationship between the first body and the second body; an external wireless communication antenna mounted on the first body or the second body; an external wireless communication control unit mounted on the first body for controlling external wireless communication using the external wireless communication antenna; a display unit mounted on the second body; a first internal wireless communication antenna mounted on the first body; a second internal wireless communication antenna mounted on the second body; a first internal wireless communication control unit mounted on the first body for controlling internal wireless communication using the first internal wireless communication antenna; a second internal wireless communication control unit mounted on the second body for controlling internal wireless communication using the second internal wireless communication antenna; and a wire communication unit mounted on the first body or the second body for transmitting through a wire transmission line a portion of information to be transmitted by the internal wireless communication.

According to the above-mentioned structure, it is possible to transmit data between the bodies of the wireless communication terminal wirelessly while supplementing the wireless communication with wire communication. Therefore, even when a large amount of data is exchanged between the bodies with a raise in the resolution of the display unit mounted in the wireless communication terminal, it is possible to smoothly perform the data communication between the bodies while suppressing an increase in the number of wiring lines therebetween. As a result, even if a folding-type wireless communication terminal is used, it is possible to prevent a connecting portion thereof from being complicated, and it is also possible to prevent the complication of a mounting process. Therefore, it is possible to achieve a small and lightweight wireless communication terminal having high reliability and a low manufacturing cost. In addition, it is possible to realize a wireless communication terminal having a large screen and advanced functions without damaging portability.

As described above, according to the above-mentioned structures of the present invention, it is possible to perform wireless data transmission by an electromagnetic wave at a short distance in the same electronic apparatus or the same system. Therefore, it is possible to solve various problems accompanying the conventional high-speed data transmission and a problem of mounting, and thus it is possible to realize an electronic apparatus having a low manufacturing cost, high reliability, and low power consumption.

### BRIEF DESCRIPTION OF THE DRAWINGS

FIG. 1 is a perspective view illustrating an unfolded state of a folding-type mobile phone to which a wireless communication controlling method of the present invention is applied.

FIG. 2 is a perspective view illustrating a folded state of the folding-type mobile phone to which the wireless communication controlling method of the present invention is applied.

FIG. 3 is a front view illustrating the external appearance of a rotary mobile phone to which the wireless communication controlling method of the present invention is applied.

FIG. 4 is a block diagram illustrating the main parts of an embodiment of the present invention.

FIG. 5 is a cross-sectional view of an embodiment of an electronic apparatus of the present invention.

FIG. 6 is a block diagram illustrating an embodiment of an electronic apparatus to which an information transmitting method of the present invention is applied.

FIG. 7 is a block diagram illustrating another embodiment of the electronic apparatus using the information transmitting method of the present invention.

FIGS. 8A and 8B are block diagrams respectively illustrating a modulator and a demodulator of fifth and sixth embodiments of the electronic apparatus according to the present invention in more detail.

FIG. 9 is a timing chart illustrating seventh and eighth embodiments according to the present invention.

FIG. 10 is a block diagram illustrating the main parts of an embodiment of another electronic apparatus according to the present invention.

FIG. 11 is a block diagram illustrating the main parts of another embodiment of the electronic apparatus according to the present invention.

FIG. 12 is a block diagram illustrating the main parts of still another embodiment of the electronic apparatus according to the present invention.

FIG. 13 is a block diagram illustrating the main parts of still yet another embodiment of the electronic apparatus according to the present invention.

FIG. 14 is a block diagram illustrating the main parts of yet still another embodiment of the electronic apparatus according to the present invention.

FIG. 15 is a block diagram illustrating the main parts of still yet another embodiment of the electronic apparatus according to the present invention.

FIG. 16 is a cross-sectional view of still another embodiment of the electronic apparatus according to the present invention.

FIG. 17 is a block diagram illustrating yet still another embodiment of the electronic apparatus according to the present invention.

FIGS. 18A and 18B are block diagrams respectively illustrating a modulator and a demodulator of a sixteenth embodiment of the electronic apparatus according to the present invention in more detail.

FIG. 19 is a block diagram illustrating the main parts of still yet another embodiment of the electronic apparatus according to the present invention.

FIG. 20 is a block diagram illustrating the main parts of still yet another embodiment of the electronic apparatus according to the present invention.

FIG. 21 is a block diagram illustrating the main parts of still yet another embodiment of the electronic apparatus according to the present invention.

FIG. 22 is a block diagram illustrating an embodiment of a superimposing circuit and a separating circuit of the electronic apparatus according to the present invention.

FIG. 23 is a block diagram illustrating the main parts of yet still another embodiment of the electronic apparatus according to the present invention.

FIG. 24 is a block diagram illustrating the main parts of still yet another embodiment of the electronic apparatus according to the present invention.

FIG. 25 is a block diagram illustrating still another embodiment of the electronic apparatus according to the present invention.

FIG. 26 is a block diagram illustrating still yet another embodiment of the electronic apparatus according to the present invention.

FIG. 27 is a block diagram illustrating yet still another embodiment of the electronic apparatus according to the present invention.

FIG. 28 is a cross-sectional view illustrating still yet another embodiment of the electronic apparatus according to the present invention.

FIG. 29 is a block diagram illustrating still yet another embodiment of the electronic apparatus according to the present invention.

FIG. 30 is a block diagram illustrating yet still another embodiment of the electronic apparatus according to the present invention.

FIG. 31 is a block diagram illustrating still yet another embodiment of the electronic apparatus according to the present invention.

FIG. 32 is a timing chart illustrating an embodiment of the timing of wire communication and wireless communication.

FIG. 33 is a timing chart illustrating another embodiment of the timing of the wire communication and the wireless communication.

FIG. 34 is a timing chart illustrating still another embodiment of the timing of the wire communication and the wireless communication.

FIG. 35 is a timing chart illustrating still yet another embodiment of the timing of the wire communication and the wireless communication.

FIG. 36 is a timing chart illustrating yet still another embodiment of the timing of the wire communication and the wireless communication.

FIG. 37 is a timing chart illustrating still yet another embodiment of the timing of the wire communication and the wireless communication.

FIG. 38 is a timing chart illustrating yet still another embodiment of the timing of the wire communication and the wireless communication.

FIG. 39 is a timing chart illustrating still yet another embodiment of the timing of the wire communication and the wireless communication.

FIG. 40 is a block diagram illustrating an electronic apparatus having a conventional liquid crystal display body.

FIG. 41 is a timing chart illustrating the operation of the electronic apparatus having the conventional liquid crystal display body.

### DETAILED DESCRIPTION

Hereinafter, embodiment of the present invention will be described with reference to the accompanying drawings.

### First Embodiment

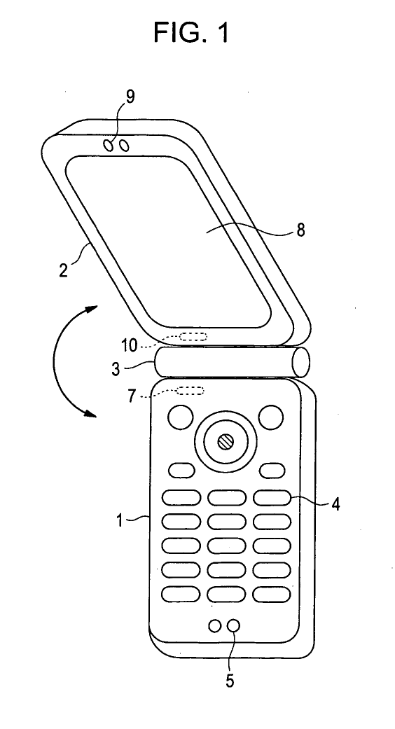

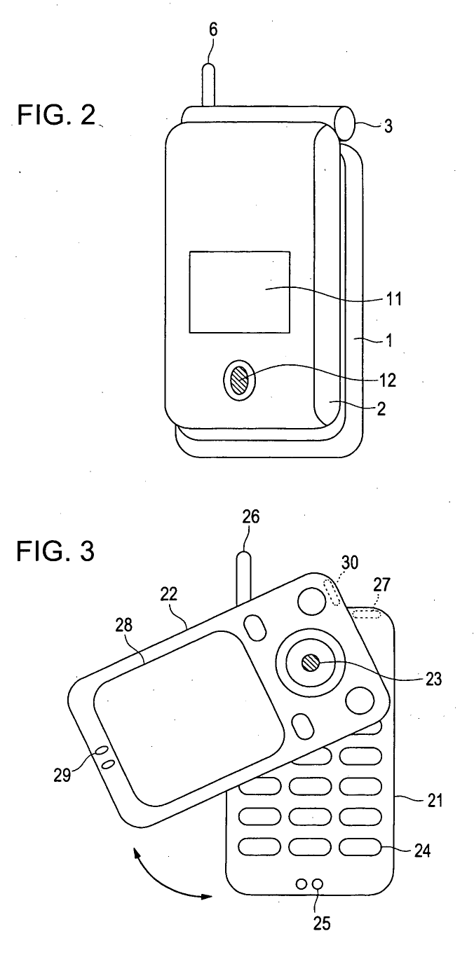

FIG. 1 is a perspective view illustrating a state in which a folding-type mobile phone to which a wireless communication control method according to the present invention is applied is unfolded. FIG. 2 is a perspective view illustrating a state in which the folding-type mobile phone to which the wireless communication control method according the present invention is applied is folded.

In FIGS. 1 and 2, operating buttons 4 are arranged on the surface of a first body 1, and a microphone 5 is provided at the lower end of the first body 1. In addition, an external wireless communication antenna 6 is mounted at the upper end of the first body 1. Further, a display body 8 is provided on the surface of a second body 2, and a speaker 9 is provided at the upper end of the second body 2. Further, a display body 11 and an image capturing element 12 are provided on the back surface of the second body 2. For example, a liquid crystal panel, an organic EL panel, and a plasma display panel may be used as the display bodies 8 and 11. In addition, a CCD, a CMOS sensor, or the like may be used as the image capturing element 12. Further, internal wireless communication antennas 7 and 10 are respectively provided in the first body 1 and the second body 2 for performing the internal wireless communication between the first body 1 and the second body 2.

Furthermore, the first body 1 and the second body 2 are connected to each other through a hinge 3, and it is possible to fold the second body 2 upon the first body 1 by pivoting the second body 2 on the hinge 3, which is a pivotal point. In addition, the second body 2 can be folded upon the first body 1 to protect the operating buttons 4. Therefore, it is possible to prevent the operating buttons 4 from being carelessly operated at the time of the carrying of a mobile phone. Further, unfolding the second body 2 and the first body 1 makes it possible to operate the operating buttons 4 while viewing the display body 8, to make a phone call using the speaker 9 and the microphone 5, or to pick up an image using the operating buttons 4.

The folding-type structure enables the display body 8 to be arranged substantially on the entire surface of the second body 2 without deteriorating the portability of the mobile phone and enables an increase in the size of the display body 8, thereby improving visibility.

Further, the internal wireless communication antennas 7 and 10 are provided in the first body 1 and the second body. 2, respectively, so that it is possible to perform the data transmission between the first body 1 and the second body 2 in the internal wireless communication using the internal wireless communication antennas 7 and 10. For example, image data and voice data received by the external antenna 6 in the first body 1 can be transmitted to the second body 2 by the internal wireless communication using the internal wireless communication antennas 7 and 10 such that an image is displayed on the display body 8 or a voice is output from the speaker 9. In addition, image data relating an image picked up by the image capturing element 12 is transmitted from the second body 2 to the first body 1 in the internal wireless communication using the internal wireless communication antennas 7 and 10 and is then transmitted to the outside through the external wireless communication antenna 6.

Therefore, it is not necessary to perform the data transmission between the first body 1 and the second body 2 via a wire, and thus it is not necessary for a multi-pin flexible wiring substrate to pass through the hinge 3. Thus, it is possible to simplify the structure of the hinge 3 and to simplify a mounting process thereof. As a result, it is possible to achieve a mobile phone having a low manufacturing cost, a small size, and high reliability. In addition, it is possible to realize a mobile phone having a large screen and advanced functions without deteriorating the portability of the mobile phone.

Furthermore, the external wireless communication antenna 6 is mounted in the first body 1. However, the external wireless communication antenna 6 may be mounted in the second body 2. In the latter case, since the external wireless communication antenna 6 is not covered with the second body 2 in use, high-efficiency communication can be realized. In this case, power is applied from a communication control unit for the mobile phone mounted in the first body 1 to the external wireless communication antenna 6 through, for example, a coaxial cable.

Moreover, when the internal wireless communication is performed between the first body 1 and the second body 2, second category information used for controlling or processing first category information used in the internal wireless communication may be transmitted between the first body 1 and the second body 2 via a wire. In this way, a group of signals difficult to transmit at high speed can be wirelessly transmitted, which does not cause various problems accompanying the high-speed transmission of data. In addition, by transmitting signals such as synchronization information which is needed for the wireless transmission via a wire, it is possible to prevent a communication system from being complicated due to the wireless communication system.

### Second Embodiment

FIG. 3 is a perspective view illustrating the external appearance of a rotary mobile phone to which the wireless communication control method according to the present invention is applied.

In FIG. 3, operating buttons 24 are arranged on the surface of a first body 21, and a microphone 25 is provided at the lower end of the first body 21. In addition, an external wireless communication antenna 26 is mounted at the upper end of the first body 21. Further, a display body 28 is provided on the surface of a second body 22, and a speaker 29 is provided at the upper end of the second body 22. Further, internal wireless communication antennas 27 and 30 are respectively provided in the first body 21 and the second body 22 for performing the internal wireless communication between the first body 21 and the second body 22.

Furthermore, the first body 21 and the second body 22 are connected to each other through a hinge 23, and it is possible for the second body 22 to overlap or not to overlap the first body 21 by horizontally pivoting the second body 22 on the hinge 23, which is a pivotal point. In addition, it is possible for the second body 22 to overlap the first body 21 to protect the operating buttons 24. Therefore, it is possible to prevent the operating buttons 24 from being carelessly operated at the time of the carrying of a mobile phone. Further, by horizontally pivoting the second body 22 not to overlap the first body 21, it is possible to operate the operating buttons 24 while viewing the display body 28 and to make a phone call using the speaker 29 and the microphone 25.

Further, the internal wireless communication antennas 27 and 30 are provided in the first body 21 and the second body 22, respectively, so that it is possible to perform the data transmission between the first body 21 and the second body 22 in the internal wireless communication using the internal wireless communication antennas 27 and 30. For example, image data and voice data received in the first body 21 by the external antenna 26 can be transmitted to the second body 22 by the internal wireless communication using the internal wireless communication antennas 27 and 30 such that an image is displayed on the display body 28 or a voice is output from the speaker 29.

Therefore, it is not necessary for a multi-pin flexible wiring substrate to pass through the hinge 23. Thus, it is possible to simplify the structure of the hinge 23 and to simplify a mounting process thereof. As a result, it is possible to achieve a mobile phone having a low manufacturing cost, a small size, and high reliability. In addition, it is possible to realize a mobile phone having a large screen and advanced functions without deteriorating the portability of the mobile phone.

Moreover, when the internal wireless communication is performed between the first body 21 and the second body 22, second category information used for controlling or processing first category information used in the internal wireless communication may be transmitted between the first body 21 and the second body 22 via a wire. In this way, a group of signals difficult to transmit at high speed can be wirelessly transmitted, which does not cause various problems accompanying high-speed data transmission. In addition, by transmitting signals such as synchronization information which is needed for the wireless transmission via a wire, it is possible to prevent a communication system from being complicated due to wireless communication.

Further, in the above-mentioned embodiments, the mobile phone is used as an example, but the present invention may be applied to various electronic apparatuses, such as a video camera, a personal digital assistant (PDA), and a notebook personal computer.

### Third Embodiment

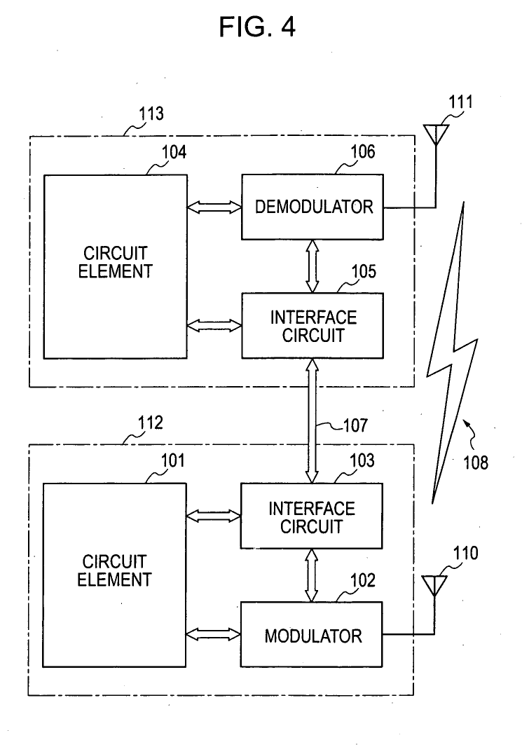

FIG. 4 is a conceptual view illustrating the main parts of an embodiment of an information transmitting method according to the present invention.

FIG. 4 shows a transmitting unit block 112 and a receiving unit block 113, and data is transmitted from the transmitting unit block 112 to the receiving unit block 113. A circuit element 101 having transmitting information is provided in the transmitting unit block 112, and a circuit element 104 for receiving the transmission information is provided in the receiving unit block 113. In addition, interface circuits 103 and 105 communicating with each other by a wire transmission line 107 and a transmitting antenna 110 and a receiving antenna 111 communicating with each other by a wireless propagation path 108 are provided in the transmitting unit block 112 and the receiving unit block 113, respectively.

Further, the transmitting information generated by the circuit element 101 is divided into the first category information and the second category information. The first category information is modulated by a modulator 102, and the modulated signal is transmitted from the transmitting antenna 110 as an electromagnetic wave. The second category information is transmitted to the wire transmission line 107 through the interface circuit 103.

The electromagnetic wave signal carrying the first category information that is transmitted from the transmitting antenna 110 to be propagated through a space (the wireless propagation path 108) is received by the receiving antenna 111 and is then demodulated by a demodulator 106 to be output to the circuit element 104. In addition, the second category information transmitted through the wire transmission line 107 is transmitted to the circuit element 104 through the interface circuit 105. When the second category information is transmitted from the receiving unit block 113 to the transmitting unit block 112, the second category information is transmitted from the interface circuit 105 to the interface circuit 103.

As the first category information, high-speed data difficult to transmit via a wire or parallel data required for multiplexing, such as a bus line, is selected. The information belonging to the first category is wirelessly transmitted. An electromagnetic filed from the transmitting antenna 110 is set to excess an upper limit prescribed by law. A radiation level to be radiated by an unlicensed wireless station is lower than that prescribed by the provisions of EMI. However, since a communication distance is short, it is possible to ensure a communication path having a sufficient quality by appropriately setting a link budget.

As such, since a large amount of information required for high-speed transmission is wirelessly propagated through a space, not via a wire, it is not necessary to use signal lines, and thus it is possible to settle problems caused by the structure of a conventional connector or hinge.

Further, the conventional transmission method using the signal lines has problems in that power consumption increases due to frequent charging and discharging to floating capacitance, and in that, since unnecessary radiating power radiated from the signal lines increases, it is necessary to take measures to prevent the interference of the unnecessary radiating power on peripheral apparatuses. In the transmission using the signal lines, since a logic level is prescribed, it is essentially difficult to decrease power consumption. Therefore, for example, a method of improving a shield is used to decrease unnecessary radiation.

However, according to the method of the present embodiment, since wireless communication is performed at a short distance, that is, within the same system, it is possible to obtain high communication quality. Therefore, it is possible to reduce the radiation power by the transmitting antenna 110 to a predetermined level and thus to essentially decrease power consumption, thereby easily take measures to prevent EMI. In addition, many problems, such as an increase in power consumption generated at the end of a communication line for impedance matching and restrictions in the arrangement of components and wiring, can be settled.

In the wireless communication method used in the present invention, since short-distance communication is performed within a case body or a system, it is possible to operate a wireless communication apparatus using a communication method simpler than that used in the conventional wireless communication method. This method is realized by the second category information transmitted via a wire. The second category information includes information not necessary to be transmitted in large quantities at high speed, synchronization information for wireless transmission or reception, oscillator information, and feedback information for feeding back the received state of data. In particular, in the case in which the synchronization information of a communication packet is transmitted via a wire, a receiver side does not need to have a circuit for extracting the synchronization information. Therefore, it is possible to remarkably simplify circuits of the receiver side.

Further, it is possible to remarkably simplify the structure of a correlator required for spectral diffusion or UWB communication by transmitting the synchronization information of the correlator. In addition, when the oscillator information is transmitted, it is possible to commonize a clock signal used as a standard between reception and transmission. Therefore, the accuracy of an oscillating frequency required for the oscillator is remarkably relieved, and thus an electronic apparatus can be easily realized. Further, when an electronic apparatus has a short-distance communication interface, such as a mobile phone, Bluetooth, or UWB, the electromagnetic wave carrying the first category information may interrupt the original communication of the electronic apparatus. In this case, in order to prevent the interruption of the electromagnetic wave on the original communication, the frequency or transmission power of the electromagnetic wave carrying the first category information is changed by exchanging the second category information relating the operating conditions of an electronic apparatus between the reception and transmission of the first category information. That is, in the mobile phone, the frequency of a transmitting channel thereof is selected as the second category information, and in Bluetooth or UWB, a hopping pattern thereof is selected as the second category information.

The second category information is transmitted from a receiver side of the first category information toward a transmitter side thereof. In this way, the received state of the first category information is fed back. For example, a reproduction request, a request for increasing or decreasing the energy of an electromagnetic wave radiated, or a pre-emphasis parameter for improving signal distortion generated in the transmission path is transmitted from the receiver side to the transmitter side, and thus it is possible to improve communication quality at a low hardware cost. In particular, when the request for increasing or decreasing the energy of the radiated electromagnetic wave is fed back, the receiver side can set the minimum energy of the electromagnetic wave required for securing communication quality, which results in a decrease in unnecessary radiation. Therefore, the signal level of a receiving end is prescribed, and the minimum energy level is a value lower than the energy level of the conventional unnecessary radiation electromagnetic field required for high-speed data transmission via a wire driven together with the floating capacitance by a large amount of energy for securing the prescribed value. Thus, it is possible to easily take measures to prevent EMI. In addition, since signal lines driven with floating capacitance are not used and data is wirelessly transmitted, it is possible to reduce power consumption.

### Fourth Embodiment

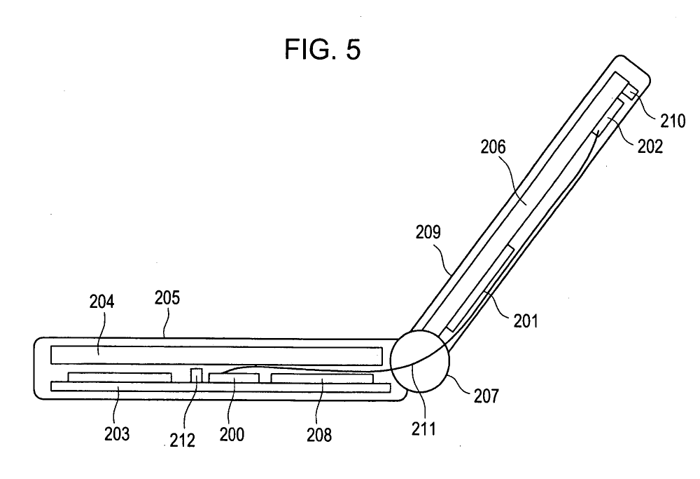

FIG. 5 is a view illustrating an embodiment of an electronic apparatus according the present invention.

In FIG. 5, the electronic apparatus comprises a main body 205 and a display unit 209 which are connected to each other through a hinge 207. In addition, various input-output devices, such as a keyboard and a display device, are connected to the electronic apparatus. That is, the main body 205 is provided with a main body substrate 203 for taking charge of the functional control of the main body of the electronic apparatus, a keyboard 204, serving as an input device, and a liquid crystal controller 208 for generating display data to control electronic components on the main body substrate 203. In addition, a liquid crystal display body 206, serving as a display device, is provided in the display unit 209. Further, a transmitting antenna 212 and a receiving antenna 210 are respectively provided in the main body 205 and the display unit 209 to perform wireless communication therebetween. The main body 205 and the display unit 209 are connected to each other through a transmission line 211 for performing wire communication therebetween.

The display data generated from the liquid crystal controller 208 is transmitted to a modulator 200 as the first category information and is then modulated. Then, the modulated data is converted into an electromagnetic wave (a radio wave) by the transmitting antenna 212 to be propagated through a space. The electromagnetic wave signal transmitted from the transmitting antenna 212 is received by the receiving antenna 210 and is then demodulated into the display data by a demodulator 202. Subsequently, the display data is transmitted to a liquid crystal driver 201 and is then displayed on the liquid crystal display body 206.

Synchronizing signals of the modulator 200 and the demodulator 202 are transmitted to the demodulator 202 as the second category information through the transmission line 211. In the present embodiment, since these signals are transmitted at relatively high speed and the number of signal lines is small, it is possible to easily arrange the signal lines through the hinge. Therefore, according to the present embodiment, it is possible to increase the degree of freedom on the arrangement of components or signal lines. In addition, as shown in FIG. 5, the modulator 200 and the transmitting antenna 212, which are transmitting components, and the demodulator 202 and the receiving antenna 210, which are receiving components, can be arranged at a distant position from the hinge 207.

With an increase in the speed of data transmission, it is difficult to transmit data through transmission lines, but wireless data transmission can be more easily performed. Therefore, when transmitting signals via a wire and synchronizing the modulator 200 with the demodulator 202, the demodulator 202 does not need to detect synchronization. Therefore, it is possible to simplify the structure of circuits. With the advance of a semiconductor element manufacturing technique in recent years, it is possible to simplify the modulator 200 and the demodulator 202 capable of wirelessly transmitting high-frequency signals, and these components can be easily integrated into the electronic apparatus, thereby achieving an electronic apparatus having a low manufacturing cost and high practicality.

### Fifth Embodiment

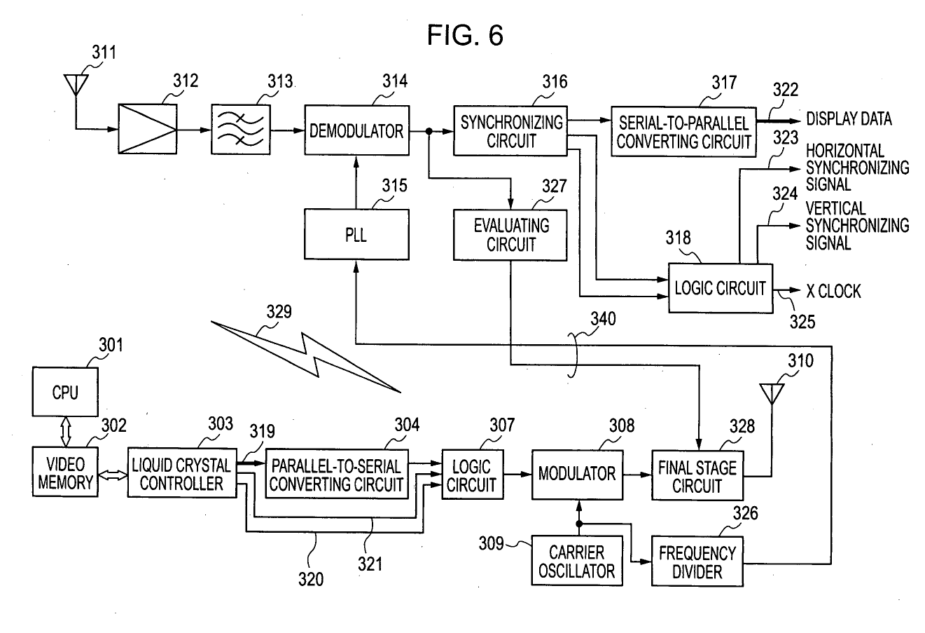

FIG. 6 is a block diagram illustrating an embodiment of the electronic apparatus to which an information transmitting method according to the present invention is applied.

In FIG. 6, a CPU 301 generates display data by calculation, and the display data is stored in a video memory 302. A liquid crystal controller 303 reads data 309 to be displayed on a display body from the video memory 302 in a predetermined sequence and outputs the read data together with a vertical synchronizing signal 321 and a horizontal synchronizing signal 320. Generally, since the data 319 for display is read in parallel from the video memory 302 in pixel units for every word, the read data is parallel-to-serial converted by a parallel-to-serial converting circuit 304 and is then transmitted to a logic circuit 307. The logic circuit 307 receives a signal output from the parallel-to-serial converting circuit 304 and the horizontal synchronizing signal 320 and the vertical synchronizing signal 321 output from the liquid crystal controller 303 to generate a packet and attaches a preamble for obtaining synchronization required for communication, such as a synchronization detecting timing, to the packet. The packet is modulated in the modulator 308 by a carrier frequency generated from a carrier oscillator 309 and is then transmitted from the transmitting antenna 310 via a final state circuit 328. At the same time, the output of the carrier oscillator 309 is divided by a frequency divider 326 and is then converted into a low frequency to be transmitted to the receiver side as one of the second category information items through a wire transmission line 340.

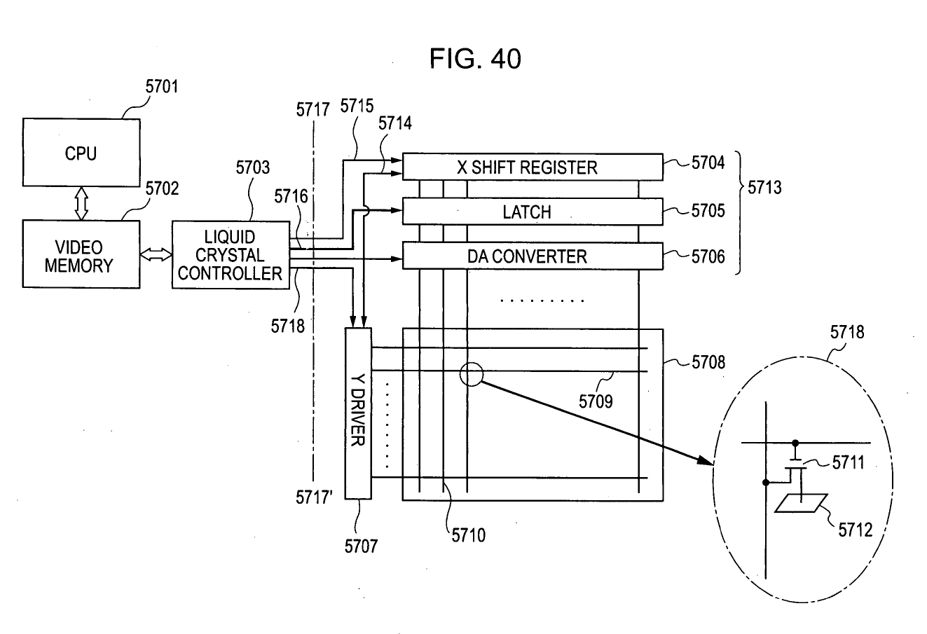

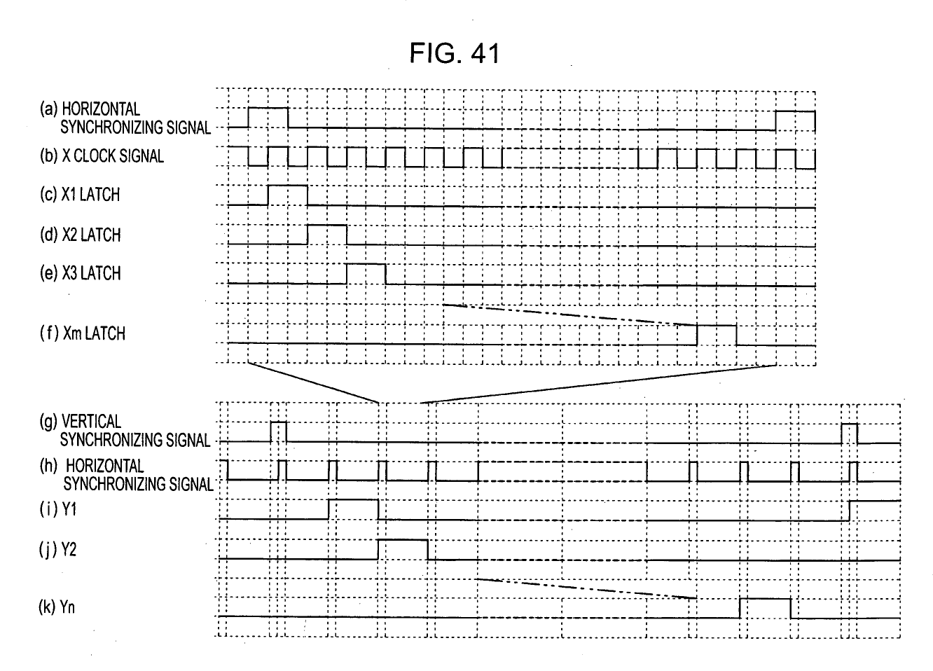

The receiving antenna 311 receives an electromagnetic wave signal transmitted from the transmitting antenna 310. The signal received by the receiving antenna 311 is amplified by a preamplifier 312, and a band-pass filter 313 filters the amplified signal to remove signal components of an unnecessary band. Then, the filtered signal is input to the demodulator 314. A phase-lock loop (PLL) circuit 315 multiplies the frequency of the signal transmitted from the frequency divider 326 through the wire transmission line 340 as one of the second category information items to restore the carrier frequency and then supplies the restored frequency to the demodulator 314. Subsequently, the demodulator 314 demodulates the electromagnetic wave signal. A synchronizing circuit 316 detects a preamble from the received signal packet to detect synchronizing timing required for demodulation and synchronizing signals for driving liquid crystal. The logic circuit 318 generates the horizontal synchronizing signal 323, the vertical synchronizing signal 324, and a transmission clock 325 for an X driver by matching the timing with the display data 322 in the demodulated packet and outputs them to a driver of the liquid crystal display body as signals corresponding to a display data signal 5716, a horizontal synchronizing signal 5714, and a vertical synchronizing signal 5718, and an X clock signal 5715 shown in FIG. 40 to perform display.

A frequency that does not affect the original function of an electronic apparatus using a radio wave, such as a radio receiver or a mobile phone, and that is not affected by the electronic apparatus is selected as the oscillating frequency of the carrier oscillator 309. When a frequency of 2 GHz or more is selected, an occupied band is about 20 MHz even if data of 100 Mbps is transmitted. In this case, the frequency can be generally used without any problem.

In general, in the wireless communication, it is necessary that the modulator 308 on the receiver side and the demodulator 314 on the transmitter side have the same carrier frequency, and the carrier oscillator has to generate a frequency with high accuracy in transmission and reception. Therefore, a difference in frequency directly causes the deterioration of communication quality. Further, according to the above-mentioned structure of the present invention, since the modulator 308 and the demodulator 314 use signals from the same carrier oscillator 309 as reference, the difference does not occur. Thus, the accuracy of the carrier oscillator 309 does not matter, and manufacturing costs are reduced. The frequency divider 326 and the PLL 315 are not necessarily needed, and any circuit capable of transmitting the output of the carrier oscillator 309 to the demodulator 314 may be used. However, in general, since the carrier wave has a high frequency, it is difficult to transmit the carrier wave through the wire transmission line. Therefore, it is more realizable that a high-frequency carrier wave is frequency-divided into low-frequency carrier waves in the above-mentioned way, and that the low-frequency carrier waves are multiplied by the PLL 315 to restore a carrier wave equal to the output of the carrier oscillator 309.

An evaluating circuit 327 evaluates receiving conditions as a reception error rate by, for example, CRC, on the basis of the output of the demodulator 314 and then feeds back the result to the final stage circuit 328 through the wire transmission line 340 as the second category information. The final stage circuit 328 controls power to be applied to the transmitting antenna 310 such that the level of transmitting power becomes the minimum level to secure the sufficient communication quality of the electromagnetic signal in the receiver side. In this way, it is possible to maintain communication quality with radiation power having a level much smaller than that of unnecessary radiation power generated in the conventional wire transmission line where the level of the received signal should be maintained to a predetermined value, which is a basic measure for EMI.

Further, it is possible to give pre-emphasis or pre-distortion to an electromagnetic field generated to compensate propagation path characteristics of the radiation electromagnetic field, using the feedback information. Therefore, it is possible to obtain a predetermined communication quality with a predetermined power of the radiation electromagnetic field. In addition, in the conventional technique, the transmission power and the propagation path characteristics are greatly affected by the, arrangement of components, and it is necessary to adjust parameters in a trial and error manner by a trial manufacturing method at the beginning of machine design. However, according to the above-mentioned structure, since the adjustment or setup of the parameters is automatically performed, it is possible to greatly reduce the number of development processes. The method of maintaining communication quality by controlling the transmitter side according to the present embodiment has a different conception from the conventional wireless communication technique in which an AGC (automatic gain control) circuit is provided on the receiver side to control the sensitivity (gain) of a receiver. That is, according to the present embodiment, it is possible to simplify the structure of a system and to decrease unnecessary radiation to the minimum level.

According to the above-mentioned structure, it is possible to wirelessly transmit display data to the display body at high speed and in large quantities. In addition, it is possible to settle various problems, such as an increase in power consumption, the restriction of wiring position, an EMI problem, and the deterioration of reliability, which occur with an increase in the size of a display body.

### Sixth Embodiment

In the fifth embodiment, the horizontal synchronizing signal and vertical synchronizing signal of the display body are made of packets and are then transmitted as the first category information through an electromagnetic wave path 329. However, the output of the liquid crystal controller 303 may be directly transmitted to the logic circuit 318 as the second category information through the wire transmission line.

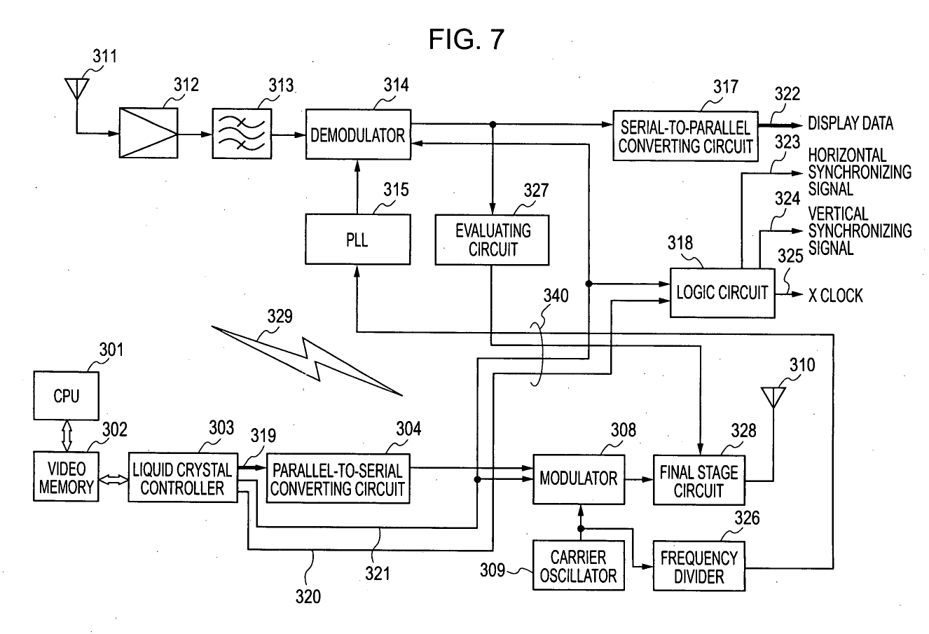

FIG. 7 is a block diagram schematically illustrating an information transmitting method according to the present invention and the main parts of an electronic apparatus using the information transmitting method. In addition, FIG. 7 shows an embodiment in which the structures of the logic circuit 307 and the synchronizing circuit 316 are simplified on the basis of the above-mentioned conception. In FIG. 7, the same components as those in FIG. 6 have the same reference numerals and the same functions.

In FIG. 7, the horizontal synchronizing signal 320 and the vertical synchronizing signal 321 output from the liquid crystal controller 303 are transmitted to the receiver side as the second category information via a wire. That is, the horizontal synchronizing signal 320 does not pass through the logic circuit 307 on the transmitter side shown in FIG. 6, but is directly supplied to the logic circuit 318 on the receiver side. Further, the vertical synchronizing signal 321 does not pass through the logic circuit 307 on the transmitter side shown in FIG. 6, but is directly supplied to the demodulator 314 and the logic circuit 318 on the receiver side.

In this way, when the transmission packet is transmitted in synchronism with these synchronizing signals, it is not necessary for the receiver side to detect the synchronization of the packet for notifying the start of the packet. Therefore, the synchronizing circuit 316 and the logic circuit 307 are not needed, and their structures are remarkably simplified.

### Seventh Embodiment

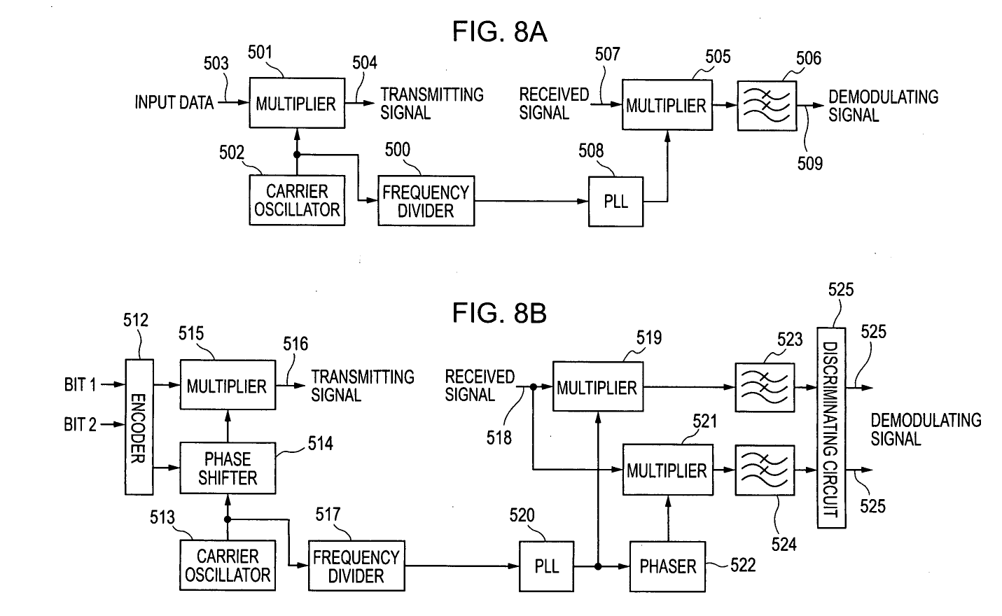

FIG. 8A is a block diagram illustrating the main parts of an electronic apparatus according to an embodiment of the present invention and illustrates the modulator 308 and the demodulator 314 of the fifth and sixth embodiments in detail.

In FIG. 8A, a carrier oscillator 502 is a square pulse oscillator corresponding to the carrier oscillator 309 of the fifth embodiment. A multiplier 501 multiplies signals output from the carrier oscillator 502 by input data 503 and outputs the multiplied signals to a transmitting antenna as a transmitting signal 504. A multiplier 501 may be an exclusive OR circuit since the input data 503 and the output of the carrier oscillator 502 are digital signals. When a logical value 0 corresponds to an analog value 1 and a logical value 1 corresponds to an analog value −1, the input/output of the exclusive OR circuit temporally functions as a multiplier. In addition, since a communication distance is very short, a component, such as a filter, is not needed between an antenna and the output of a modulator because the interference of a high frequency with other apparatuses occurs little.

The demodulator 314 operates as follows. The received signal received by the receiving antenna 311 in FIG. 6 is amplified, so that its unnecessary band is removed, and the signal is then input to a multiplier 505 as a received signal 507. Then, the signal is reproduced by a PLL 508 and is multiplied by a carrier wave clock signal. Subsequently, high-frequency components of the multiplied signal are removed by a low-pass filter 506, and the signal is then demodulated to a demodulation signal 509. The low-pass filter 506 removes high-frequency components (thin pulse components generated due to a little difference in phase between the received signal 507 and the reproduction clock of the PLL 508) of the signal output from the multiplier 505 and outputs the signal as the demodulation signal 509. The PLL 508 reproduces a carrier frequency before frequency division on the basis of the output of the carrier oscillator 502 whose frequency is lowered by dividing the frequency of the signal transmitted as the second category information via a wire using the frequency divider 500.

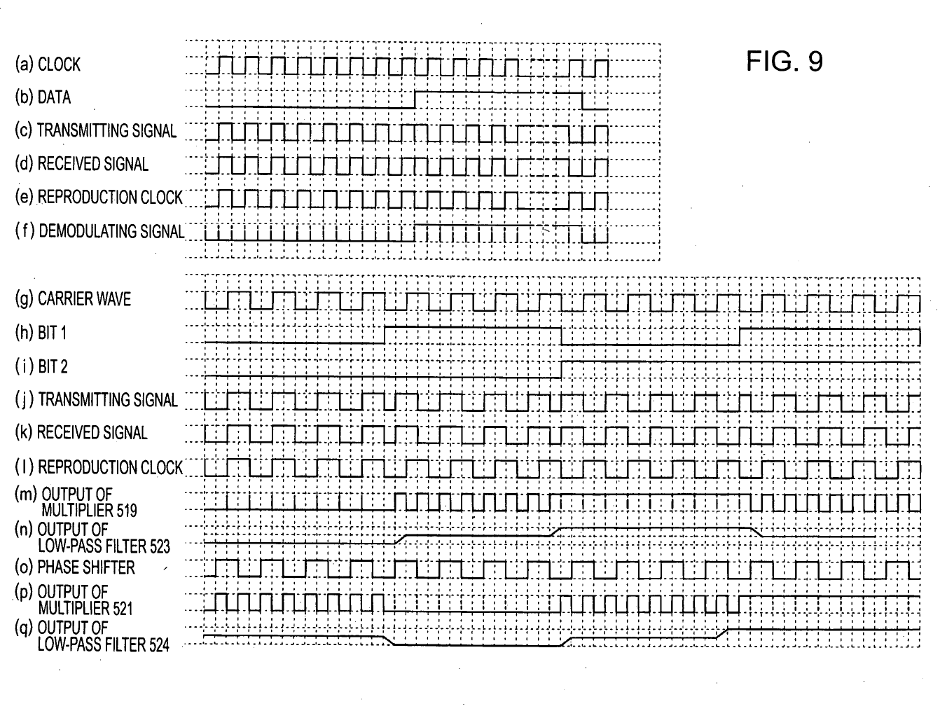

FIG. 9 includes timing charts (a) to (c) of the above-mentioned demodulator 308. That is, (a) in FIG. 9 illustrates a carrier wave clock signal generated by the carrier oscillator 502, and (b) in FIG. 9 illustrates the transmission data 503. (c) in FIG. 9 illustrates the output transmitting signal 504. In the timing charts shown in (a) to (c) in FIG. 9, from the viewpoint of a digital circuit, the modulator 308 is an exclusive OR circuit, and from the viewpoint of an analog circuit having analog values ±1, the modulator 308 is a multiplier.

FIG. 9 includes timing charts (d) to (f) of the demodulator in the seventh embodiment. That is, (d) in FIG. 9 shows a received signal, and (e) in FIG. 9 shows a pulse string generated by the PLL 508. In addition, (f) in FIG. 9 shows the output of the multiplier 505. The low-pass filter 506 removes high-frequency components generated due to a little difference in phase between the received signal 507 and the output of the PLL 508 from the output of the multiplier 505 and then restores the demodulation signal 509.

As can be clearly seen from (d) to (f) in FIG. 9, when the carrier wave clock ((a) in FIG. 9) and the reproduction clock ((e) in FIG. 9) have different frequencies or different phases, demodulation is not performed well. In the conventional wireless communication, high-precision oscillators are respectively provided in the transmitter side and the receiver side to suppress an error to the minimum level. However, according to the present embodiment having the above-mentioned structure, since the reproduction clock on the receiver side is based on the carrier oscillator 502 on the receiver side, it is possible to make a reproduction clock always have the same frequency. Therefore, an error caused by the stability or accuracy of an oscillating frequency does not occur. Thus, it is possible to constitute a circuit having high stability with an inexpensive oscillator.

In the wireless signal transmitting method used in the present invention, since a communication distance is short, it is possible to obtain communication quality having a high S/N ratio. Therefore, it is possible to sufficiently amplify signals from the viewpoint of digitalization. In this case, the level of the amplified signal increases to the level of a logical value. However, the load driven by the logical value is small since communication is performed at a short distance in the same semiconductor chip, not at a long distance from a CPU to a display body, which causes a large floating capacitance. Thus, power consumption decreases. In addition, even when the received signal 507 has an analog level that is not amplified to the logical value level, it is possible to realize a multiplication with a simple switching circuit since the output (having values of ±1) of the PLL 508 is a square wave. That is, two amplifiers whose absolute values of the degree of amplification are equal to each other and whose polarities are reverse to each other are provided. In addition, when the output of the PLL 508 is 1 in logical level, the output of an inverting amplifier with respect to the received signal 507 is selected by a switch. When the output of the PLL 508 is 0 in logical level, the output of the inverting amplifier with respect to the received signal 507 is selected. The circuit having the above-mentioned structure may be used as the multiplier 505.

According to the above-mentioned structure, the modulator 308 can be composed of an exclusive OR circuit, and the demodulator 314 can also be composed of only an exclusive OR circuit, or an amplifier having positive and negative degrees of amplification, a switch circuit, and a low-pass filter. Therefore, it is possible to realize the modulator and the demodulator with a simple structure.

### Eighth Embodiment

FIG. 8B is a block diagram illustrating the main parts of an electronic apparatus according to an embodiment of the present invention. In addition, FIG. 8B illustrates another example of the modulator 308 and the demodulator 314 described in the fifth and sixth embodiments in detail.

In the seventh embodiment, simplified BPSK modulation is described as an example. However, the eighth embodiment is described based on QPSK modulation in order to explain a case in which more general phase modulation is used. The carrier oscillator 513 is a square pulse oscillator corresponding to the carrier oscillator 309 in the fifth or sixth embodiment. In QPSK modulation, a 2-bit transmitting signal (that is, a data bit 1 and a data bit 2) is allocated in each symbol and is encoded to transmit it. That is, the amount of phase difference is encoded with respect to a reference clock as shown in Table 1 and is then modulated to transmit it. An encoder 512 controls a phase shifter 514 and a multiplier 515 such that phase shift is generated as shown in Table 1 by bit-patterning the data bit 1 and the data bit 2.

TABLE 1

| | | | | |
|---|---|---|---|---|
| Bit 1 | 0 | 1 | 0 | 1 |
| Bit 2 | 0 | 0 | 1 | 1 |
| Shift | 0 | +90° | +180° | +270° |
| Amount | | | | |

FIG. 9 includes timing charts (g) to (j) illustrating the operations of the respective units of the modulator shown in FIG. 8B. The bit 1 ((h) in FIG. 9) and bit 2 ((i) in FIG. 9) of the transmission data are encoded by the encoder 512. The encoder 512 controls the phase shifter 514 to shift the phase of the carrier wave ((g) in FIG. 9) oscillated by the carrier oscillator 513 by 90° and controls the multiplier 515 to reverse the phase of the carrier wave (that is, a phase shift of 180° ). Finally, the encoder 512 outputs the transmitting signal 515 (j) in FIG. 9) subjected to the QPSK modulation.

A frequency divider 517 corresponds to the frequency divider 326 in the fifth or sixth embodiment, and a PLL 520 corresponds to the PLL 315 in the fifth or sixth embodiment and generates a reproduction clock (l) in FIG. 9). The reproduction clock output from the PLL 520 is multiplied by a received signal 518 ((k) in FIG. 9) by a first multiplier 519, and the multiplied signal is transmitted to a first low-pass filter 523 to remove high-frequency components. Then, the signal is transmitted to a discriminating circuit 525. At the same time, the received signal 518 is multiplied by a pulse string ((o) in FIG. 9) obtained by 90° shifting the phase of a reproduction clock pulse string reproduced from the PLL 520 by 90° using a phase shifter 522 by a second multiplier 521, and high-frequency components of the multiplied signal are removed by a second low-pass filter 524. Then, the signal is transmitted to the discriminating circuit 525. The discriminating circuit 525 extracts the transmission data from the outputs ((n) and (q) in FIG. 9) of the first and second low-pass filters 523 and 524 to demodulate the received signal 518.

According to the above-mentioned structure, it is possible to transmit data at high speed without increasing the occupied band of the transmitting signal 516. In addition, since a simple digital circuit can be composed of only the modulator and the demodulator, the circuit can be incorporated into a semiconductor chip, and thus it is possible to reduce manufacturing costs and power consumption. Further, since the reproduction clock necessary for the receiver side is generated on the basis of the same carrier oscillator 513 as in the transmitter side, an error caused by a difference in the accuracy of a clock frequency between reception and transmission does not occur. It is possible to realize stable data transmission using an inexpensive oscillator. In addition, even when the transmitter side one-sidedly changes the frequency of the carrier oscillator 513, the receiver side always follows the frequency of the carrier oscillator 513. Therefore, for example, in an electronic apparatus, such as a wireless communication apparatus, it is possible for the transmitter side to one-sidedly select a frequency so as not to interfere with a communication channel (this can be applied to any one of the fifth to seventh embodiments). That is, it is possible to easily take measures to prevent interference or interruption in communication, which is an original object of any communication apparatus.

### Ninth Embodiment

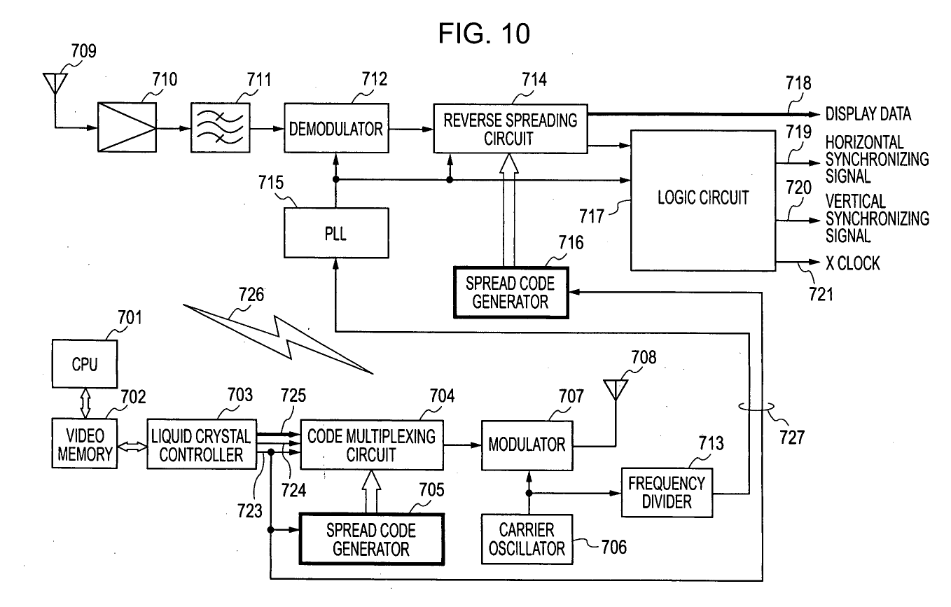

FIG. 10 is a block diagram illustrating an embodiment of the electronic apparatus to which an information transmitting method according to the present invention is applied.

In FIG. 10, a CPU 701, a video memory 702, and a liquid crystal controller 703 have the same functions as those in the fifth and sixth embodiments. A horizontal synchronizing signal 723, a vertical synchronizing signal 724, and display data 725 generated by the liquid crystal controller 703 are multiplexed with a spread code generated from a spread code generator 705 by a code multiplexing circuit 704. In the present embodiment, since parallel data is multiplexed as follows, the parallel-to-serial conversion by the parallel-to-serial converting circuit 304 in the fifth or sixth embodiment is not needed. Therefore, a serial-to-parallel converting circuit 317 for reverse conversion is not also needed.

As the spread code, code sets orthogonal to each other are mainly used. Since the display data 725 is read in a packet from the video memory 702 for every pixel, the display data 725 is output as parallel digital data. Each bit of the data signal is multiplied by each code generated by the spread code generator 705 (or they are calculated by an exclusive OR operation), and an analog operation is performed on the multiplied signal to multiplex it. The multiplexed signal is modulated into a carrier wave generated from the carrier oscillator 706 by the modulator 707, and the modulated signal is transmitted from a transmitting antenna 708 as the first category information through a wireless communication path 726.

The transmitted electromagnetic wave signal is received by a receiving antenna 709 and is then amplified by a preamplifier 710. Then, a band-pass filter 711 removes unnecessary signals out of a predetermined bandwidth from the amplified signal, and a demodulator 712 demodulates the signal. A frequency divider 713 divides the frequency of a carrier wave generated by the carrier oscillator 706, and the frequency-divided signal is input to a PLL 715 as the second category information. Then, the PLL 715 multiplies the signal to restore the frequency of the carrier wave. The signal demodulated by a demodulator 712 is input to a reverse spreading circuit 714, and the reverse spreading circuit 714 calculates correlation with the spread code generated by the spread code generator 716 for multiplexing, thereby dividing the multiplexed data. A logic circuit 717 generates a display data signal 718, a horizontal synchronizing signal 719, and a vertical synchronizing signal 720 for driving a liquid crystal driver, and a clock signal 721 for an X driver, based on the detected display data or various timings and then transmits these signals to a liquid crystal display body to perform display.

Since the demodulator 712 uses the carrier wave generated by the PLL 715 on the basis of the same frequency as that input to the modulator 707 from the carrier oscillator 706, an error caused by a difference in the accuracy of a carrier wave frequency does not occur. In addition, the timing for the synchronization detection of the demodulator 712 or the timing for reverse spread can be generated, based on a horizontal synchronizing signal 723 transmitted as the second category information via a wire. Therefore, it is not necessary to provide a circuit for synchronization compensation on the receiver side, thereby simplify the structure of a circuit. In particular, in case of code multiplexing, it is possible to use a correlator, not a matching filter, as the reverse spreading circuit.

As well known, the circuit structure of a matching filter used for reverse spread is complicated. However, in the present embodiment, response time is short, and synchronization is also not needed. Meanwhile, when a correlator is used for reverse spread, it is difficult to perform the reverse spread if synchronization is not taken. In this case, generally, since calculation is performed in the manner of trial and error by sliding chips one by one, it takes a long time to perform the reverse spread. Therefore, according to the above-mentioned structure of the present embodiment, since the synchronization information of the correlator is transmitted as the second category information via a wire, it is not necessary to perform synchronization capture or sliding. Thus, it is possible to perform the reverse spread using a very simple circuit.

According to the above-mentioned structure, it is possible to multiplex signals to receive and transmit them without performing the parallel-to-serial conversion of data, which has an effect of installing several bus lines in parallel. Particularly, multiplexing by orthogonal codes is performed without limitation, and a physical space, such as a bus line, is not needed. In addition, a plurality of transmitting portions and a plurality of receiving portion are provided, and thus it is possible to simultaneously perform communication at several different places where signal transmission or reception should be performed. Further, it is possible to obtain a spread gain by spread. In particular, in an electronic apparatus generating a radio wave, such as a mobile phone, there is an effect of improving an interference resisting characteristic or an interference characteristic with respect to a radio wave, which is an original object of the apparatus. In addition, since synchronization information and information on a carrier frequency are transmitted as the second category information via a wire, it is possible to easily match carrier frequencies between transmission and reception. Therefore, the carrier oscillator 706 does not need to have high precision. In addition, synchronization capture for reverse spread is also not needed, and it is possible to considerably simplify the reverse spreading circuit 714.

### Tenth Embodiment

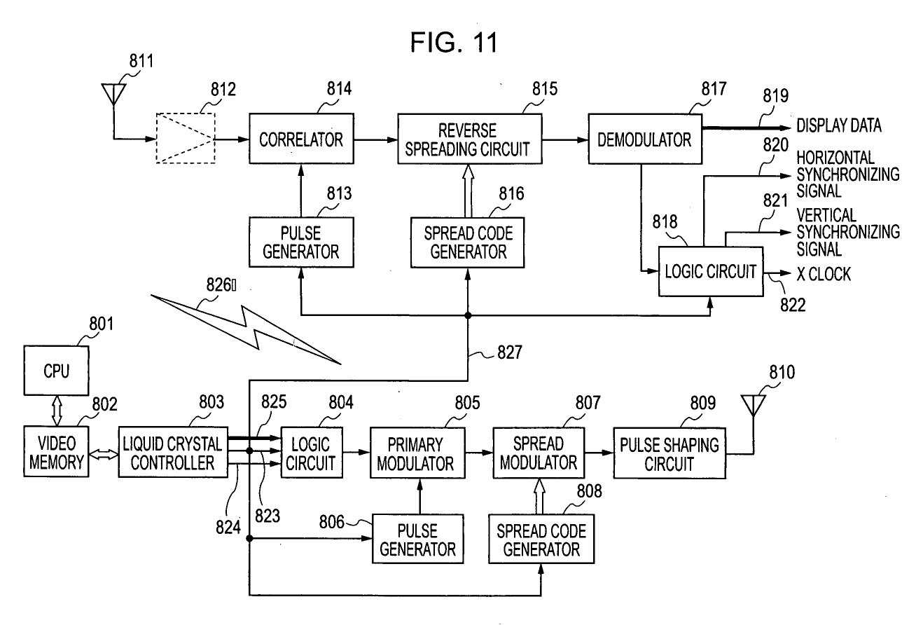

FIG. 11 is a block diagram illustrating a data transmitting method and the main parts of an electronic apparatus according to an embodiment of the present invention.

In FIG. 11, a CPU 801, a video memory 802, and a liquid crystal controller 803 have the same functions as those in the fifth and sixth embodiments. A logic circuit 804 performs the rearrangement of data, such as parallel-to-serial conversion, preamble attachment, or packet construction, on a horizontal synchronizing signal 823, a vertical synchronizing signal 824, and display data 825 generated by the liquid crystal controller 803 to convert these signals into serial signals. A primary modulator 805 modulates these signals with a pulse string generated by a pulse generator 806. In the primary modulation, pulse position modulation or bypass pulse modulation is performed on the pulse string. The signals subjected to the primary modulation are spread-modulated by a spread modulator 807 with a spread code generated by a spread code generator 808.

The spread-modulated pulse string is waveform-shaped by a pulse shaping circuit 809 into a wide-band pulse having a low spectral density and having a very short period and is then radiated from a transmitting antenna 810 as an electromagnetic wave. The electromagnetic wave to be radiated is not a wave obtained by modulating a sine wave, but is a very thin pulse string. A communication method in which a wide-band pulse is used as a short pulse is called an impulse radio communication method or a UWB communication method.

The radiated electromagnetic wave is transmitted through a wireless propagation path 826 and is then received by a receiving antenna 811. The received signal is amplified by a preamplifier 812 if necessary, and a correlator 814 calculates the correlation between the amplified signal and a pulse template generated by a pulse generator 813. The output of the correlator 814 is reversely spread by a reverse spreading circuit 815, based on the spread code generated by a spread code generator 816, and then the reversely spread signal is demodulated by a demodulator 817. Then, the demodulated signal is converted into a signal before the primary modulation (the input of the primary modulator 805). A logic circuit 818 generates a display data signal 819, a horizontal synchronizing signal 820, and a vertical synchronizing signal 821 for driving a liquid crystal driver, and an X clock signal 822 for an X driver, based on display data detected by the demodulator 817 or a horizontal synchronizing signal 823 transmitted from the transmitter side as the second category information through a wire transmission path 827, and then transmits these signals to a liquid crystal display body to perform display. When the receiver side has such timing information used as a standard, the structures of the correlator.814 and the logic circuit 818 can be remarkably simplified, compared to a case in which no timing information used as a standard exists.

In the UWB communication, a short pulse having a low spectral density is used. When UWB is used, the upper limit of radiation energy prescribed by law is permitted up to an unnecessary radiation level restricted by EMI, which is much lower than the upper limit of a wireless station that does not require license (about 20 dB). Therefore, in an electronic apparatus generating a strong radio wave, such as a mobile phone, it is possible to easily make a link budget capable of securing a sufficient communication,quality. Since a pulse used is set to have a high wave height by narrowing a pulse width, it is possible to omit the preamplifier 812.

In case of an electronic apparatus having UWB as an interface for short-distance communication, when the present embodiment is applied to data transmission in the electronic apparatus, interference possibly occurs therebetween. However, this problem can be settled by performing frequency hopping for synchronizing the window on a time axis and by synchronizing the hopping sequence. In this case, the second category information of the present embodiment may be applied as synchronization information.

According to the above-mentioned structure, a modulating operation can be performed only on the time axis, and most of components can be realized only by digital circuits dealing with a pulse. In addition, it is possible to easily form circuit elements using ICs. Further, by adopting a short pulse, it is possible to obtain a spread gain in the direction of the time axis, and it is possible to improve an interference resisting characteristic and interference characteristics with respect to a radio wave radiated, which is an original function of an electronic apparatus. In addition, it is possible to achieve data transmitting lines having multi-channels.

### Eleventh Embodiment

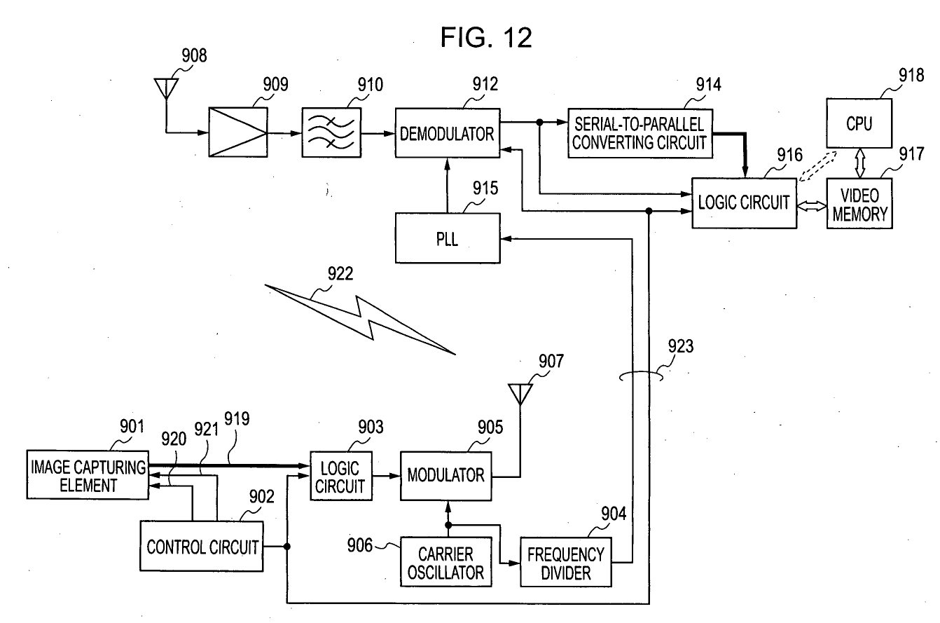

FIG. 12 is a block diagram illustrating the main parts of an electronic apparatus according to another embodiment of the present invention and shows an example in which an information transmitting method is applied to an electronic apparatus using an image capturing element.

In FIG. 12, an image capturing element 901 is driven by a horizontal synchronizing signal 920 and a vertical synchronizing signal 921 generated from a control circuit 902 to pick up an image and outputs image data 919 related to the captured image. A logic circuit 903 receives these signals to construct a packet for wireless transmission. The packet is modulated with a carrier wave generated from a carrier oscillator 906 by a modulator 905, and the modulated signal is radiated from a transmitting antenna 907 as an electromagnetic wave.

The electromagnetic wave signal transmitted from the transmitting antenna 907 is propagated through a wireless propagation path (space) 922 and is received by a receiving antenna 908. Then, the received signal is amplified by a preamplifier 909, and a band-pass filter 910 removes unnecessary signals out of a predetermined bandwidth from the amplified signal. Subsequently, the signal is input to a demodulator 912. A carrier wave output from a carrier oscillator 906 is frequency-divided by a frequency divider 904, and the divided waves are transmitted to a PLL 915 as the second category information through a wire transmission line 923. Then, the PLL 915 multiplies the output of the frequency divider 904 by a carrier frequency to generate a carrier wave. The carrier wave is then input to a demodulator 912. The demodulator 912 demodulates the received signal, based on synchronization timing necessary for demodulation included in the signal transmitted from the control circuit 902 as the second category information through the wire transmission line 923. A serial-to-parallel converting circuit 914 extracts image data from the demodulated reception packet and performs serial-to-parallel conversion on every pixel to generate pixel data.

The logic circuit 916 generates a memory address to be written on a video memory 917 corresponding to the demodulated pixel data and writes the image data on the corresponding address of the video memory 917 directly or through a CPU 918. The CPU 918 accesses the video memory 917 to use the image data for various applications.

In general, the start of the image capturing element 901 is controlled by the CPU 918. However, in a method of transmitting information on the start to the control circuit 902 of the image capturing element 901, since a bit rate is low, the information may be transmitted as the second category information via a wire. In addition, the information can be wirelessly transmitted. In the latter case, the CPU 918 and the image capturing element 901 each have transmitting/receiving units to perform bidirectional communication. In particular, in a folding-type mobile phone, the image capturing element 901 is arranged in the vicinity of a display element, and the image capturing element 901 and the display element are generally arranged opposite to the CPU 918. In addition, the image data relating a captured image is transmitted to the CPU 918 to be processed, and the processed data is transmitted to the display element. This case can be realized by combining the structure in the fifth embodiment with the structure in the sixth embodiment back-to-back.

According to the above-mentioned structure in which data transmission from the image capturing element 901 is preformed wirelessly, it is possible to settle various problems caused via a wire transmission, such as an increase in power consumption, the restriction of wiring position, an EMI problem, and the deterioration of reliability, which occur with an increase in the size of the image capturing element 901. Since the synchronization timing necessary for demodulation is transmitted via a wire in the receiver side, synchronization capture is not needed, which results in a circuit having a considerably simple structure. In addition, since a carrier wave generated by the same oscillating source is used as a standard in the receiver side, high-frequency accuracy required for the carrier oscillator 906 is remarkably released, thereby decreasing manufacturing costs and improving reliability.

### Twelfth Embodiment

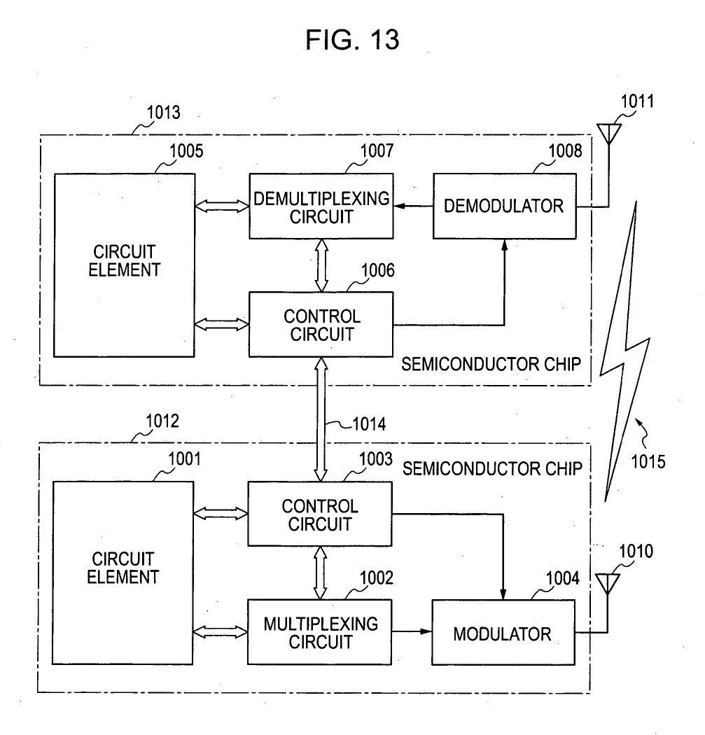

FIG. 13 is a diagram illustrating an electronic apparatus according to still another embodiment to which an information transmitting method according to the present invention is applied, and shows an example in which data transmission is performed between semiconductor chips.

In FIG. 13, a semiconductor chip 1012 is provided with a circuit element 1001 having (generating) a plurality of data to be transmitted from the semiconductor chip 1012, and a semiconductor chip 1013 is provided with a circuit element 1005 receiving the data of the semiconductor chip 1012. In addition, the semiconductor chips 1012 and 1013 have control circuits 1003 and 1006 for communicating with each other via a wire transmission line 1014, respectively. Further, the semiconductor chips 1012 and 1013 have a transmitting antenna 1010 and a receiving antenna 1011 for communicating with each other via a wireless propagation path 1015, respectively. Data is transmitted from the semiconductor chip 1012 to the semiconductor chip 1013.

The control circuit 1003 controls the circuit element 1001 to output data to be transmitted, and a multiplexing circuit 1002 receives the transmission data from the circuit element 1001 to multiplex it. Multiplexing is performed by the parallel-to-serial conversion described in the fifth or sixth embodiment or the code multiplexing described in the ninth embodiment. A modulator 1004 receives the output of the multiplexing circuit 1002 to modulate it, and the modulated signal is transmitted from the transmitting antenna 1010 as an electromagnetic wave. The control circuit 1003 generates a timing signal and a carrier wave in addition to performing multiplexing and the synchronization of modulation. In addition, the control circuit 1003 generates a reference signal of the carrier wave using the methods described in the fifth to eleventh embodiments, and these signals are transmitted to the control circuit 1006 on the receiver side through the wire transmission line 1014.

The signal passed through a space (a wireless propagation path) 1015 and received by the receiving antenna 1011 is demodulated by the demodulator 1008, and the demodulated signal is demultiplexed by a demultiplexing circuit 1007. Then, the demultiplexed signal is transmitted to the circuit element 1005. The control circuit 1006 receives the multiplexed signal, the modulated synchronizing signal, the timing signal, and the reference signal of the carrier wave from the control circuit 1003 on the transmitter side. Further, the control circuit 1006 demodulates or demultiplexes these signals or restores the carrier wave used in the demodulator 1008. By receiving these signals, the demultiplxer and the circuit for demodulation can be considerably simplified, and a demand for a high-accuracy oscillating frequency can be greatly relieved.

The transmitting antenna 1010 and the receiving antenna 1011 may be formed on the semiconductor chips 1012 and 1013, respectively, or each transmitting antenna may be formed at the outside of the semiconductor chip such that signals are transmitted from the semiconductor chip to the antenna through a bonding pad.

According this structure, it is possible to greatly decrease the number of pins of the semiconductor chip, and it is also possible to greatly reduce power consumption, compared to a conventional method of driving an antenna together with floating capacitance in order to extract the signal of a logic level through the bonding pad.

### Thirteenth Embodiment

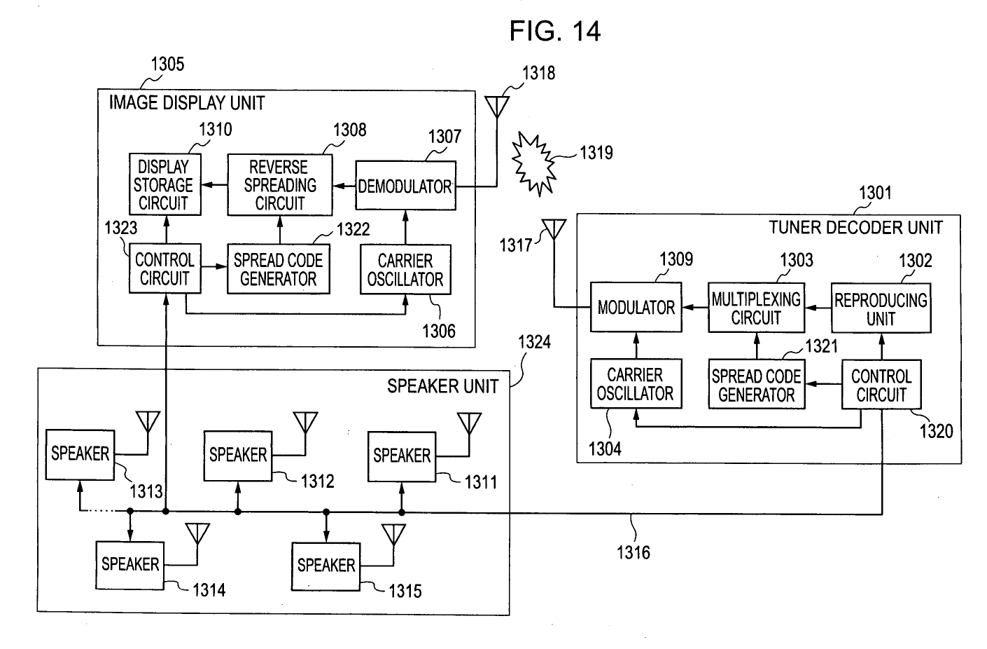

FIG. 14 is a diagram illustrating an electronic apparatus according to still yet another embodiment to which an information transmitting method of the present invention is applied, and a home theater is exemplified as the electronic apparatus.

In FIG. 14, the home theater is provided with an image display unit 1305, a tuner decoder unit 1301, and a speaker unit 1324. The image display unit 1305 has an image display device therein and receives an image signal to,perform display. In addition, the speaker unit 1324 generally includes a plurality of speaker 1311, 1312, 1313, 1314, and 1315 and driving units for driving the speakers 1311, 1312, 1313, 1314, and 1315. The driving units each receive a voice signal from the speaker 1311, 1312, 1313, 1314, and 1315 to control sound effects or to amplify the voice signal. These components are connected to each other in the following method.

A reproducing unit 1302 of the tuner decoder unit 1301 extracts image data or voice data from an image source or a voice source of a TV tuner or a DVD recorder, by commands from a control circuit 1320. Data output from the reproducing unit 1302 is multiplexed by a multiplexing circuit 1303 for each image channel or each voice channel. Multiplexing is performed in the following sequence: the data output from the reproducing unit 1302 is multiplied by a spread code output from a spread code generator 1321 for every channel in synchronism with a reference signal output from the control circuit 1320, and these multiplied results are subjected to an analog addition. The multiplexed data is modulated by a modulator 1309, and the modulated data is transmitted from a transmitting antenna 1317 as the first category information. A carrier oscillator 1304 multiplies the reference signal output from the control circuit 1320 to generate a carrier wave. The reference signal output from the control circuit 1320 is transmitted to the image display unit 1305 and the speaker unit 1324 as the second category information through a wire transmission line 1316. Image data, text data, or voice data is transmitted as the first category information through a wireless propagation path 1319 and is then received by a receiving antenna 1318. The received data is demodulated by a demodulator 1307 and is then reversely spread by a reverse spreading circuit 1308 to release the multiplexing, so that only the image signal is extracted. Then, the extracted image data is stored in a display storage circuit 1310. The image data stored in the display storage circuit 1310 is sequentially read and is then displayed on a screen of an image display device mounted in the image display unit 1305.

Also, information transmitted to the speaker unit 1324 is reproduced in the same manner as that in the image display unit 1305. Since the manner has already been described, a detailed description thereof will be omitted for the sake of the simplicity of explanation.

Here, a carrier wave for demodulation is multiplied, based on the reference signal transmitted from a control circuit 1323 as the second category information through a wire transmission line, and an oscillator 1306 is then oscillated. In addition, a spread code generator 1322 used for reverse spread generates a spread code in synchronism with the reference signal transmitted from the control circuit as the second category information. According to this structure, the tracking of the carrier wave is always taken in both the transmission and the reception. Therefore, a carrier oscillator having high frequency accuracy is not needed. In addition, since the reverse spread code is also synchronized, it is possible to remarkably simplify a circuit for reverse spread.

In a conventional technique, the tuner decoder unit 1301, the speaker unit 1324, and the image display unit 1305 are connected to each other by a star connection, and a complicated protocol is used for parallel-to-serial conversion or high-speed transmission. However, according to the above-mentioned structure of the present embodiment, it is possible to remarkably simplify a circuit structure. In addition, it is possible to simplify a circuit and protocol, compared to a case in which all signals are transmitted wirelessly.

### Fourteenth Embodiment

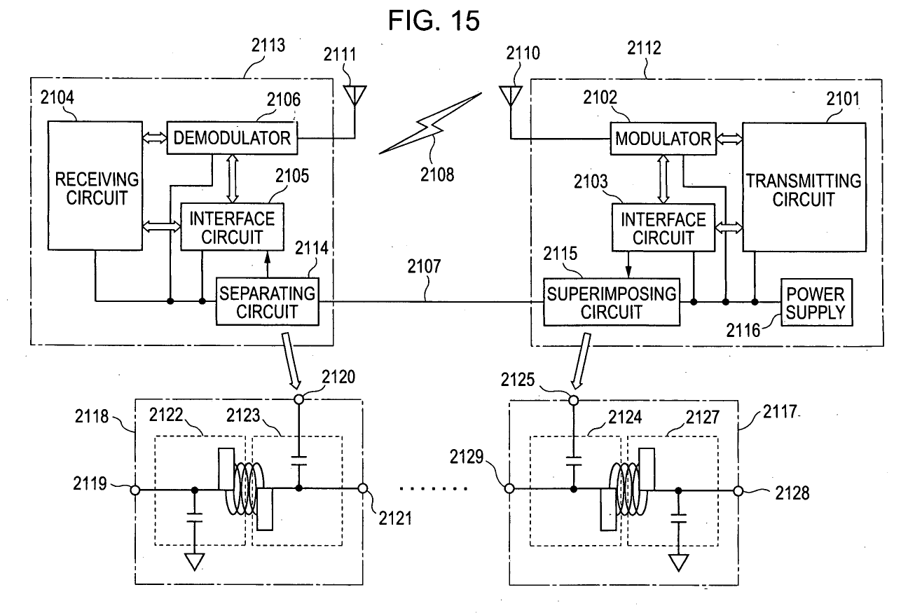

FIG. 15 is a conceptual view illustrating the main parts of an electronic apparatus to which another embodiment of the information transmitting method according to the present invention is applied.

In FIG. 15, data is transmitted from a transmitting unit block 2112 to a receiving unit block 2113. The transmitting unit block 2112 is provided with a transmitting circuit 2101 having information to be transmitted, and the receiving unit block 2113 is provided with a receiving circuit 2104 for receiving the transmitting information.

The transmitting information output from the transmitting unit block 2112 is divided into the first category information and the second category information. The first category information is modulated by a modulator 2102 and is then transmitted from a transmitting antenna 2110 as an electromagnetic wave. The second category information is superimposed on a power line 2107 via an interface circuit 2103 and is then transmitted to the receiving unit block together with power via a wire. An electromagnetic wave carrying the first category information is radiated by the transmitting antenna 2110 and is propagated through a space (a wireless propagation path 2108) to be received by a receiving antenna 2111. Then, the received wave is demodulated by a demodulator 2106 and is then output to a circuit 2104. In addition, the second category information transmitted through the power line is transmitted to the circuit 2104 via an interface circuit 2105. The second category information is transmitted from the transmitting unit block 2113 to the receiving unit block 2112. In this case, the second category information is transmitted from the interface circuit 2105 to the interface circuit 2103.

The second category information includes information not necessary to be transmitted in large quantities and at high speed, synchronization information for wireless transmission and reception, oscillator information, feedback information for feeding back the receiving state of data, encoding information for strengthening security, and the like. In addition, information output from the interface circuit 2103 or the interface circuit 2105 is also included in the second category information. The interface circuit 2103 collects the second category information output from the transmitting circuit 2101 and combines it with the second category information output from itself. Then, the interface circuit 2103 finally transmits the combined information as second category information.

In particular, since the synchronization information of a communication packet is obtained without using the wireless propagation path 2108, a circuit for extracting the synchronization information is not needed in the receiver side. Therefore, it is possible to remarkably simplify the circuit on the receiver side. In addition, it is possible to remarkably simplify the structure of a correlator required for spectral spread or UWB communication by transmitting the synchronization information of the correlator. In addition, when the oscillator information is transmitted, it is possible to commonize a clock signal used as a standard between reception and transmission. Therefore, the accuracy of an oscillating frequency required for the oscillator is remarkably relieved, and thus an electronic apparatus can be easily realized. Further, when an electronic apparatus has a short-distance communication interface, such as a mobile phone, Bluetooth, or UWB, an electromagnetic wave carrying the first category information may interrupt the communication of the electronic apparatus. In this case, in order to prevent the interruption of the electromagnetic wave on the original communication, the frequency of the electromagnetic wave carrying the first category information is changed by exchanging the second category information relating the operating conditions of an electronic apparatus between the reception and transmission of the first category information. That is, in the mobile phone, the frequency of a transmitting channel thereof is selected as the second category information, and in Bluetooth or UWB, a hopping pattern thereof is selected as the second category information. These signals are generated from the interface circuit 2103 or the interface circuit 2105.

The second category information is superimposed on the power line 2107 together with power and is transmitted or received between the transmitting unit block 2112 and the receiving unit block 2113. A power supply 2116 supplies power to all circuits in the transmitting unit block 2112. The second category information output from the interface circuit 2103 is superimposed on the power line 2107 by a superimposing circuit 2115. A detailed inner structure of the superimposing circuit 2115 is represented by a dot-and-dash line 2117. A terminal 2128 is connected to the power supply 2116, and a terminal 2129 is connected to the power line 2107. The second category information output from the interface circuit 2103 is input to a high-pass filter 2124 through a terminal 2125 and is then superimposed on the power line 2107. A signal in the second category information superimposed by a low-pass filter 2127 does not leak to the terminal 2128, and all circuits in the transmitting unit block 2112 are normally operated. The second category information superimposed on the power line 2107 is separated by a separating circuit 2114 and is then transmitted to the interface circuit 2105.

The inner structure of the separating circuit 2114 surrounded by a dot-and-dash line 2118 will be described in detail. A terminal 2121 is connected to the power line 2107. A signal in the second category information input to the terminal 2121 is separated by a high-pass filter 2123 and is then transmitted to the interface circuit 2105 through a terminal 2120. In order to prevent the leakage of the second category information, a low-pass filter 2122 is supplied with energy supplied from the power supply 2112 only through a terminal 2119 to normally supply power to all circuits in the receiving unit block through the terminal 2119. When the second category information is transmitted from the receiving unit block 2113 to the transmitting unit block 2112, the functions of the superimposing circuit 2115 and the separating circuit 2114 change to each other. However, as shown in FIG. 15, there circuits may have the same circuit structure.

In this way, it is possible to transmit the second category information through the power line 2107, so that the structures of the modulator 2102 and the demodulator 2106 for transmission and reception can be remarkably simplified. Therefore, it is possible to exchange signals in an electronic apparatus using the minimum number of wiring lines and to realize an electronic apparatus having high reliability with a simple method.

### Fifteenth Embodiment

FIG. 16 is a view illustrating an electronic apparatus according to still another embodiment of the present invention.

In FIG. 16, an electronic apparatus mainly has a main body portion 2205 and a display unit 2212, and two portions are connected to each other through a hinge 2207. Here, the main body portion 2205 is provided with a power supply 2213. In the main body portion 2205, a power supply voltage is supplied to each electronic circuit through wiring lines on a substrate, and the second category information is superimposed on the power supply voltage by a superimposing circuit 2214 and is transmitted to the display unit 2212 through an electric wire 2211. A separating circuit 2215 separates the superimposed power supply voltage and second category information, and the separated power supply voltage is supplied to each circuit in the display unit 2212 through wiring lines on the substrate of the display unit 2212.

Display data generated from a liquid crystal controller 2208 is transmitted to a modulator 2200 as the first category information to be modulated. Then, the modulated signal is converted into an electronic wave (radio wave) by a transmitting antenna 2209 to be propagated through a space. The electromagnetic wave signal transmitted from the transmitting antenna 2209 is received by a receiving antenna 2210, and the received signal is demodulated into display data by a demodulator 2202. Then, the display data is sent to a liquid crystal driver 2201 to be displayed on a liquid crystal display body 2206.

The synchronization signals of a modulator 2200 and the demodulator 2202, serving as the second category information, are superimposed on a power line 2211 by a superimposing circuit 2214 and are then transmitted to a separating circuit 2215 through the power line 2211. The separating circuit 2215 separates the second category information from a power supply voltage and transmits it to the demodulator 2202. Since this signal is not transmitted at higher speed, or since few signal lines are needed, it is easy to provide signal lines superposed on the power line 2211 to pass through the hinge 2207. Therefore, the degree of freedom on wiring or the arrangement of components can increase, and as shown in FIG. 16, the modulator 2200 and the transmitting antenna 2209 included in a signal transmitting portion and the demodulator 2202 and the receiving antenna 2210 included in a signal receiving portion can be arranged at places distant from the hinge 2207.

In general, the higher a data transmission speed becomes, the more difficult data is transmitted in a transmission line. However, in this case, it is easier to transmit an electromagnetic wave through a space. As such, when a control signal, such as a synchronizing signal, is transmitted by a wire transmission line and the modulator and the demodulator are synchronized, it is not necessary for the demodulator to perform synchronization detection, and thus it is possible to simplify a circuit structure. In addition, since the power line 2211 is also used as the wire transmission line, it is possible to reduce the number of wiring lines. With the advance of a semiconductor manufacturing technique in recent years, the structures of the modulator and the -demodulator for transmitting a high frequency wirelessly are simplified, and thus it is possible to incorporate these components into an electronic apparatus at a low cost, thereby achieving an electronic apparatus having high practicality.

### Sixteenth Embodiment

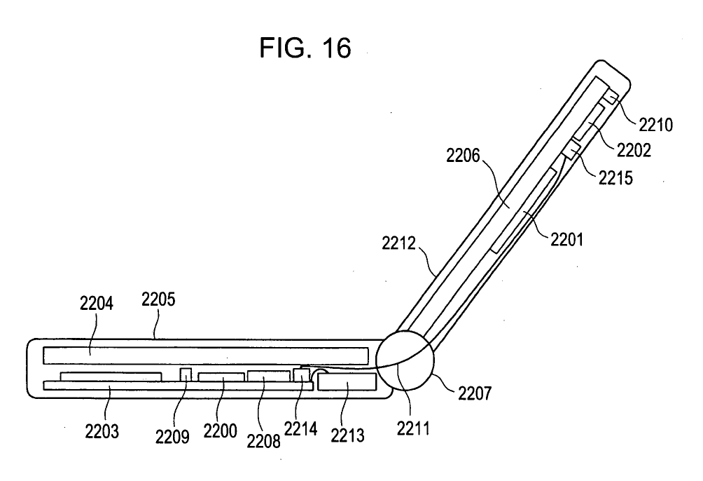

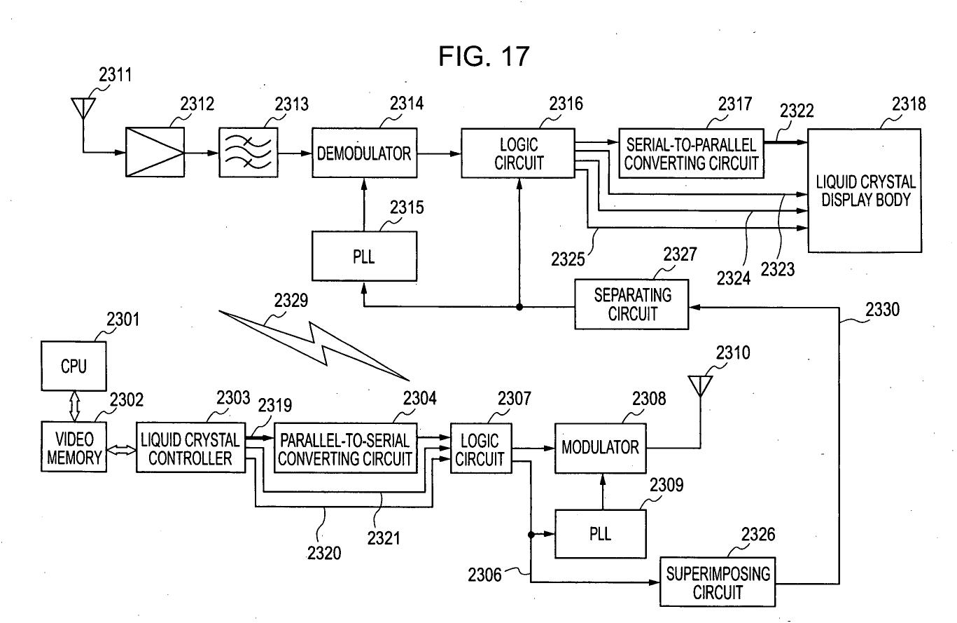

FIG. 17 is a block diagram illustrating an embodiment of the electronic apparatus to which an information transmitting method according to the present invention is applied.

In FIG. 17, a CPU 2301 generates display data by calculation, and the display data is stored in a video memory 2302. A liquid crystal controller 2303 reads data 2319 to be displayed on a display body from the video memory 2302 in a predetermined order and outputs the read data together with a vertical synchronizing signal 2321 and a horizontal synchronizing signal 2320. Generally, since the data 2319 for display is read in parallel from the video memory 302 in pixel units for every word, the read data is parallel-to-serial converted by a parallel-to-serial converting circuit 2304 and is then transmitted to a logic circuit 2307. The logic circuit 2307 receives a signal output from the parallel-to-serial converting circuit 2304, the horizontal synchronizing signal 2320, and the vertical synchronizing signal 2321 to generate a packet. The packet is transmitted to a modulator 2308 as the first category information, and a reference signal 2306 indicating the head of the packet is output to a PLL 2309 and a superimposing circuit 2326 as the second category information. The PLL 2309 multiplies the reference signal 2306 to generate a carrier wave in synchronism with the reference signal. The carrier wave is modulated by the modulator 2308, and the modulated signal is transmitted from a transmitting antenna 2310. At the same time, the reference signal 2306 is superimposed on a power line 2330 as the second category information by a superimposing circuit 2326 and is then transmitted to a separating circuit 2327 on the receiver side.

A receiving antenna 2311 receives an electromagnetic wave signal transmitted from the transmitting antenna 2310. The signal received by the receiving antenna 2311 is amplified by a preamplifier 2312, and a band-pass filter 2313 filters the amplified signal to remove signal components in an unnecessary band. Then, the filtered signal is input to a demodulator 2314. In addition, a separating circuit. 2327 separates the reference signal superimposed on a power line 2330 and transmitted therethrough as the second category information, and then a PLL 2315 multiplies the separated signal, based on the output of the separating circuit 2327, to restore the carrier wave and supplies it to the demodulator 2314. The demodulator demodulates the electromagnetic wave signals. A logic circuit 2316 detects the head of the packet from the reference signal separated by the separating circuit 2327 to generate display data 2322 in the packet, a horizontal synchronizing signal 2323, a vertical synchronizing signal 2324, and a transmission clock 2325 for an X driver from the packet, and then outputs them to a driver of a liquid crystal display body 2318 to perform display.

A frequency that does not affect the original function of an electronic apparatus using a radio wave, such as a radio receiver or a mobile phone, and that is not affected by that is selected as an oscillating frequency of the PLL 2309 or 2315. When a frequency of 2 GHz or more is selected, an occupied band is about 200 MHz even if data of 100 Mbps is transmitted. In this case, the frequency can be generally used without any problem.

In general, in the wireless communication, it is necessary that the modulator 2308 on the receiver side and the demodulator 2314 on the transmitter side have the same carrier frequency, and the carrier oscillator has to generate a frequency with high accuracy in transmission and reception. Therefore, a difference in frequency directly causes the deterioration of communication quality. Further, according to the above-mentioned structure of the present invention, the modulator 2308 and the demodulator 2314 use the same reference signal 2306, and the PLLs 2309 and 2315 multiply the reference signal 2306 to generate a carrier wave. Therefore, oscillating frequencies of both sides are equal to each other, so that no error occurs. Thus, the accuracy of the carrier oscillator does not matter, and manufacturing costs are reduced. Instead of the reference signal 2306, the output of the PLL 2309 may be directly superimposed on the power line 2330 by the superimposing circuit 2326 and is then transmitted. In this case, the carrier wave separated by the separating circuit 2327 can be directly input to the demodulator 2314 without passing through the PLL 2315. Therefore, the PLL 2315 is not needed. Further, in general, since the carrier wave has a high frequency, it is difficult that the carrier wave is transmitted through a wire transmission line. Therefore, it is more realizable that the PLLs 2309 and 2315 having the same characteristic multiply the reference signal having a low frequency in transmission and reception to generate a carrier wave.

The reference signal 2306 is a signal indicating the head of a packet for transmitting the first category information, and the reference signal is superimposed on the power line 2330 and is then transmitted as the second category information. Therefore, it is possible for the receiver side to easily detect the head of the packet. Thus, a circuit for extracting data from a packet can have a simple structure, and it is not necessary to write a preamble indicating the head of a packet. As a result, it is possible to remarkably simplify a packet structure and to increase an effective rate of communication.

According to the above-mentioned structure, it is possible to transmit display data to a liquid crystal display body 2318 in large quantities and at high speed. In addition, it is possible to settle various problems, such as an increase in power consumption, the restriction of wiring position, an EMI problem, and the deterioration of reliability, which occur with an increase in the size of a display body 2318.

Further, since the second category information is superimposed on the power line 2330, a dedicated wiring line for the second category information is not needed. In addition, it is possible to easily mount components in an electronic apparatus.

### Seventeenth Embodiment

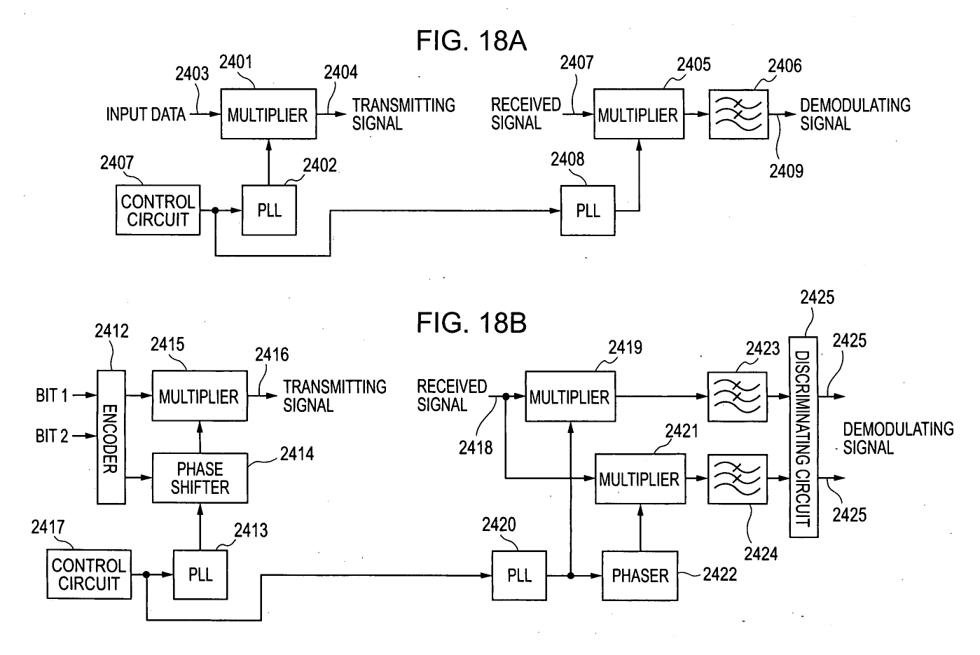

FIG. 18A is a block diagram illustrating the main parts of an electronic apparatus according to yet still another embodiment of the present invention and illustrates the modulator 2308 and the demodulator 2314 of the sixteenth embodiment in more detail. A PLL 2402 corresponding to the PLL 2309 of the sixteenth embodiment is an oscillator for multiplying the reference signal output from a control circuit 2407 to generate a square pulse carrier wave in synchronism with the reference signal. A multiplier 2401 multiplies the output of the PLL 2402 by input data 2403 and outputs the multiplied signal to a transmitting antenna as a transmitting signal 2404. Since the input data 2403 and the output of the PLL 2402 are digital signals, the multiplier 2401 may be an exclusive OR circuit. When a logical value 0 corresponds to an analog value 1 and a logical value 1 corresponds to an analog value −1, the input/output of the exclusive OR circuit exactly functions as a multiplier. In addition, since a communication distance is very short, high-frequency interference with other electronic apparatus is remarkably reduced, and it is not necessary to provide a filter, etc., between an antenna and a modulator.

A modulating unit is operated as follows. The received signal received by a receiving antenna 2311 shown in FIG. 17 is amplified to remove unnecessary signal components, and then the amplified signal is input to a multiplier 2405 as a received signal 2407. Then, the signal is multiplied by a carrier clock signal reproduced by a PLL 2408, and a low-pass filter 2406 filters high-frequency signal components from the multiplied signal to demodulate a demodulating signal 2409. The low-pass filter 2406 removes a high-frequency component (a thin pulse component generated by a little difference in phase between the received signal 2407 and the reproduction clock waveform of the PLL 2408) of the signal output from the multiplier 2405 and outputs the resultant signal as the demodulating signal 2409. The PLL 2408 multiplies the reference signal transmitted from the control circuit 2407 as the second category information through a power line to generate a carrier wave pulse having the same phase and frequency as the PLL 2408. Further, although a superimposing circuit and a separating circuit are omitted in FIG. 18A, these circuits are actually provided between the control circuit 2407 and the PLL 2408.

FIG. 9 illustrates timing charts (a) to (c) of the above-mentioned modulator. That is, (a) in FIG. 9 shows a carrier clock signal generated by a PLL on the transmitter side, that is, the PLL 2402. (b) in FIG. 9 shows the input data 2403, and (c) in FIG. 9 shows the output transmitting signal 2404. In the timing charts, from the viewpoint of a digital circuit, the modulator is an exclusive OR circuit, and from the viewpoint of an analog circuit having a value of +1, the modulator is a multiplier.

FIG. 9 includes timing charts (d) to (f) of a demodulating circuit. That is, (d) in FIG. 9 shows the received signal 2407, and (e) in FIG. 9 shows a pulse string generated by a PLL on the receiver side, that is, the PLL 2408. In addition, (f) in FIG. 9 shows the output of the multiplier 2405. The low-pass filter 2406 removes high-frequency components generated due to a little difference in phase between the received signal 2407 and the output of the PLL 2408 from the output of the multiplier 2405 and then restores the demodulation signal 2409.

As can be clearly seen from (d) to (f) in FIG. 9, when a carrier wave clock on the transmitter side ((a) in FIG. 9) and the reproduction clock on the receiver side ((e) in FIG. 9) have different frequencies or different phases, demodulation is not performed well. In the conventional wireless communication, high-precision oscillators are respectively provided on the transmitter side and the receiver side to perform tracking in order to suppress an error to the minimum level. However, according to the present embodiment having the above-mentioned structure, since the PLLs 2402 and 2408 having the same characteristics generate carrier waves based on the reference signal generated by the control circuit 2407 on the transmitter side, it is possible to always obtain the same frequency. Therefore, an error caused by the stability or accuracy of an oscillating frequency does not occur. Thus, it is possible to constitute a circuit having high stability with an inexpensive oscillator.

In the wireless signal transmitting method used in the present invention, since a communication distance is short, it is possible to obtain communication quality having a high S/N ratio. Therefore, it is possible to sufficiently amplify signals from the viewpoint of digitalization. In this case, the level of the amplified signal increases to the level of a logical value. However, a load driven by the logical value is small since communication is performed at a short distance in the same semiconductor chip, not at a long distance from a CPU to a display body, which causes a large floating capacitance. Thus, power consumption decreases. In addition, even when the received signal has an analog level that is not amplified to the logical value level, it is possible to realize a multiplication with a simple switching circuit since the output (having values of ±1) of the PLL 2408 is a square wave. That is, two amplifiers whose absolute values of the degree of amplification are equal to each other and whose polarities are reverse to each other are provided. In addition, when the output of the PLL 2408 is 1 in logical level, the output of an inverting amplifier with respect to the received signal 2407 is selected by a switch, and when the output of the PLL 2408 is 0 in logical level, the output of the inverting amplifier with respect to the received signal 2407 is selected. The circuit having the above-mentioned structure may be used as the multiplier 2405.

According to the above-mentioned structure, the modulator can be composed of an exclusive OR circuit, and the demodulator can also be composed of only an exclusive OR circuit, or an amplifier having positive and negative degrees of amplification, a switch circuit, and a low-pass filter. Therefore, it is possible to realize the modulator and the demodulator with a simple structure.

### Eighteenth Embodiment

FIG. 18B is a block diagram illustrating the main parts of an electronic apparatus according yet still another embodiment of the present invention and shows another example of the modulator 2308 and the demodulator 2314 of the sixteenth embodiment in more detail. The seventeenth embodiment has described simple BPSK modulation, but the eighteenth embodiment will be described based on QPSK using more general phase modulation.

A PLL 2413 corresponding to the PLL 2309 of the sixteenth embodiment is a square pulse oscillator for multiplying a reference signal generated by a control circuit 2417 and for generating a carrier wave in synchronism with the reference signal.

FIG. 9 includes timing charts (g) to (j) illustrating the operations of the respective units of the modulator shown in FIG. 18B. A bit 1 ((h) in FIG. 9) and bit 2 ((i) in FIG. 9) of the transmitting data are encoded by an encoder 2412. The encoder 2412 controls a phase shifter 2414 to shift the phase of the carrier wave ((g) in FIG. 9) oscillated by a PLL on the transmitter side, that is, a PLL 2413 by 90° and controls a multiplier 2415 to reverse the phase of the carrier wave (that is, a phase shift of 180°). Finally, the encoder 2412 outputs the transmitting signal 2415 (j) in FIG. 9) subjected to the QPSK modulation.

A control circuit 2417 corresponds to the logic circuit 2307 of the sixteenth embodiment, and a reference signal generated by the control circuit 2417 is superimposed on a power supply voltage as the second category information and is also transmitted to the receiver side. In addition, FIG. 18B, although the superimposing circuit and the separating circuit are omitted, these circuits are actually provided between the control circuit 2407 and the PLL 2408. A PLL 2420 corresponding to the PLL 2315 of the sixteenth embodiment multiplies the reference signal transmitted through the power line 2330 of FIG. 17 to generates a reproduction clock, that is, a carrier wave ((l) in FIG. 9) for the receiver side. The reproduction clock output from the PLL 2420 is multiplied by a received signal 2418 ((k) in FIG. 9) by a first multiplier 2419, and the multiplied signal is transmitted to a first low-pass filter 2423 to remove high-frequency components. Then, the signal is transmitted to a discriminating circuit 2425. At the same time, the received signal 2418 is multiplied by a pulse string ((o) in FIG. 9) obtained by shifting the phase of a reproduction clock pulse string reproduced from the PLL 2420 by 90° using a phase shifter 2422 by a second multiplier 2421, and high-frequency components of the multiplied signal are removed by a second low-pass filter 2424. Then, the signal is transmitted to the discriminating circuit 2425. The discriminating circuit 2425 calculates the transmitting data from the outputs ((n) and (q) in FIG. 9) of the first and second low-pass filters 2423 and 2424 to demodulate the received signal.

According to the above-mentioned structure, it is possible to transmit data at high speed without increasing the occupied band of the transmitting signal. In addition, since a simple digital circuit can be composed of only the modulator and the demodulator, the circuit can be incorporated into a semiconductor chip, and thus it is possible to reduce manufacturing costs and power consumption. Further, since the carrier wave clocks necessary for transmission and reception are obtained by multiplying the reference signal generated by the same control circuit 2417 using the PLLs 2413 and 2420 having the same characteristics in transmission and reception, the carrier wave clocks have the same phase and frequency. Therefore, an error caused by a difference in the accuracy of a clock frequency between reception and transmission does not occur. It is possible to realize stable data transmission using an inexpensive oscillator. In addition, even when the control circuit 2417 one-sidedly changes the frequency of the reference signal, the receiver side and the transmitter side always follows the frequency. Therefore, for example, in an electronic apparatus, such as a wireless communication apparatus, it is possible for the transmitter side to one-sidedly change a frequency by selecting the frequency so as not to interfere with a communication channel (this can be applied to the sixteenth or seventeenth embodiment). That is, this property makes it possible to easily take measures to prevent interference or interruption in communication, which is an original object of any communication apparatus.

### Nineteenth Embodiment

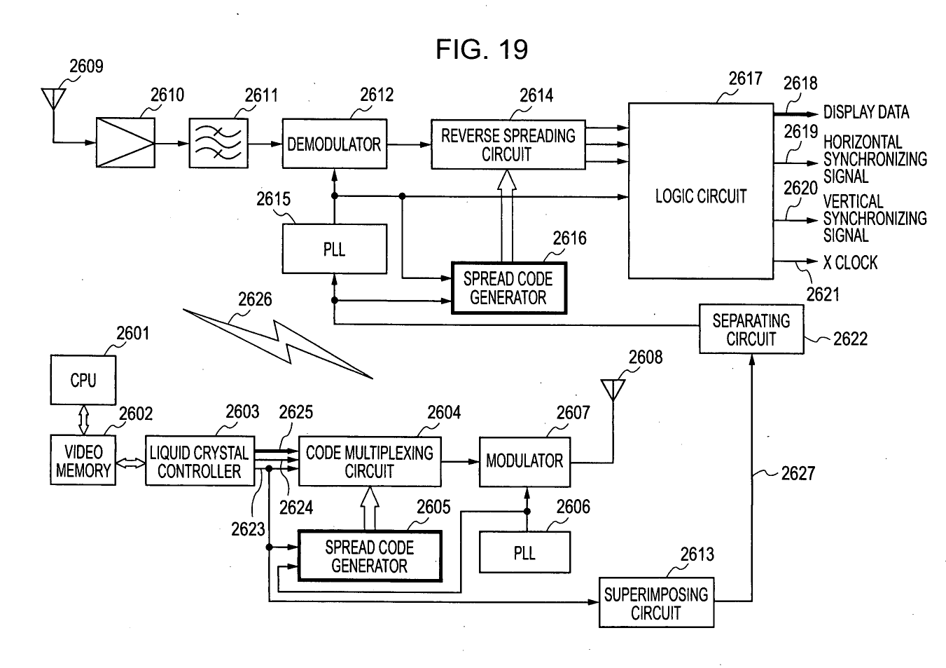

FIG. 19 is a block diagram illustrating an embodiment of the electronic apparatus to which another information transmitting method according to the present invention is applied.

In FIG. 19, a CPU 2601, a video memory 2602, and a liquid crystal controller 2603 have the same functions as those in the sixteenth embodiment. A horizontal synchronizing signal 2623, a vertical synchronizing signal 2624, and display data 2625 generated by the liquid crystal controller 2603 are multiplexed with a spread code generated from a spread code generator 2605 by a code multiplexing circuit 2604. In the present embodiment, since parallel data is multiplexed as follows, the parallel-to-serial conversion by the parallel-to-serial converting circuit 2304 in the sixteenth embodiment is not needed. Therefore, the serial-to-parallel converting circuit 2317 for reverse conversion is not also needed. As the spread code, code sets orthogonal to each other are mainly used. The spread code is generated by synchronizing the head of the code with the horizontal synchronizing signal 2623 generated by the liquid crystal controller 2603. In addition, since the spread code generator 2605 uses a signal obtained by multiplying the horizontal synchronizing signal 2623 using the PLL 2606, the carrier wave and the spread code are exactly synchronized with each other.

Since the display data 2625 is read in a packet from the video memory 2602 for every pixel, the display data is output as parallel digital data. Each bit of the data signal, the horizontal synchronizing signal 2623, and the vertical synchronizing signal 2624 are multiplied by each code generated by the spread code generator 2605 (or they are calculated by an exclusive OR operation), and an analog operation is performed on the multiplied signals to multiplex them. The multiplexed signals are modulated with a carrier wave generated from the PLL 2606 by a modulator 2607, and the modulated signals are transmitted from a transmitting antenna 2608 as the first category information through a wireless communication path 2626 (space). Since the carrier wave is generated by multiplying the horizontal synchronizing signal 2623 using the PLL 2606, the carrier wave is exactly synchronized with the horizontal synchronizing signal 2623. In addition, as described above, the horizontal synchronizing signal 2623 is also synchronized with the output of the spread code generator 2605. The horizontal synchronizing signal 2623 is superimposed on a power line 2627 by a superimposing circuit 2613 and is then transmitted to a separating circuit 2622 on the receiver side as second category information.

The transmitted electromagnetic wave signal is received by a receiving antenna 2609 and is then amplified by a preamplifier 2610. Then, a band-pass filter 2611 removes unnecessary signals out of a predetermined band width from the amplified signal, and a demodulator 2612 demodulates the signal. A separating circuit 2622 separates the horizontal synchronizing signal 2623 that is superimposed on the power line 2627 as the second category information and is then transmitted, and A PLL 2615 multiplies the signal to generate a carrier wave. The signal demodulated by a demodulator 2612 is transmitted to a reverse spreading circuit 2614, and the reverse spreading circuit 2614 calculates the correlation between the demodulated signal and a spread code for multiplexing generated by a spread code generator 2616 to separate the multiplexed data. A logic circuit 2617 performs waveform shaping and timing adjustment on a display data signal 2618, a horizontal synchronizing signal 2619, a vertical synchronizing signal 2620, and a clock signal 2621 of an X driver for driving a liquid crystal driver, based on the detected display data or various timings, and then transmits these signals to a liquid crystal display body to perform display.

Since the carrier waves of the demodulator 2612 and the modulator 2607 are synchronized with the horizontal synchronizing signal 2623, which is the same reference signal, and are oscillated by the PLLs 2606 and 2615 having the same characteristics, the carrier waves of both sides have the same frequency and phase. Therefore, an error caused by a difference in the accuracy of a carrier wave frequency does not occur. In addition, in both the receiver side and the transmitter side, since the head of the spread code coincides with the horizontal synchronizing signal, it is not necessary to detect timing for reverse spread. Therefore, it is not necessary to provide a circuit for synchronization compensation on the receiver side, thereby simplify the structure of a circuit. In particular, in case of code multiplexing, it is possible to use a correlator, not a matching filter, as a reverse spreading circuit. Further, since the synchronization information of the correlator is transmitted as the second category information via a wire, it is not necessary to perform synchronization compensation or sliding. Thus, it is possible to perform reverse spread with a very simple circuit.

Further, since the horizontal synchronizing signal 2623 and the vertical synchronizing signal 2624 are also multiplexed together with the display data 2625 and are then transmitted, it is possible for the receiver side to immediately detect a synchronizing signal for display by the reverse spread. Since the horizontal synchronizing signal 2623 is superimposed on the power line 2627 as the second category information and is then transmitted, the signal can be used as the horizontal synchronizing signal 2619 without code multiplexing. In addition, in order to obtain a spread gain, a spread code having a sufficiently wide frequency band can be selected, and spread modulation may be additionally performed after the modulator 2607.

### Twentieth Embodiment

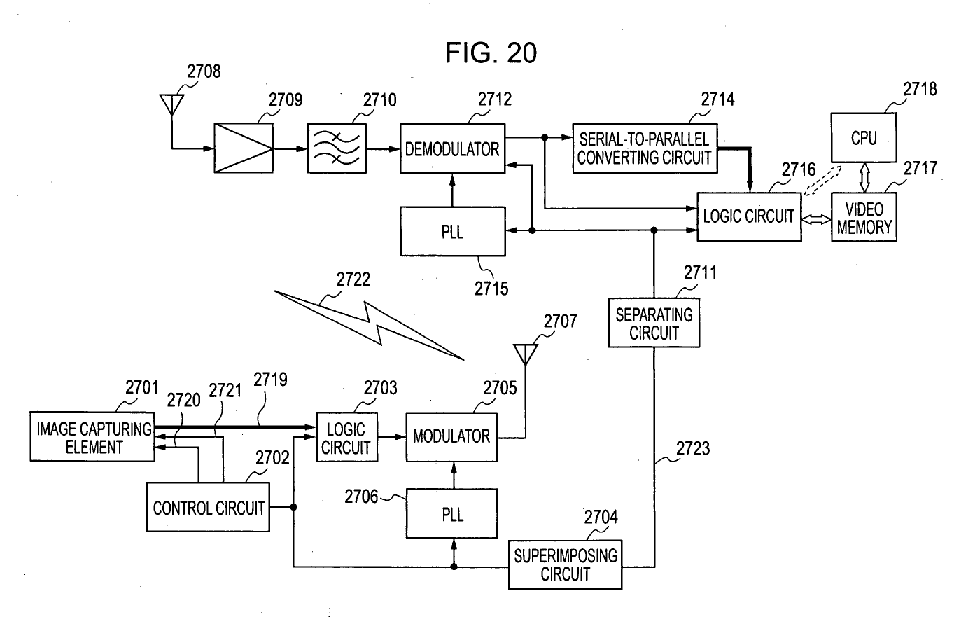

FIG. 20 is a block diagram illustrating the main parts of an electronic apparatus according to still yet another embodiment of the present invention and shows an example in which an information transmitting method according to the present invention is applied to an electronic apparatus using an image capturing element.

In FIG. 20, an image capturing element 2701 is driven by a horizontal synchronizing signal 2720 and a vertical synchronizing signal 2721 generated from a control circuit 2702 to pick up an image and outputs image data 2719 related to the captured image. A logic circuit 2703 receives these signals to construct a packet for wireless transmission. The packet is modulated by a modulator 2705, and the modulated signal is radiated from a transmitting antenna 2707 as an electromagnetic wave. A carrier wave used in the modulator 2705 is oscillated by multiplying a reference signal generated from a control circuit 2702 using a PLL 2706. For example, a signal indicating the head of the packet obtained by constructing the signals output from the control circuit 2702 using the logic circuit 2703 and the horizontal synchronizing signal 2720 for driving the image capturing element are used as the reference signal. The reference signal is superimposed on a power line 2723 as the second category information by a superimposing circuit 2704 and is then transmitted to a separating circuit 2711 on the receiver side.

An electromagnetic wave signal transmitted from a transmitting antenna 2707 is propagated through a wireless propagation path (space) 2722 and is received by a receiving antenna 2708. Then, the received signal is amplified by a preamplifier 2709, and a band-pass filter 2710 removes unnecessary signals out of a predetermined band width from the amplified signal. Subsequently, the signal is input to a demodulator 2712. The separating circuit 2711 extracts the reference signal transmitted through the power line 2723 as the second category information, and a PLL 2715 multiplies the reference signal to generate a carrier wave. The demodulator 2712 demodulates the received signal, based on synchronization timing necessary for demodulation from the reference signal transmitted from the control circuit 2702 as the second category information through a wire transmission line 2723. A serial-to-parallel converting circuit 2714 extracts an image data portion from the demodulated reception packet and performs serial-to-parallel conversion on every pixel to generate pixel data. Since these circuits use the reference signal from the control circuit 2702 as the second category information, it is not necessary to perform signal detection for synchronization, and thus it is possible to remarkably simplify a circuit structure. In addition, since a carrier frequency is always synchronized with the transmitter side, tracking is taken. Therefore, the accuracy required for tracking can be remarkably relieved.

The logic circuit 2716 generates a memory address to be written on a video memory 2717 corresponding to the demodulated pixel data and writes the image data on the corresponding address of the video memory 2717 directly or through a CPU 2718. The CPU 2718 accesses the video memory 2717 to use the image data for various applications. In general, the start of an image capturing element 2701 is controlled by the CPU 2718. However, in order to transmit information on the start to the control circuit 2702 of the image capturing element 2701, the information may be superimposed on the power line 2723 as the second category information and be transmitted via a wire. In addition, the information can be transmitted wirelessly.

In the case of the wireless transmission, the CPU 2718 and the image capturing element 2701 each have wireless transmitting/receiving units to perform bidirectional communication. In particular, in a folding-type mobile phone, the image capturing element 2701 is arranged in the vicinity of a display element, and the image capturing element 2701 and the display element are generally arranged opposite to the CPU 2718. In addition, the image data relating a captured image is transmitted to the CPU 2718 to be processed, and the processed data is transmitted to the display element. The second category information may be in a place where the control circuit 2702 is arranged, and it is possible to synchronize both sides by using the reference signal of the control circuit 2702 in common. Further, since the synchronization timing required for demodulation is transmitted to the receiver side through the power line 2723, it is not necessary for the receiver side to perform synchronization compensation. Thus, it is possible to reduce the number of wiring lines and to greatly simplify a circuit structure.

### Twenty-First Embodiment

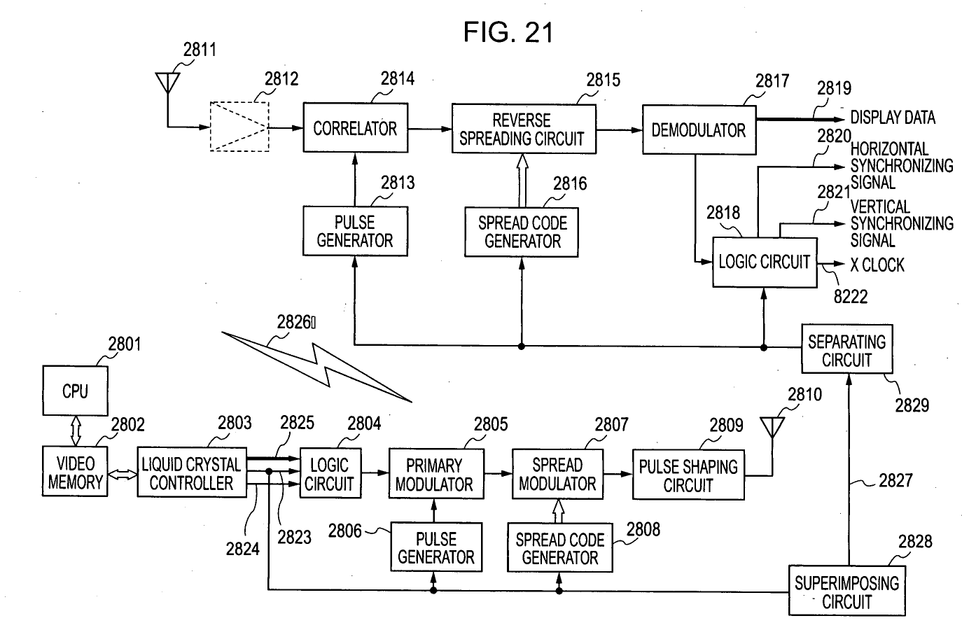

FIG. 21 is a block diagram illustrating a data transmitting method and the main parts of an electronic apparatus according to an embodiment of the present invention.

In FIG. 21, a CPU 2801, a video memory 2802, and a liquid crystal controller 2803 have the same functions as those in the sixteenth and nineteenth embodiments. A logic circuit 2805 performs the rearrangement of data, such as parallel-to-serial conversion, preamble attachment, or packet construction, on a horizontal synchronizing signal 2823, a vertical synchronizing signal 2824, and display data 2825 generated by the liquid crystal controller 2803 to convert these signals into serial signals. A primary modulator 2804 modulates these signals with a pulse string generated by a pulse generator 2806. In the primary modulation, pulse position modulation or bypass pulse modulation can be performed on the pulse string. The signals subjected to the primary modulation are spread-modulated by a spread modulator 2807 with a spread code generated by a spread code generator 2808.

The spread-modulated pulse string is waveform-shaped by a pulse shaping circuit 2809 into a wide-band pulse having a low spectral density and having a very short period and is then radiated from a transmitting antenna 2810 as an electromagnetic wave. The electromagnetic wave to be radiated is not a wave obtained by modulating a sine wave, but is a very thin pulse string.

Meanwhile, the horizontal synchronizing signal 2823 also determines a pulse generating standard for pulse modulation, such as pulse position modulation. The signal is superimposed on a power line 2827 as a reference signal of the second category information by a superimposing circuit 2828 and is then transmitted to a separating circuit 2829 on the receiver side.

The radiated electromagnetic wave is transmitted through a wireless propagation path 2826 and is then received by a receiving antenna 2811. The received signal is amplified by a preamplifier 2812 if necessary, and a correlator 2814 calculates the correlation between the amplified signal and a pulse template generated by a pulse generator 2813. The output of the correlator 2814 is reversely spread by a reverse spreading circuit 2815, based on a spread code generated by a spread code generator 2816, and then the reversely spread signal is demodulated by a demodulator 2817. Then, the demodulated signal is converted into the signal before the primary modulation (the input of the primary modulator 2805). A logic circuit 2818 generates a display data signal 2819, a horizontal synchronizing signal 2820, and a vertical synchronizing signal 2821 for driving a liquid crystal driver, and an X clock signal 2822 for an X driver, based on display data detected by the demodulator 2817 or a horizontal synchronizing signal 2823 transmitted from the transmitter side as the second category information via a power line 2827, and then transmits these signals to a liquid crystal display body to perform display.

According to the above-mentioned structure, a modulating operation can be performed only on the time axis, and most of components can be realized only by digital circuits dealing with a pulse. In addition, it is possible to easily form circuit elements using ICs. Further, by adopting a short pulse, it is possible to obtain a spread gain in the direction of the time axis, and it is possible to improve an interference resisting characteristic and interference characteristics with respect to a radio wave radiated, which is an original function of an electronic apparatus. In addition, it is possible to achieve data transmitting lines having multi-channels. Further, since the synchronization timing required for demodulation is transmitted to the receiver side through the power line 2827, it is not necessary for the receiver side to perform synchronization compensation. Thus, it is possible to reduce the number of wiring lines and to greatly simplify a circuit structure.

### Twenty-Second Embodiment

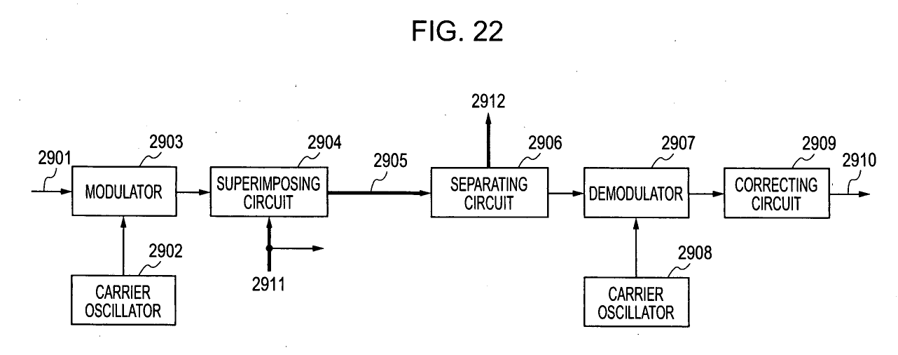

FIG. 22 is a diagram illustrating an electronic apparatus according to yet still another embodiment of the present invention. The present embodiment describes another example of the method of superimposing the second category information on the power line described in the fourteenth to twenty-first embodiments. In general, a high-frequency signal, such as a carrier wave, cannot superimpose on a power line as the second category information. Therefore, an object of the present invention is to transmit the high-frequency signal wirelessly since the high-frequency signal is not transmitted well. On the contrary, when the second category information has a low frequency, it cannot superimpose on the power line well. In addition, even if the second category information is superposed thereon, it is difficult for the receiver side to separate it, a voltage level of the power line can be changed, or an apparatus can be greatly influenced in operation. When the second category information has a low frequency, the second category information is modulated before transmission as shown in FIG. 22.

That is, the second category information input to an input terminal 2901 is modulated by a modulator 2903 and is then transmitted to a superimposing circuit 2904. The superimposing circuit 2904 can be easily composed of a high-pass filter and a low-pass filter, similar to the superimposing circuit 2115 shown in FIG. 15. A carrier wave input to the modulator 2903 is oscillated by a carrier oscillator 2902. An oscillating frequency thereof is appropriately selected such that it can be superimposed on a power line 2905 and does not have an effect on an electronic apparatus. The carrier oscillator 2902 may be, for example, a unit for dividing the frequency of a carrier wave for transmitting the first category information as an electronic wave.

The second category information is superimposed on a power supply voltage supplied from a power supply terminal 2911 by the superimposing circuit 2904 and is then transmitted to a receiving end through a power line 2905. A separating circuit 2906 separates the second category information to output it to a demodulator 2907 and supplies the power supply voltage to each unit in a receiving portion. A demodulator 2907 demodulates the second category information. The demodulated second category information is delayed by a predetermined time by demodulation, but a correcting circuit 2909 corrects the time delay. A carrier oscillator 2908 generates a carrier wave for demodulation. However, when using delay detection, the carrier wave is not necessarily needed for demodulation. In order to simplify a circuit structure, a demodulating method without the carrier oscillator 2908 may be selected.

Such a circuit can be incorporated into all kinds of semiconductor chips without increasing manufacturing costs, with the advance of a semiconductor technique.

### Twenty-Third Embodiment

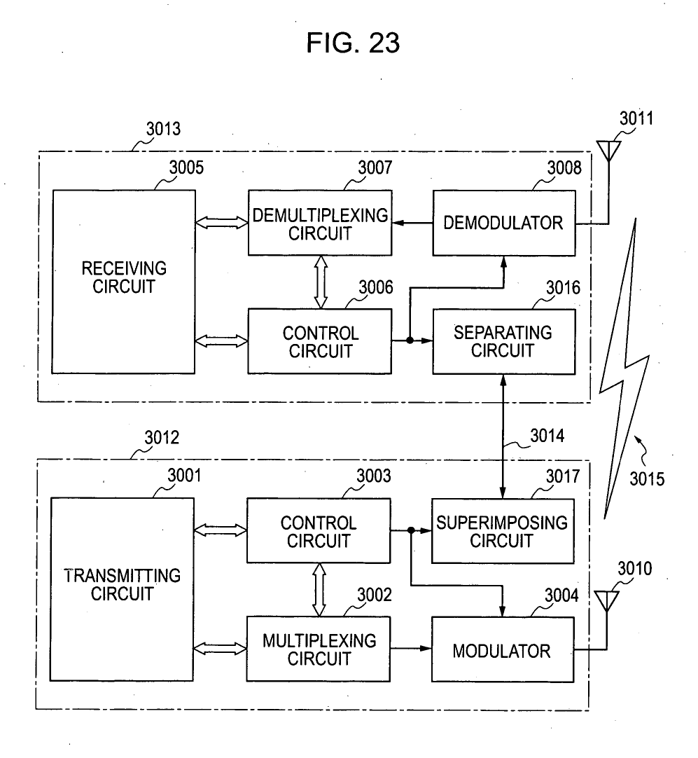

FIG. 23 is a block diagram illustrating an electronic apparatus according to still another embodiment to which an information transmitting method according to the present invention is applied and shows an example in which data transmission is performed between semiconductor chips using a power line.

In FIG. 23, a semiconductor chip 3012 is provided with a transmitting circuit 3001 having (generating) a plurality of data to be transmitted from the semiconductor chip 3012, and a semiconductor chip 3013 is provided with a receiving circuit 3005 receiving the data of the semiconductor chip 3012. In addition, Data is transmitted from the semiconductor chip 3012 to the semiconductor chip 3013.

A control circuit 3003 controls the transmitting circuit 3001 to output data to be transmitted, and a multiplexing circuit 3002 receives the transmitting data from the transmitting circuit 3001 to multiplex it. Multiplexing is performed by the parallel-to-serial conversion described in the sixteenth embodiment or the code multiplexing described in the nineteenth embodiment. A modulator 3004 receives the output of the multiplexing circuit 3002 to modulate it, and the modulated signal is transmitted from a transmitting antenna 3010 as an electromagnetic wave. The control circuit 3003 generates a timing signal and a carrier wave in addition to performing multiplexing and the synchronization of modulation. In addition, the control circuit 3003 generates a reference signal of the carrier wave using the methods described in the sixteenth to twenty-first embodiments, and these signals are transmitted to a separating circuit 3016 on the receiver side by a superimposing circuit 3017 through a power line 3014.

The separating circuit 3016 extracts the second category information from the power line 3014 and transmits it to a control circuit 3006. The signal passing through a space (a wireless propagation path) 3015 and received by a receiving antenna 3011 is demodulated by a demodulator 3008, and the demodulated signal is demultiplexed by a demultiplexing circuit 3007. Then, the demultiplexed signal is transmitted to the receiving circuit 3005. The control circuit 3006 receives the multiplexed signal, the modulated synchronizing signal, the timing signal, and the reference signal of the carrier wave from the control circuit 3003 via the superimposing circuit 3017, the power line 3014, and the separating circuit 3016. Further, the control circuit 3006 demodulates or demultiplexes these signals or restores the carrier wave used in the demodulator 3008.

By performing synchronization between the receiver side and the transmitter side of the signal using the same reference signal with such a method, it is possible to greatly simplify circuits for multiplexing, demultiplexing, modulation, and demodulation, and a demand for a high-precision oscillating frequency is greatly relieved. Therefore, these circuits can be mounted on the semiconductor chips 3012 and 3013. Further, when using the superimposing and the separating circuit in the twenty-second embodiment, it is possible to transmit or receive data through the power line 3104 in a wide frequency range.

### Twenty-Fourth Embodiment

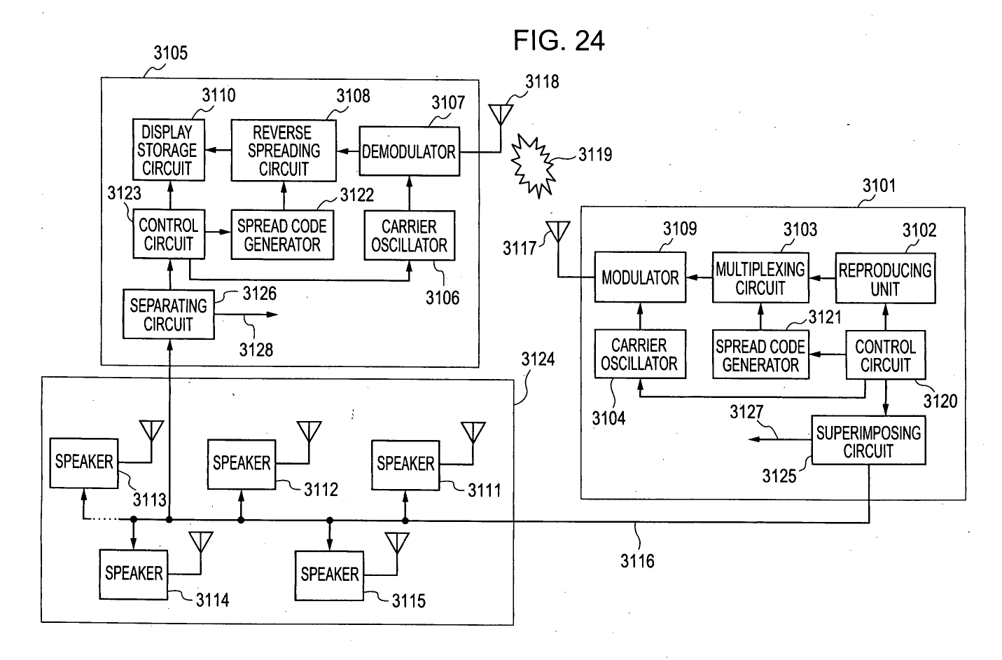

FIG. 24 is a diagram illustrating an electronic apparatus according to still yet another embodiment to which an information transmitting method of the present invention is applied and shows an example in which a data transmitting method using a power line is applied to a home theater. The home theater is provided with an image display unit 3105, a tuner decoder unit 3101, and a speaker unit 3124. The image display unit 3105 has an image display device therein and receives an image signal to perform display. In addition, the speaker unit 3124 generally includes a plurality of speakers 3111, 3112, 3113, 3114, and 3115 and driving units for driving the speakers 3111, 3112, 3113, 3114, and 3115. The driving units each receive a voice signal from the speakers 3111, 3112, 3113, 3114, and 3115 to control sound effects or to amplify the voice signal.

These components are connected to each other in the following method. That is, a reproducing unit 3102 of the tuner decoder unit 3101 extracts image data or voice data from an image source or a voice source of a TV tuner or a DVD recorder, by commands from a control circuit 3120. Data output from the reproducing unit 3102 is multiplexed by a multiplexing circuit 3103 for each image channel or each voice channel. Multiplexing is performed in the following sequence: the data output from the reproducing unit is multiplied by a spread code output from a spread code generator 3121 for every channel in synchronism with a reference signal output from the control circuit 3120, and these multiplied results are subjected to an analog addition. The multiplexed data is modulated by a modulator 3109, and the modulated data is transmitted from an transmitting antenna 3117 as the first category information. A carrier oscillator 3104 multiplies the reference signal output from the control circuit 3120 to generate a carrier wave. The reference signal output from the control circuit 3120 is superimposed on a power line 3116 as the second category information by a superimposing circuit 3125 and is then transmitted to the image display unit 3105 and the speaker unit 3124.

Unlike the fourteenth to twenty-third embodiments, the power line is an AC power supply, and the superimposing circuit 3125 or a separating circuit 3126 can be composed of a low-pass filter and a high-pass filter as shown in FIG. 15. A terminal 3127 is a power line for supplying power to each unit of the tuner decoder unit 3101. Image data, text data, or voice data is transmitted as the first category information through a wireless propagation path 3119 and is then received by a receiving antenna 3118. The received data is demodulated by a demodulator 3107 and is then reversely spread by a reverse spreading circuit 3108 to release the multiplexing, so that only the image signal is extracted. Then, the extracted image data is stored in a display storage circuit 3110. The image data stored in the display storage circuit 3110 is sequentially read and is then displayed on a screen of an image display device, mounted in the image display unit 3105. Similarly, the information transmitted to the speaker unit 3124 is reproduced in the same manner as in the inside of the image display unit 3105.

The reference signal transmitted through the power line 3116 as the second category information is separated by the separating circuit 3126, and the control circuit 3123 generates various signals for controlling the operation of the image display unit 3128 based on the separated signal. A carrier wave for demodulation is multiplied on the basis of a control signal generated by the control circuit 3123, and a carrier oscillator 3106 is oscillated. In addition, a spread code generator 3122 used for reverse spread is controlled by the control circuit 3123 to generate a spread code in synchronism with the reference signal transmitted as the second category information. According to this structure, the tracking of the carrier wave is always taken in both transmission and reception. Therefore, a carrier oscillator 3106 having high frequency accuracy is not needed. In addition, since the reverse spread code is also synchronized, it is possible to remarkably simplify a reverse spreading circuit 3108.

Further, the image display unit 3105, the tuner decoder unit 3101, and the speaker unit 3124 are connected to each other only through the power line 3116 by superimposing the second category information on the power line 3116. Therefore, it is possible to construct a home theater and to simplify the structure of the home theater.

### Twenty-Fifth Embodiment

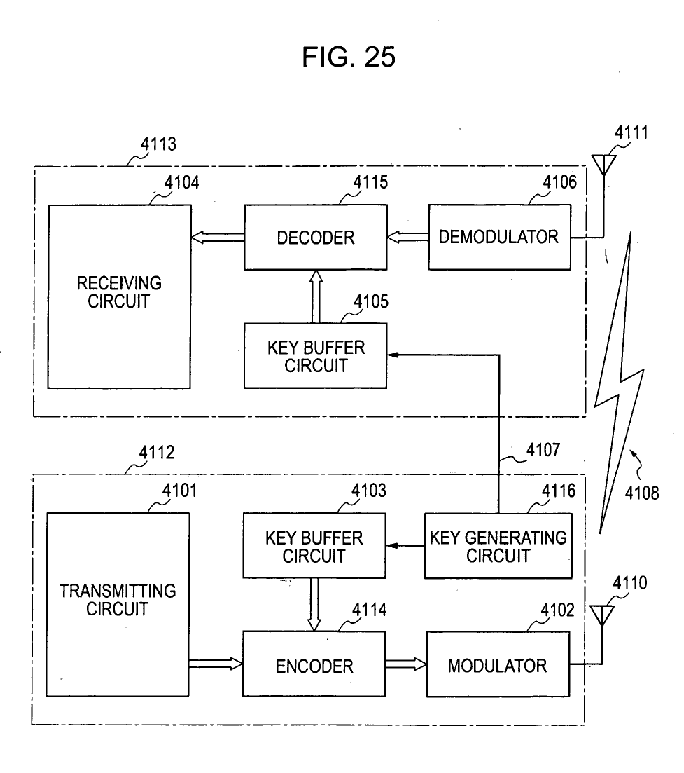

FIG. 25 is a conceptual view illustrating the main parts of an electronic apparatus according to yet still another embodiment of the present invention.

In FIG. 25, data is transmitted from a transmitting unit block 4112 to a receiving unit block 4113. Information is transmitted from a transmitting circuit 4101 having transmitting information to a receiving circuit 4104 for receiving the information. The transmitting information output from the transmitting circuit 4101 is encoded by an encoder 4114 using an encrypted key held by a key buffer circuit 4103, and the encoded information is modulated by a modulator 4102. Then, the modulated signal is transmitted from a transmitting antenna 4110 as an electromagnetic wave (radio wave).

The encrypted key is generated from a key generating circuit 4116. The generated encrypted key is transmitted to the key buffer circuit 4103 and is also transmitted through a wire transmission line 4107. Then, the transmitted encrypted key is stored in a key butter circuit 4105 in a receiving unit block 4113. The electromagnetic wave signal transmitted from the transmitting antenna 4110 and propagated through a space (a wireless propagation path 4108) is received by a receiving antenna 4111 and is then demodulated by a demodulator 4106. Then, the demodulated signal is decoded by a decoder 4115 and is output to a receiving circuit 4104.

The key buffer circuits 4103 and 4105 continuously hold the encrypted key having been previously held therein while the key generating circuit 4116 is transmitting an encrypted key, and updates the encrypted key in synchronism with each other after the key generating circuit 4116 finishes transmitting the encrypted key. Since the key generating circuit 4116 frequently updates the encrypted key, it is possible to improve the security of the encrypted key.

The key generating circuit 4116 may be provided in the receiving unit block 4113 and transmit the encrypted key to the key buffer circuit 4103 in the transmitting unit block 4112 through the wire transmission line 4107.

It is not necessary for cipher used in the encoder 4114 and the decoder 4115 to use a complicated algorithm, such as public key cipher. The reason is that, since an encrypted key is transmitted at a short distance in the same apparatus via a wire communication, the possibility of encrypted keys being leaked or changed is prevented when the encrypted keys are distributed. Therefore, it is possible to directly use common key cipher, without using an encrypted key distributing procedure having a complicated structure.

According to the present embodiment, since data is encoded and is then transmitted via a wire in an electronic apparatus, it is not necessary to use wiring lines necessary for high-speed data transmission. Therefore, it is possible to settle various problems accompanying a high-speed operation of an electronic apparatus without damaging the security of the apparatus.

### Twenty-Sixth Embodiment

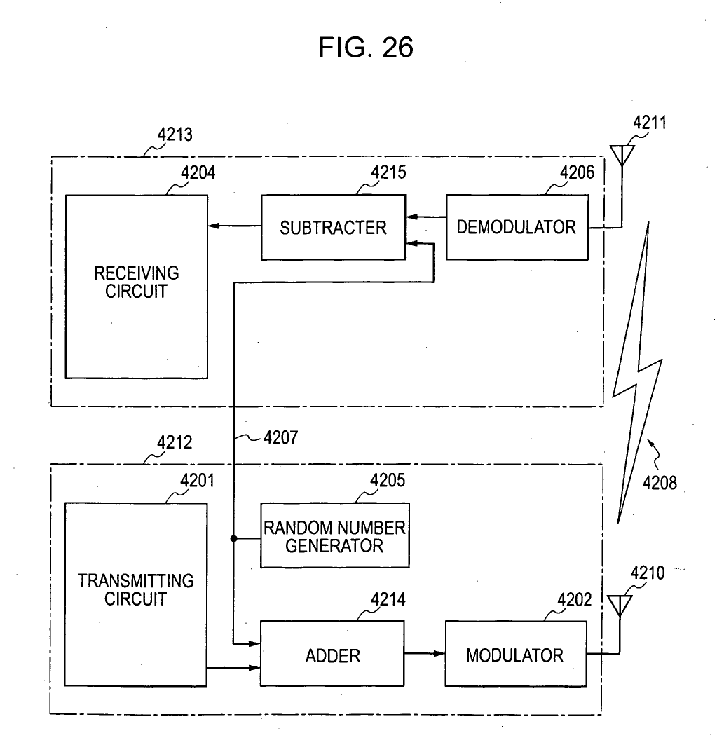

FIG. 26 is a conceptual view illustrating the main parts of an electronic apparatus according to still yet another embodiment of the present invention.

In FIG. 26, data is transmitted from a transmitting unit block 4212 to a receiving unit block 4213. Information is transmitted from a transmitting circuit 4201 having transmitting information to a receiving circuit 4204 for receiving the information. The transmitting information output from the transmitting circuit 4201 is added to a random number generated from a random number generating circuit 4205 by an adder 4214, and the added signal is modulated by a modulator 4202 and is then transmitted from a transmitting antenna 4210 as an electromagnetic wave (radio wave). The random number generated by the random number generator 4205 is transmitted to a subtracter 4215 in a receiving unit block 4213 through a wire transmission line 4207 at the same time of the wireless transmission. The electromagnetic wave signal transmitted from the transmitting antenna 4210 and propagated through a space (a wireless propagation path 4208) is received by a receiving antenna 4211 and is then demodulated by a demodulator 4206. Subsequently, the random number transmitted from the random number generator 4205 is subtracted from the demodulated signal by the subtracter 4215 and is then output to the receiving circuit 4204.

Since an addition in Galois field (GF(2)) can be realized in a simple exclusive OR circuit, the adder 4214 and the subtracter 4215 have a simple structure. When the transmitting circuit 4201 outputs serial data, an addition can be realized only by performing an exclusive OR operation with a one-bit random number. Further, in Galois field GF(2), since addition and subtraction are the same (equivalent) calculation, a subtracter required for demodulation can be realized by using an exclusive OR circuit, thereby simplifying the structure of a circuit. When data generated from the transmitting circuit 4201 is parallel data, not serial data, an exclusive OR operation is performed on the data and a random number for every bit. When neglecting carry, calculation is simplified. When the random number generator 4205 frequently generates a random number to continuously update the random number, the security of a system can be improved.

The random number generator 4205 may be provided in the receiving unit block 4213 to output data to the adder 4214 in the transmitting unit block 4212 through the wire transmission line 4207.

According to the above-mentioned embodiment, since data is converted into a random number and is then transmitted wirelessly in an electronic apparatus, it is not necessary to use wiring lines necessary for high-speed data transmission. Therefore, it is possible to settle various problems accompanying a high-speed operation of an electronic apparatus without damaging the security of the apparatus.

### Twenty-Seventh Embodiment

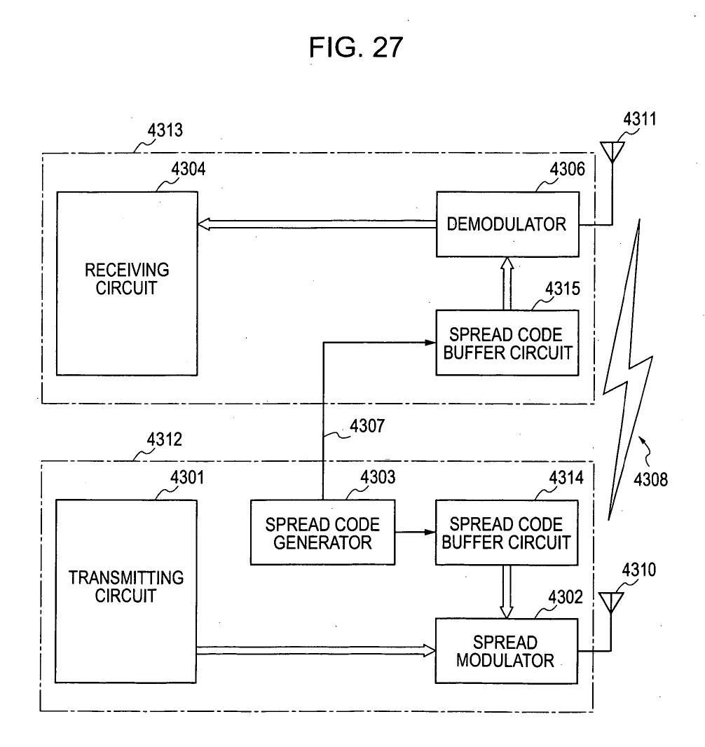

FIG. 27 is a conceptual view illustrating the main parts of an electronic apparatus according to still yet another embodiment of the present invention.

In FIG. 27, data is transmitted from a transmitting unit block 4312 to a receiving unit block 4313. Information is transmitted from a transmitting circuit 4301 having transmitting information to a receiving circuit 4304 for receiving the information. The transmitting information output from the transmitting circuit 4301 is spread-modulated by a spread modulator 4302 and is then transmitted from a transmitting antenna 4310 as an electromagnetic wave (radio wave). A spread code used for the spread modulation is generated by a spread code generator 4303.

The spread code generated from the spread code generator 4303 is transmitted to a spread code buffer circuit 4314 and is then stored therein. At the same time, the spread code generated from the spread code generator 4303 is also transmitted to a spread code buffer circuit 4315 in a receiving unit block 4313 through a wire transmission line 4307 and is then stored therein. The spread modulator 4302 spread-modulates the transmitting information using the spread code stored in the spread code buffer circuit 4314. The electromagnetic wave signal transmitted from the transmitting antenna 4310 is propagated through a space (a wireless propagation path 4308) and is then received by a receiving antenna 4311. Then, the received signal is demodulated by a demodulator 4306 and is output to the receiving circuit 4304. As a spread code used for reverse spread, the same code as that subjected to spread modulation at the time of transmission is used at the same timing. Therefore, the two spread code buffer circuits 4314 and 4315 are controlled so as to be synchronized with each other.

The spread code generator 4303 may be provided in the receiving unit block 4313 to transmit data to the spread code buffer circuit 4314 in the transmitting unit block 4312 through the wire transmission line 4307.

The spread code can be freely generated by the spread code generator 4303 at any time. Since the changed spread code is always synchronized by the operation of the two spread code buffer circuits 4314 and 4315 to maintain tracking, the spread code can be freely changed at any time if necessary. Further, it is also possible to used a very long spread code.

Even when a third party tries to receive a leakage electromagnetic wave signal and to decode it, he cannot decode the signal if he does not know a spread code. In addition, since the spread code is notified to a receiver side via a wire communication in an electronic apparatus, it is very difficult for the third party to obtain the spread code. Therefore, it is possible to improve the security of a system. In addition, when using a long spread code, or when frequently changing the spread code, it is also possible to improve the security of a system.

According to the above-mentioned embodiment, since data is encoded into a spread code and is then transmitted wirelessly in an electronic apparatus, it is not necessary to use wiring lines necessary for high-speed data transmission. Therefore, it is possible to settle various problems accompanying a high-speed operation of an electronic apparatus without damaging the security of the apparatus.

### Twenty-Eighth Embodiment

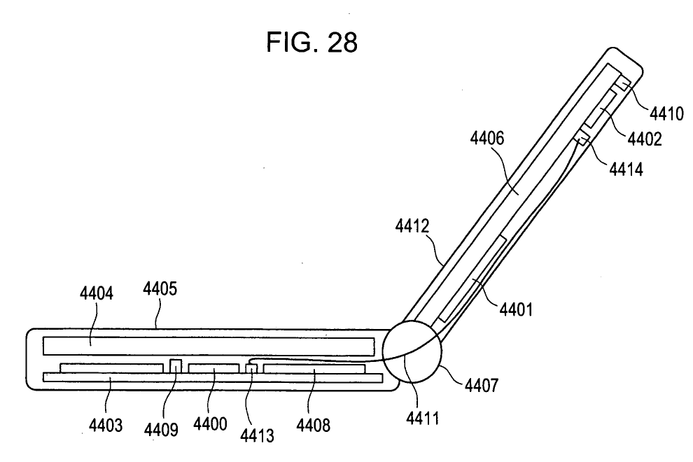

FIG. 28 is a view illustrating an electronic apparatus according to yet still another embodiment of the present invention.

In FIG. 28, an electronic apparatus mainly has a main body portion 4405 and a display unit 4412, and two portions are connected to each other through a hinge 4407. Here, display data generated by a liquid crystal controller 4408 is added to a random number generated by a random number generator 4413, and the added data is transmitted to a modulator 4400 for modulation. Then, the modulated data is modulated into an electronic wave (radio wave) by a transmitting antenna 4409 and is then propagated through a space. The electromagnetic wave signal transmitted from the transmitting antenna 4409 is received by a receiving antenna 4410. Then, the received signal is demodulated by a demodulator 4402, and a random number added at the time of transmission is subtracted from the demodulated signal by a subtracter 4414 to be restored to display data. The display data is transmitted to a liquid crystal driver 4401 to be displayed on a liquid crystal display body 4406.

A random number generated from a random number generator 4413 is transmitted to the subtracter 4414 through a wire transmission line 4411. Since this signal is transmitted at a rate sufficiently lower than the speed of transmitted data and the number of necessary signal lines is small, it is possible to easily provide wiring lines through the hinge 4407. Further, the degree of freedom on the arrangement of components or wiring also increases. In addition, as shown in FIG. 28, the modulator 4400 and the transmitting antenna 4409, which are transmitting components, and the demodulator 4402 and the receiving antenna 4410, which are receiving components, can be arranged at a distant position from the hinge 4407. A restriction for the arrangement of components can be relieved, and it is possible to remarkably increase the degree of freedom on the design of an apparatus in improving the design or utilization of the apparatus.

With an increase in the speed of data to be transmitted, it is difficult to transmit data through transmission lines, but wireless data transmission can be more easily performed. Meanwhile, as describe above, since a signal added with a random number is transmitted wirelessly, it is difficult for a third party to decode the signal as long as he does not know the random number. Therefore, it is possible to settle a security problem, such as wiretapping caused by the leakage of an electromagnetic wave signal. Since the added random number is transmitted to a receiver side through the wire transmission line 4411 in an electronic apparatus, it is difficult for the third party to know the random number, thereby improving the security of a system.

### Twenty-Ninth Embodiment

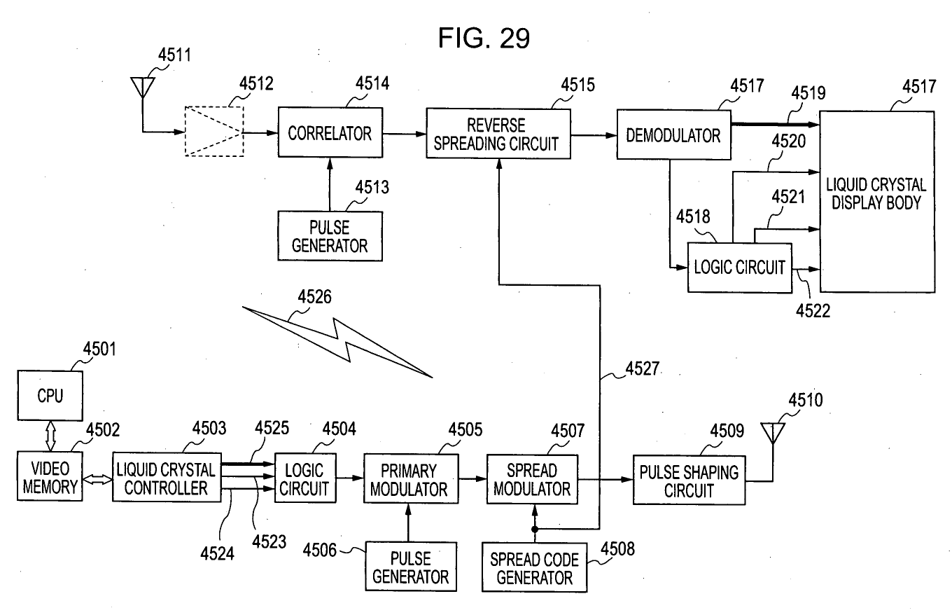

FIG. 29 is a block diagram illustrating a data transmitting method and the main parts of an electronic apparatus according to still yet another embodiment of the present invention.

In FIG. 29, a CPU 4501 controls the overall electronic apparatus and generates image data to be displayed on a display body by decompressing compressed image data, such as MPEG or JPEG, or by using image data relating an image picked-up by an image capturing element to write it on a video memory 4502. A liquid crystal controller 4503 reads display data 4525 from the video memory 4502 according to an operating sequence of a liquid crystal display body 4517 to output it to a logic circuit 4504 together with a horizontal synchronizing signal 4523 and a vertical synchronizing signal 4524 of the liquid crystal display body 4517. The logic circuit 4504 performs the rearrangement of data, such as the parallel-to-serial conversion of the display data 4525 and preamble attachment to construct a packet. A primary modulator 4505 modulates a pulse string generated by a pulse generator 4506 with this signal. The primary modulation can be performed by executing pulse position modulation or bypass pulse modulation on the pulse string. The signal subjected to the primary modulation is spread-modulated by a spread modulator 4507 with a spread code generated by a spread code generator 4508.

The spread-modulated pulse string is waveform-shaped by a pulse shaping circuit 4509 into a wide-band pulse having a low spectral density and having a very short period and is then radiated from a transmitting antenna 4510 as an electromagnetic wave. The electromagnetic field to be radiated is not a wave obtained by modulating a sine wave, but is a very thin pulse string.

The radiated electromagnetic wave is transmitted through a wireless propagation path 4526 and is then received by a receiving antenna 4511. The received signal is amplified by a preamplifier 4512 if necessary, and a correlator 4514 calculates the correlation between the amplified signal and a pulse template, generated by a pulse generator 4513. The output of the correlator 4514 is reversely spread by a reverse spreading circuit 4515, based on a spread code transmitted from a spread code generator 4508 through a wire transmission line 4527, and then the reversely spread signal is demodulated by a demodulator 4517. Then, the demodulated signal is converted into a signal before the primary modulation (a communication packet constructed in the logic circuit 4504). A logic circuit 4518 generates a display data signal 4519, a horizontal synchronizing signal 4520, and a vertical synchronizing signal 4521 for driving a liquid crystal driver, and an X clock signal 4522 for an X driver, based on the communication packet restored by the demodulator 4517 and then transmits these signals to a liquid crystal display body to perform display. Since the spread code necessary for reverse spread is transmitted from the transmitter side through the wire transmission line 4527, it is not necessary for the receiver side to have the spread code. In addition, synchronization compensation for the reverse spread is not needed. Therefore, it is possible to greatly simplify circuits on the receiver side.

In UWB communication, the electromagnetic wave leaks at a very low spectral density, and it is difficult for a third party to obtain information without permission. Further, in the present embodiment, since the spread code is transmitted to the receiver side through the wire transmission line 4527 in a closed space inside an electronic apparatus, it is difficult for the third party to know the spread code. In addition, since the spread code can be frequently changed, it is possible to improve the security of the apparatus. Therefore, it is possible to avoid various conventional problems accompanying the high-speed transmission of data to a liquid crystal display body 4518 without an increase in manufacturing costs while maintaining high security.

### Thirtieth Embodiment

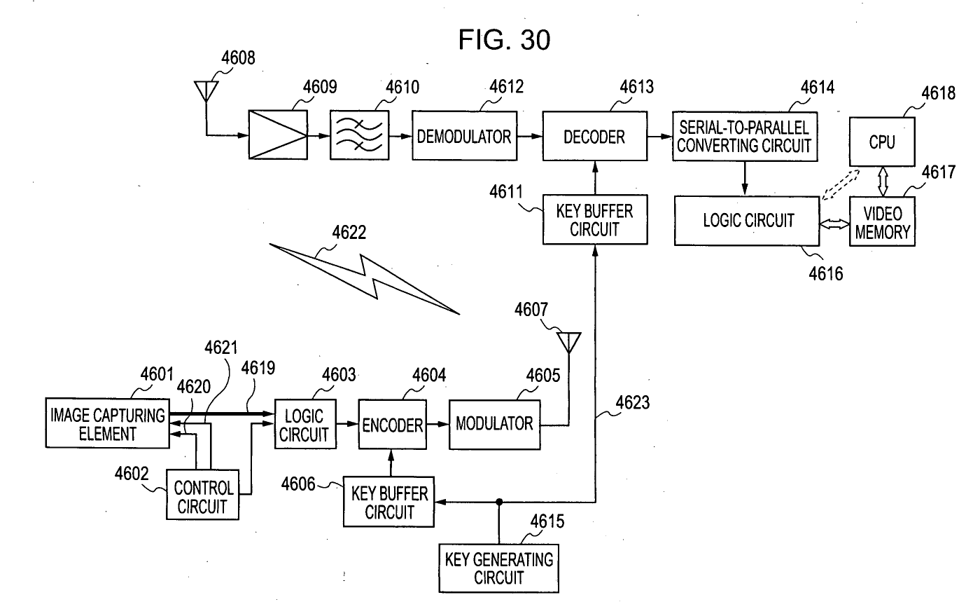

FIG. 30 is a block diagram illustrating the main parts of an electronic apparatus according to still yet another embodiment of the present invention and shows an example in which an information transmitting method according to the resent invention is applied to an electronic apparatus using an image capturing element.

In FIG. 30, an image capturing element 4601 is driven by a horizontal synchronizing signal 4620 and a vertical synchronizing signal 4621 generated from a control circuit 4602 to pick up an image and outputs image data 4619 related to the captured image. A logic circuit 4603 receives these signals to construct a packet for wireless transmission. The packet is encoded by an encoder 4604, and the encoded signal is modulated by a modulator 4605 and is then radiated from a transmitting antenna 4607 as an electromagnetic wave.

The key used for encryption is generated from a key generating circuit 4615. The encrypted key is transmitted to a key buffer circuit 4606 on the transmitter side and a key buffer circuit 4611 on the receiver side at the same time. The key buffer circuits 4606 and 4611 are synchronized with each other in transmission and reception to respectively output encrypted keys to an encoder 4604 and a decoder 4613. Then, the decoder 4613 is, normally operated for decoding. The key is transmitted from the key generating circuit 4615 to the key buffer circuit 4611 on the receiver side through a wire transmission line 4623.

The electromagnetic wave signal received by the transmitting antenna 4607 is propagated through a wireless propagation path (space) 4622 and is then received by a receiving antenna 4608. Then, the received signal is amplified by a preamplifier 4609, and a band-pass filter 4610 removes unnecessary signals out of a predetermined band width from the amplified signal, and a demodulator 4612 demodulates the signal. A decoder 4613 decodes from the demodulated signal and transmits the decoded signal to a serial-to-parallel converting circuit 4614. Then, the serial-to-parallel converting circuit 4614 extracts an image data portion from the demodulated reception packet and performs serial-to-parallel conversion on every pixel to generate image data.

A logic circuit 4616 generates a memory address to be written on a video memory 4617 corresponding to the demodulated pixel data and writes the image data on the corresponding address of the video memory 4617 directly or through a CPU 4618. The CPU 4618 accesses the video memory 4617 to use the image data for various applications.

In the case in which the signal propagated through a wireless communication path 4622 leaks and a third party wiretaps the leakage signal, because an encrypted key is used, it is very difficult for the third party to obtain the contents of transmitting data unless the third party acquires the encrypted key. Since the encrypted key is transmitted at a short distance in the same apparatus via a wire communication, it is difficult for the third party to know the encrypted key, thereby improving the security of a system. Further, since the key generating circuit 4615 and the key buffer circuits 4606 and 4611 are always connected to each other through the wire transmission line 4623, the encrypted key can be frequently changed. When frequently changing the encrypted key, the security of a system can be improved.

In the present embodiment, the key generating circuit 4615 is provided in the transmitter side of data. However, the encrypted key can be transmitted from the receiver side to the key buffer circuit 4606 of the transmitter side through the wire transmission line 4623. In this case, the same effects as described above can also be obtained.

According to the above-mentioned structure in which data from the image capturing element 4601 is encoded and is then transmitted wirelessly, it is possible to settle various problems, such as an increase in power consumption, the restriction of wiring position, an EMI problem, and the deterioration of reliability, which occur with an increase in the size of the image capturing element 4601.

### Thirty-First Embodiment

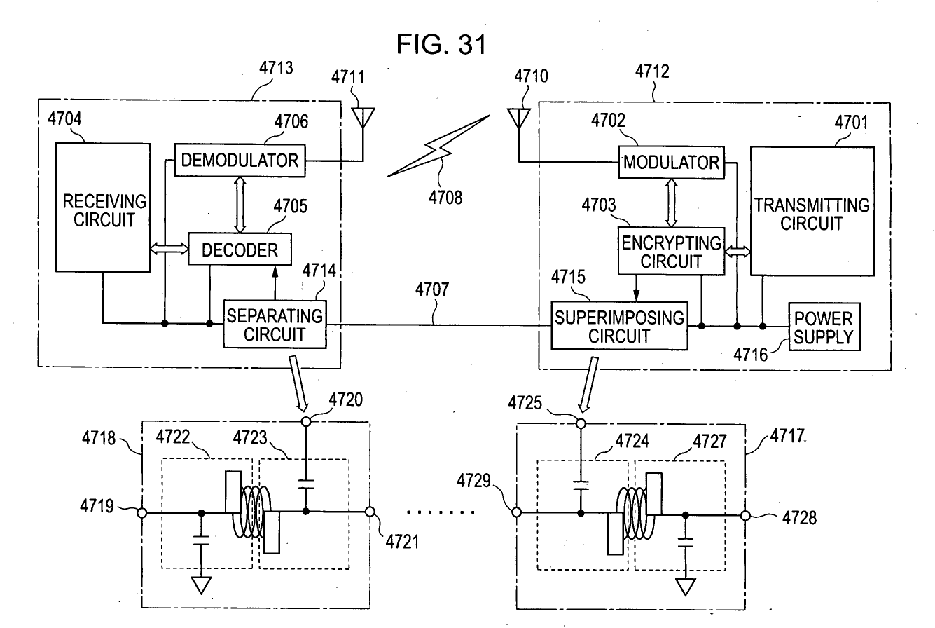

FIG. 31 is a conceptual view illustrating the main parts of an electronic apparatus according to still yet another embodiment of the present invention.

In FIG. 31, a transmitting unit block 4712 is provided with a transmitting circuit 4701 having information to be transmitted, and a receiving unit block 4713 is provided with a receiving circuit 4704 for receiving the transmitting information. Here, data is transmitted from the transmitting unit block 4712 to the receiving unit block 4713.

Transmitting data output from the transmitting circuit 4701 is encrypted by an encrypting circuit 4703, and the encrypted signal is modulated by a modulator 4702 and is then transmitted from a transmitting antenna 4710 as an electromagnetic wave. The encrypting circuit 4703 also generates an encrypted code, and the encrypted code is superimposed on a power line 4707 by a superimposing circuit 4715 and is then transmitted to the receiving unit block 4713 via a wire together with a power supply voltage. The addition and subtraction of random numbers, encoding, spread modulation as described in the above-mentioned embodiments can be applied to the encryption process. In addition, the encrypted code corresponds to the random number, the encrypted key, or the spread code.

An electromagnetic wave carrying the transmitting data is radiated by the transmitting antenna 4710 and is propagated through a space (a wireless propagation path 4708) to be received by a receiving antenna 4711. Then, the received wave is demodulated by a demodulator 4706 and is then output to a decoder 4705. The decoder 4705 decodes the received data, using the encrypted code obtained by separating the signal transmitted through the power line 4707 using a separating circuit 4714 and then transmits the decoded signal to the receiving circuit 4704. In addition, the encrypted code is transmitted from the receiver unit block 4713 of data to the transmitter unit block 4712. In this case, the encrypted code is generated from the receiver unit block 4713. The separating circuit 4714 functions as a superimposing circuit, and the superimposing circuit 4715 functions as a separating circuit.

The encrypted code is superimposed on a power supply voltage on the power line 4707 and is then transmitted between the transmitter unit block 4712 and the receiver unit block 4713. A power supply 4716 supplies power to all circuits in the transmitting unit block 4712, and the encrypted code generated from the encrypting circuit 4703 is superimposed on the power line 4707 by the superimposing circuit 4715. The detailed inner structure of the superimposing circuit 4715 is represented by a dot-and-dash line 4717. A terminal 4728 is connected to the power supply 4716, and a terminal 4729 is connected to the power line 4707. The encrypted code generated from the encrypting circuit 4703 is input to a terminal 4725 and is then superimposed on the power line 4707 through a high-pass filter 4724.

The superimposed encrypted code signal does not leak toward a terminal 4728 by a low-pass filter 4727, so that all circuits in the transmitter unit block 4712 are normally operated. The encrypted code superimposed on the power line 4707 is separated by the separating circuit 4714 and is then transmitted to the decoder 4705. The inner structure of the separating circuit 4714 surrounded by a dot-and-dash line 4718 is described in detail. A terminal 4721 is connected to the power line 4707.

The encrypted code signal input to the terminal 4721 is separated by a high-pass filter 4723, and the separated signal is transmitted to the decoder 4705 through a terminal 4720. Since a low-pass filter 4722 prevents the leakage of information on the superimposed encrypted code, only energy supplied from the power supply 4716 is applied to a terminal 4719, and a normal power supply voltage is applied to all circuits in the receiving unit block 4713 through the terminal 4719. When the encrypted code is transmitted from the receiving unit block 4713 to the transmitting unit block 4712, the functions of the superimposing circuit 4715 and the separating circuit 4714 are reverse to each other. Alternatively, as shown in FIG. 25, these circuits may have the same structure.

According to the above-mentioned structure, the encrypted key is superimposed on the power line and is then transmitted therethrough in order to maintain the security of signals transmitted wirelessly. Therefore, it is possible to achieve a signal exchange in an electronic apparatus with the minimum number of wiring lines. Thus, it is possible to realize an electronic apparatus having high reliability and security using a simple method.

In particular, when applying this structure to the data transmission between semiconductor chips, signals subjected to an encrypting process are transmitted between the semiconductor chips wirelessly, and an encrypted code for the encrypting process is superimposed on a power line and is then transmitted. Therefore, only the power line is needed as a wiring line, and it is possible to easily mount the semiconductor chips without damaging the security of a system.

### Thirty-Second Embodiment

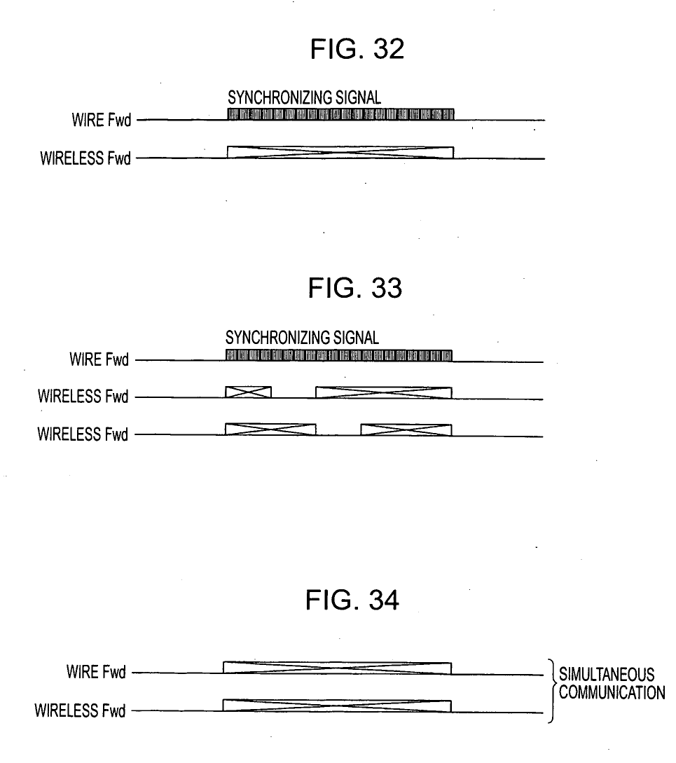

FIGS. 32 to 39 are timing charts illustrating the timing of wire communication and wireless communication.

In FIG. 32, data is transmitted between circuit blocks wirelessly, and a synchronizing signal is transmitted between these circuit blocks via a wire at the same time.

In addition, in FIG. 33, when bidirectional communication is performed between these circuit blocks, the synchronizing signal may be transmitted between both sides via a wire. Alternatively, one of these circuit blocks may perform wireless communication while synchronizing the synchronizing signal transmitted one direction.

Further, in FIG. 34, data may be transmitted between the circuit blocks by both wire and wireless.

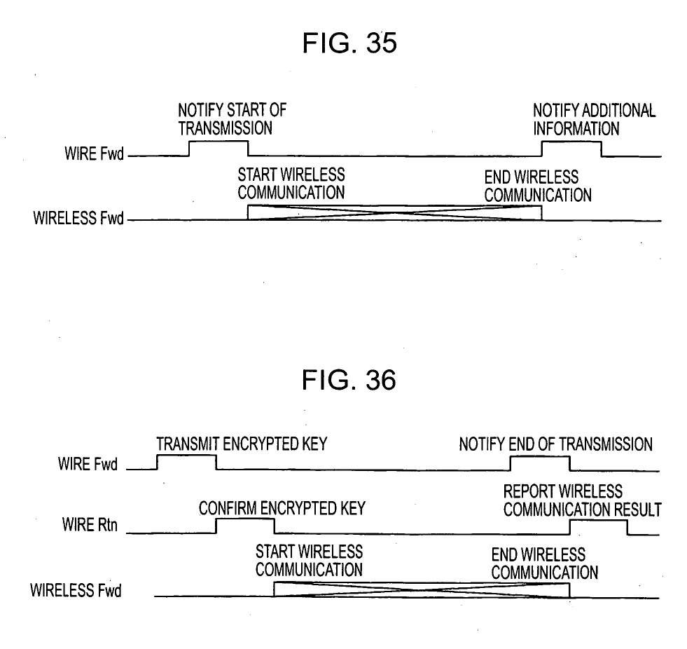

Furthermore, in FIG. 35, when data is transmitted between the circuit blocks wirelessly, the control information of wireless communication can be transmitted via a wire. For example, a notice of a transmission start and an encrypted key may be transmitted via a wire, and a receiver side may receive the notice of a transmission start and the encrypted key to start wireless communication. In addition, when the wireless communicated is completed, an additional information notice may be transmitted via a wire.

Further, in FIG. 36, when the control information of wireless communication is transmitted via a wire, an encrypted key may be transmitted via a wire, and after the confirmation of the encrypted key is performed via a wire, wireless communication may start.

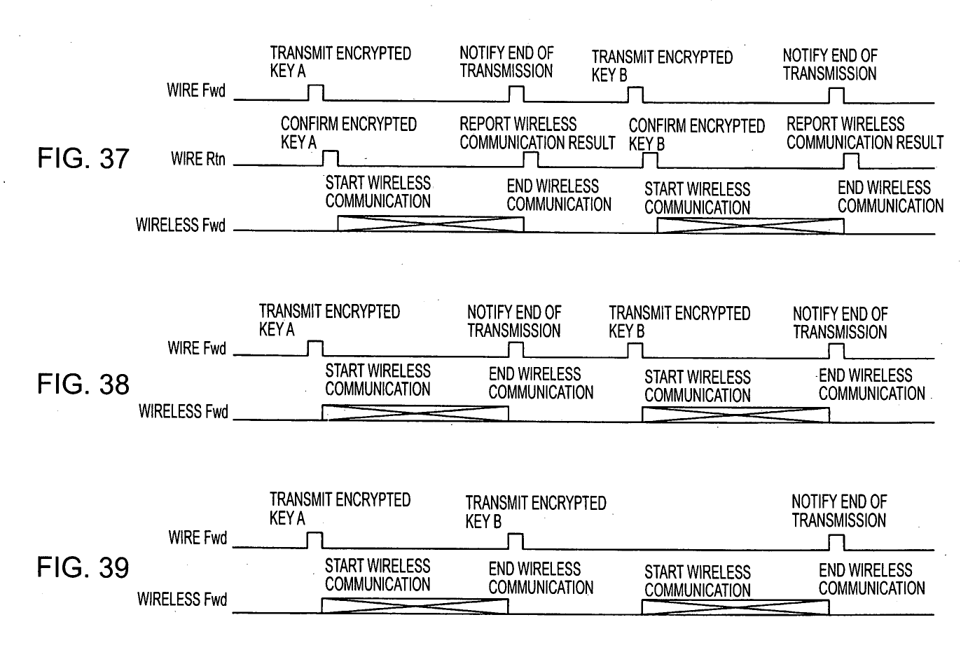

Furthermore, in FIGS. 37 to 39, an encrypted key may be converted into a wireless communication frame, etc. In this case, the confirmation of the encrypted key may be performed on every wireless communication frame via a wire, and a notice of a transmission end may be transmitted via a wire. In addition, the term ‘wireless communication frame’ means a period of time from the start of wireless communication to the end of the wireless communication.

### INDUSTRIAL APPLICABILITY

The present invention is not limited to the above-mentioned embodiments, but may apply to, for example, the connection between a CPU and a storage device, such as a hard disk driver built in an electronic apparatus.

1. An information transmitting method used in an electronic apparatus comprising a wireless communication unit wirelessly transmitting first category information and a wire communication unit transmitting second category information via a wire,
wherein the wireless transmission of the first category information and the wire transmission of the second category information are performed in a communication link.

2. An electronic apparatus comprising:
a wireless communication unit for wirelessly transmitting first category information; and
a wire communication unit for transmitting second category information via a wire,
wherein the wireless transmission of the first category information and the wire transmission of the second category information are performed in a communication link.

3. An electronic apparatus comprising:
a wireless communication unit for wirelessly transmitting first category information; and
a wire communication unit for transmitting second category information used for at least one of controlling and processing the first category information via a wire.

4. An electronic apparatus comprising:
an information transmitting unit for transmitting first category information;
an encoding unit for encoding the first category information from the information transmitting unit;
a wireless transmitting unit for transmitting the first category information encoded by the encoding unit as an electromagnetic wave signal;
a wireless receiving unit for receiving the electromagnetic wave signal transmitted by the wireless transmitting unit;
a decoding unit for decoding the signal received by the wireless receiving unit;
a key generating unit for generating an encrypted key as second category information; and
a wire communication unit for distributing the encrypted key generated by the key generating unit to the encoding unit and the decoding unit via a wire.

5. An electronic apparatus comprising:
an information transmitting unit for transmitting first category information;
a random number generating unit for generating a random number as second category information;
a wire communication unit for distributing the random number generated by the random number generating unit via a wire;
an adding unit for adding the random number to the first category information transmitted from the information transmitting unit;
a wireless transmitting unit for transmitting the information added by the adding unit as an electronic wave signal;
a wireless receiving unit for receiving the electromagnetic wave signal transmitted from the wireless transmitting unit; and
a subtracting unit for subtracting the random number from the information received by the wireless receiving unit and for decoding the resultant signal.

6. An electronic apparatus comprising:
an information transmitting unit for transmitting first category information;
a spread code generating unit for generating a spread code as second category information;
a wire communication unit for transmitting the spread code generated from the spread code generating unit via a wire;
a modulating unit for spread-modulating the first category information transmitted from the information transmitting unit by the spread code;
a wireless transmitting unit for transmitting the information modulated by the modulator as an electromagnetic wave signal;
a wireless receiving unit for receiving the electromagnetic wave signal; and
a demodulating unit for reversely spreading the information received by the wireless receiving unit by the spread code.

7. The electronic apparatus according to claim 2,
wherein the wire communication unit superimposes a signal on a power line to transmit the signal.

8. The electronic apparatus according to claim 2, further comprising:
an electromagnetic wave converting unit for converting the first category information into the electromagnetic wave signal; and
an electromagnetic wave restoring unit for receiving the electromagnetic wave signal to restore the signal to the first category information.

9. The electronic apparatus according to claim 8,
wherein the electromagnetic wave converting unit and the electromagnetic wave restoring unit are driven with a carrier wave generated by the same carrier oscillator.

10. The electronic apparatus according to claim 8,
wherein the electromagnetic wave converting unit performs spectral spread modulation, and the electromagnetic wave restoring unit performs spectral reverse spread modulation, and
wherein synchronization information of the electromagnetic wave converting unit and the electromagnetic wave restoring unit is transmitted via a wire.

11. The electronic apparatus according to claim 8,
wherein the electromagnetic wave converting unit performs modulation to a UWB signal, and the electromagnetic wave restoring unit performs demodulation from the UWB signal, and
wherein synchronization information of the electromagnetic wave converting unit and the electromagnetic wave restoring unit is transmitted via a wire.

12. An electronic apparatus comprising:
a wireless transmitting unit for modulating first category- information and transmitting the modulated information as an electromagnetic wave signal;
a wireless receiving unit for receiving the electromagnetic wave signal to demodulate the signal;
a wire transmitting unit for superimposing second category information on a power line to transmit the information; and
a wire receiving unit for separating the signal superimposed on the power line,
wherein the first category information and the second category information are transmitted in a communication link by the wireless transmitting unit and the wire transmitting unit, and the wireless transmitting unit and the wire transmitting unit are supplied with power through the common power line.

13. The electronic apparatus according to claim 12,
wherein the wireless transmitting unit comprises a control unit for generating a reference signal and a modulating unit for converting the first category information into the electromagnetic wave signal in synchronism with the reference signal,
wherein the second category information transmitted to or received from the wire transmitting unit and the wire receiving unit comprises the reference signal, and
wherein the wireless receiving unit includes a demodulating unit for demodulating the first category information in synchronism with the reference signal received by the wire receiving unit.

14. The electronic apparatus according to claim 12,
wherein the wireless transmitting unit comprises a control unit for generating a reference signal, a first carrier oscillating unit for oscillating a carrier wave synchronized with the reference signal, and a modulating unit for modulating the carrier wave oscillated from the first carrier oscillating unit into the first category information and for converting the first category information into the electromagnetic wave signal,
wherein the second category information transmitted to or received from the wire transmitting unit and the wire receiving unit comprises the reference signal, and
wherein the wireless receiving unit includes a second carrier oscillating unit for oscillating a carrier wave synchronized with the reference signal received by the wire receiving unit and a demodulating unit for demodulating the first category information using the carrier wave oscillated by the second carrier oscillating unit.

15. The electronic apparatus according to claim 12,
wherein the wireless transmitting unit comprises a control unit for generating a reference signal, a first carrier oscillating unit for oscillating a carrier wave synchronized with the reference signal, and a modulating unit for modulating the carrier wave oscillated from the first carrier oscillating unit into the first category information in synchronism with the reference signal and for converting the first category information into the electromagnetic wave signal,
wherein the second category information transmitted to or received from the wire transmitting unit and the wire receiving unit comprises the reference signal, and
wherein the wireless receiving unit includes a second carrier oscillating unit for oscillating a carrier wave synchronized with the reference signal received by the wire receiving unit and a demodulating unit for demodulating the first category information in synchronism with the reference signal received by the wire receiving unit, using the carrier wave oscillated by the second carrier oscillating unit.

16. The electronic apparatus according to claim 12,
wherein the wireless transmitting unit modulates the first category information by phase modulation to generate carrier wave information for modulation and demodulation based on the reference signal transmitted as the second category information via a wire, and
wherein a transmitting packet transmitted from the wireless transmitting unit is synchronized with the reference signal transmitted as the second category information via a wire.

17. The electronic apparatus according to claim 12,
wherein the wireless transmitting unit modulates the first category information by spectral spread modulation,
wherein the wireless receiving unit demodulates the first category information by spectral reverse spread demodulation and generates carrier wave information or synchronization information of a spread code for modulation and demodulation based on the reference signal transmitted as the second category information via a wire, so that the information is synchronized with the reference signal.

18. The electronic apparatus according to claim 12,
wherein the wireless transmitting unit modulates the first category information by UWB modulation and generates synchronization information of a pulse template for modulation and demodulation based on the reference signal transmitted as the second category information via a wire, so that the information is synchronized with the reference signal.

19. The electronic apparatus according to claim 2,
wherein the second category information includes at least one of the carrier wave information and the synchronization information concerning the wireless communication of the first category information.

20. The electronic apparatus according to claim 2,
wherein the second category information includes information indicating a receiving state of the first category information and is transmitted from a receiving side of the first category information to a transmitting side thereof.

21. The electronic apparatus according to claim 2,
wherein the first category information includes at least one of image data, text data, and voice data.

22. The electronic apparatus according to claim 2, further comprising:
a storage unit for storing the first category information;
a display body for displaying the first category information;
a display control unit for reading the first category information from the storage unit according to an operating sequence of the display body and for outputting the read information; and
a display body driving unit for driving the display body, based on the first category information read by the display control unit.

23. The electronic apparatus according to claim 2, further comprising:
an image capturing element; and
an image capturing control unit for reading an image signal picked-up by the image capturing element as the first category information and for outputting the signal.

24. The electronic apparatus according to claim 2,
wherein information transmitted between an electronic circuit on an integrated circuit and outside the integrated circuit is wirelessly transmitted as the first category information.

25. The electronic apparatus according to claim 2, further comprising:
a display unit;
a speaker unit; and
a data source unit for generating image data displayed on the display unit and sound data for driving the speaker unit,
wherein the image data and the sound data transmitted between the display unit or the speaker unit and the data source unit are wirelessly transmitted as the first category information.

26. A wireless communication terminal comprising:
a first body;
a second body connected to the first body;
a connecting portion for connecting the first body to the second body so that the positional relationship between the first body and the second body may be changed;
an external wireless communication antenna mounted on at least one of the first body and the second body;
an external wireless communication control unit mounted on the first body for controlling external wireless communication using the external wireless communication antenna;
a display unit mounted on the second body;
a first internal wireless communication antenna mounted on the first body;
a second internal wireless communication antenna mounted on the second body;
a first internal wireless communication control unit mounted on the first body for controlling internal wireless communication using the first internal wireless communication antenna;
a second internal wireless communication control unit mounted on the second body for controlling internal wireless communication using the second internal wireless communication antenna; and
a wire communication unit mounted on at least one of the first body and the second body for transmitting through a wire transmission line a portion of information to be transmitted by the internal wireless communication.
